(19) United States
(12) Patent Application Publication
(10) Pub. No.: US 2007/0196763 A1
(43) Pub. Date: Aug. 23, 2007

(54) Method of forming laminated resist

(75) Inventors: Takayuki Araki, Osaka (JP); Meiten Koh, Osaka (JP); Kazuyuki Sato, Osaka (JP); Mihoko Ohashi, Osaka (JP); Yosuke Kishikawa, Osaka (JP)

Correspondence Address: SUGHRUE MION, PLLC, 2100 PENNSYLVANIA AVENUE, N.W., SUITE 800, WASHINGTON, DC, 20037, US

(73) Assignee: DAIKIN INDUSTRIES, LTD.

(21) Appl. No.: 10/579,855

(22) PCT Filed: Nov. 15, 2004
(86) PCT No.: PCT/JP04/16937

§ 371 Date: May 17, 2006

(30) Foreign Application Priority Data
Nov. 19, 2003 (JP) 2003-389857
Apr. 23, 2004 (JP) 2004-128935
Jun. 18, 2004 (JP) 2004-181329
Aug. 18, 2004 (JP) 2004-238813

(51) Int. Cl. G03C 11/12

(52) U.S. Cl. 430/256; 430/270.1

(57) ABSTRACT

There is formed a laminated resist which exhibits sufficient reflection reducing effect in a photolithography process using light of vacuum ultraviolet region and also has sufficient developing characteristics in a developing process. The method of forming the laminated photoresist comprises (I) a step for forming the photoresist layer (L1) on a substrate and (II) a step for forming the antireflection layer (L2) on the photoresist layer (L1) by applying the coating composition containing the fluorine-containing polymer (A) having hydrophilic group Y. The fluorine-containing polymer (A) contains a structural unit derived from a fluorine-containing ethylenic monomer having hydrophilic group Y and is characterized in that (i) the hydrophilic group Y contains an acidic OH group having a pKa value of not more than 11, (ii) a fluorine content is not less than 50% by mass, and (iii) the number of moles of the hydrophilic group Y in 100 g of the fluorine-containing polymer (A) is not less than 0.14.

### TECHNICAL FIELD

The present invention relates to a method of forming a laminated resist produced by forming an antireflection layer on a photoresist layer.

### BACKGROUND ART

In recent years, with the advance of high integration and high speed operation of LSI, scale down of design rule is demanded, and for that reason, reduction of wavelength of exposure light source used for forming a resist pattern has been progressing. In a mass production process of 64 M bit DRAM (dynamic random access memory), KrF excimer laser (248 nm) has been used, and in production of 256 M and 1 G bit or more DRAM, ArF excimer laser (193 nm) having a shorter wavelength is used as an exposure light source. Recently aiming at further micro fabrication, F₂ (157 nm) laser having a further shorter wavelength is studied as a new exposure light source.

For an exposure system for those lithography processes, a combination of monochromatic light and dioptric system lens is mainly used. However since a standing wave is generated due to interference between the incident light and the reflection light from a substrate at the time of exposure, fluctuation in dimensions such as width of pattern line and breakage of pattern form arise. Particularly in the case of forming a fine resist pattern on a semiconductor substrate having a step, such a dimensional fluctuation and breakage of pattern form due to a standing wave are significant (standing wave effect).

So far methods for reducing this standing wave effect have been proposed, such as a method of blending a light absorbing agent in a resist material, a method of providing an antireflection layer on a top surface of a resist layer (ARCOR method, JP60-38821A, JP62-62520A, JP62-62521A) and a method of providing an antireflection layer on a bottom surface of a resist (BARC method, JP62-159143A). Among those methods, the ARCOR method comprises a step for forming a transparent upper antireflection film layer on a top surface of a resist and peeling the film after exposure. In this method, a fine pattern having a high dimensional accuracy, particularly a high matching accuracy is formed by its easy film formation procedure.

In the BARC method, too, a high reflection reducing effect can be obtained, but in the case where a substrate has a step, there are disadvantages that a thickness of the antireflection film on the step fluctuates largely, thereby greatly changing a reflectance and the reflectance is increased if the antireflection film thickness is increased for reducing a film thickness fluctuation. Therefore a combination use of an upper antireflection film layer to be provided on the top surface of the photoresist layer is desired. The upper antireflection film layer has not only a primary function of reflection reduction but also a function of preventing a developing failure by enhancing affinity for a developing solution after the exposure or a function as a barrier film from environment, and therefore will be a more important material.

At the initial stage of development, perfluoropolyether having a low refractive index was studied as an antireflection film material for the ARCOR method, but had demerits from the viewpoint of practical use because a fluorine-containing hydrocarbon solvent must be used as a diluent or a releasing agent, thereby resulting in a high cost and causing a problem with film forming property.

In order to overcome those demerits, fluorine-containing antireflection film materials which can be released easily with an aqueous alkali solution used as a developing solution or pure water used as a rinsing solution have been developed (JP5-188598A, JP6-41768A, JP6-51523A, JP7-234514A, JP8-305032A, JP8-292562A, JP11-349857A and JP11-352697A).

Those materials are mainly compositions of a water soluble polymer such as polyvinyl pyrrolidone or polyvinyl alcohol which is a non-fluorine-containing binder polymer; and a low molecular weight fluorine-containing alkylsulfonic acid, fluorine-containing alkylcarboxylic acid or amine salt thereof; or further a high molecular weight fluorine-containing polyether having sulfonic acid, carboxylic acid or amine salt thereof at an end of its trunk chain.

However when a low molecular weight fluorine-containing alkylsulfonic acid, fluorine-containing alkylcarboxylic acid or amine salt thereof is used, there is a disadvantage that diffusion thereof in a resist layer occurs because its molecular weight is low, and a pattern profile of a resist is deteriorated.

Also when a high molecular weight fluorine-containing polyether having sulfonic acid, carboxylic acid or amine salt thereof at an end of its trunk chain is used, there are disadvantages that in the case of a molecular weight being high enough for preventing the diffusion, its water solubility is lowered or it becomes insoluble and also film forming property is lowered.

Further an antireflection film prepared by using, as a binder polymer, polyvinyl pyrrolidone developed for the use for KrF is not suitable as an antireflection film material for a ArF resist since polyvinyl pyrrolidone has a high refractive index at an exposure wavelength of ArF excimer laser and a low exposure light transmission.

On the other hand, in order to compensate for those demerits, compositions for an antireflection film prepared by using a fluorine-containing polymer having sulfonic acid or its amine salt in a side chain thereof (JP2001-194798A, JP2001-200019A) or by using a fluorinated alkylamine salt of carboxylic acid or a perfluoro compound having, as a counter ion, alkanolamine salt (JP2001-133984A) have been developed.

Among them, in the case of fluorine-containing antireflection film materials having sulfonic acid or amine salt thereof in its side chain (JP2001-194798A, JP2001-200019A), there are problems that since acidity of the sulfonic acid or amine salt thereof is too strong, a surface layer portion of a resist pattern is rounded after developing, thereby causing a problem in an etching step; a surface layer portion of an un-exposed portion also undergoes chemical amplification reaction, and a thickness of the un-exposed portion is decreased; and corrosion and rusting of equipment for producing devices arise due to an influence of an acid component, thereby causing defect of products.

On the other hand, in the case of fluorine-containing antireflection film materials prepared by using a perfluoro compound having, as a counter ion, fluorinated alkanolamine salt or alkylamine salt of carboxylic acid (JP2001-133984A), a fluorine content is low and a refractive index being low enough for practical use cannot be obtained. Also there are disadvantages that due to a small amount of hydrophilic groups contained in the monomer, solubility (=dissolution rate) in a resist developing solution and an aqueous solvent is very low, and film forming property is not good.

Also compositions for an antireflection film prepared by using a fluorine-containing polymer having a high content of carboxyl groups are studied (JP11-124531A, JP2004-37887A), but only polymers having a low molecular weight are obtained as a fluorine-containing polymer having carboxyl groups, and studies are made with respect to compositions for an antireflection film for a resist prepared by using such low molecular weight fluorine-containing polymers.

Those low molecular weight fluorine-containing polymers are insufficient in solubility in water, and addition of amines or surfactants is necessary. As a result, there are problems that a refractive index of an antireflection film is decreased and transparency is lowered.

Further in order to make the polymers soluble, it is necessary to mix a large amount of a water soluble organic solvent such as alcohols to water, and as a result, there arises intermixing between the resist layer and the antireflection layer when coating on a resist film and a sufficient reflection reducing effect cannot be obtained.

Accordingly, the present situation is such that materials for an upper antireflection film layer, particularly materials for an upper antireflection film layer for ArF and F₂ photoresists which eliminate the mentioned problems and have practical water solubility are desired.

As mentioned above, conventional polymers used for antireflection film materials are high in a refractive index, and a sufficient effect thereof in pattern formation could not be obtained.

On the other hand, conventional materials were insufficient in water solubility even if a refractive index thereof was low. Therefore when forming an antireflection film on a photoresist layer, it was necessary to use an organic solvent for a coating composition containing a polymer. As a result, there arose intermixing between the photoresist layer and the antireflection layer to make an interface between them unclear and effects resulting from a low refractive index could not be exhibited sufficiently. Also solubility in a developing solution (dissolution rate) was insufficient, and in a conventional developing process, the antireflection layer could not be removed and even in a step for removing a resist layer of exposed region in the developing process, there was a case where the antireflection layer could not be smoothly removed.

A problem to be solved in the present invention is to form a laminated resist which has a sufficient reflection reducing effect particularly in a photolithography process using light in a vacuum ultraviolet region by providing, on a photoresist layer, an antireflection film for a resist obtained from a fluorine-containing polymer having a lower refractive index and excellent solubility in a developing solution and also has sufficient developing characteristics even in a developing step of the photolithography process.

### DISCLOSURE OF INVENTION

The present inventors have made intensive studies with respect to various fluorine-containing polymers having hydrophilic group, and as a result, have found a fluorine-containing polymer being capable of exhibiting both of a low refractive index and solubility in water or a developing solution (aqueous solution of 2.38% by mass of tetramethylammonium hydroxide) and also have found that by providing, on a photoresist layer, an antireflection layer obtained from this fluorine-containing polymer, good reflection reducing effect can be exhibited in an exposure process of photolithography and the antireflection layer can be easily removed in a developing process.

Namely, a method of forming a laminated photoresist of the present invention comprises:

(I) a step for forming a photoresist layer (L1) on a substrate and

(II) a step for forming an antireflection layer (L2) on the photoresist layer (L1) by applying a coating composition containing a fluorine-containing polymer (A) having hydrophilic group Y, and

the fluorine-containing polymer (A) has a structural unit derived from a fluorine-containing ethylenic monomer having hydrophilic group Y and is characterized in that:

(i) the hydrophilic group Y contains an acidic OH group having a pKa value of not more than 11,

(ii) a fluorine content is not less than 50% by mass, and

(iii) the number of moles of the hydrophilic group Y in 100 g of the fluorine-containing polymer (A) is not less than 0.14.

### BRIEF DESCRIPTION OF DRAWING

FIG. 1 is a flow chart for explaining the method of forming the laminated photoresist of the present invention.

### BEST MODE FOR CARRYING OUT THE INVENTION

First, the fluorine-containing polymer (A) constituting the antireflection layer (L2) in the method of forming the laminated photoresist of the present invention is explained below.

In the present invention, the fluorine-containing polymer (A) which is used for the antireflection layer (L2) has the hydrophilic group Y. This hydrophilic group Y is introduced as a part of a structural unit of the fluorine-containing polymer (A) by polymerizing a fluorine-containing ethylenic monomer having hydrophilic group Y.

Namely, it is important for the fluorine-containing polymer to have a repeat unit (structural unit) of a fluorine-containing ethylenic monomer having hydrophilic group Y, thereby enabling particularly both of a low refractive index and water solubility or solubility in a developing solution (dissolution rate) to be exhibited and further enabling the obtained thin antireflection film layer to be endowed with a good mechanical strength as a self-supporting film.

It is particularly preferable that among the structural units constituting the fluorine-containing polymer (A), the structural unit having the hydrophilic group Y is substantially comprised of only a structural unit obtained by polymerizing a fluorine-containing ethylenic monomer having the hydrophilic group Y, thereby enabling a lower refractive index to be achieved while maintaining good water solubility or solubility in a developing solution (dissolution rate).

In the structural unit which is derived from a fluorine-containing ethylenic monomer having the hydrophilic group Y and constitutes the fluorine-containing polymer (A), the hydrophilic group Y contains an acidic OH group having a pKa value of not more than 11.

Examples of the hydrophilic group Y are concretely those having an acidic OH group such as: 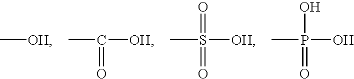
and the like, and showing an acidity of not more than 11 of a pKa value.

Particularly preferred are —OH and —COOH from the viewpoint of excellent transparency and a low refractive index.

In the case of —SO₃H and —P(═O)(OH)₂, attention should be attracted to the points that when a film of a fluorine-containing polymer having such groups is formed on the photoresist layer (L1), depending on kind of the photoresist, there is a case where too high acid strength or acid diffusion has an adverse effect on a pattern profile and causes an excessive decrease of a thickness of an un-exposed portion.

A pKa value of those acidic OH groups in the hydrophilic group Y is not more than 11, preferably not more than 10, more preferably not more than 9.

When the hydrophilic group Y is —OH group, in order to adjust its acidity to be not more than 11 in a pKa value, it is preferable to bond a fluorine-containing alkyl group or a fluorine-containing alkylene group to the carbon atom directly bonded to the —OH group. Concretely it is preferable that the structural unit has a moiety represented by the following formula: 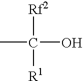
wherein Rf² is a fluorine-containing alkyl group which has 1 to 10 carbon atoms and may have ether bond; R¹ is at least one selected from the group consisting of H, a hydrocarbon group having 1 to 10 carbon atoms and a fluorine-containing alkyl group which has 1 to 10 carbon atoms and may have ether bond.

It is particularly preferable that R¹ is a fluorine-containing alkyl group which has 1 to 10 carbon atoms and may have ether bond.

It is further preferable that both of Rf² and R¹ are perfluoroalkyl groups. Concretely preferred are moieties such as: 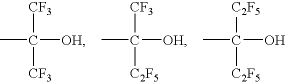
and the like.

It is further preferable, from the viewpoint of water solubility and solubility in a developing solution, that the structural unit has a moiety represented by the following formula: 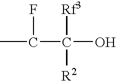
wherein Rf³ is a fluorine-containing alkyl group which has 1 to 10 carbon atoms and may have ether bond; R² is at least one selected from the group consisting of H, a hydrocarbon group having 1 to 10 carbon atoms and a fluorine-containing alkyl group which has 1 to 10 carbon atoms and may have ether bond.

Concretely preferred are structural units having moieties such as:

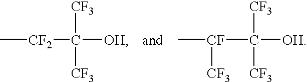

The acidic OH group in the above-mentioned moiety having —OH can have a pKa value of not more than 11 and is preferred.

The acidic OH group in —COOH can have a pKa value of not more than 11 irrespective of an ambient structure, and the pKa value is concretely not more than 6, more preferably not more than 5.

A lower limit of a pKa value of the acidic OH group in the hydrophilic group Y is 1, preferably 2, more preferably 3. If the pKa value is too low, depending on kind of the lower photoresist layer (L1), there is a case where too high acid strength or acid diffusion has an adverse effect on a pattern profile and causes an excessive decrease of a thickness of an un-exposed portion.

Those exemplified hydrophilic groups having —OH group are preferred particularly because of excellent transparency and a low refractive index, and the hydrophilic groups having —COOH group are preferred particularly from the viewpoint of water solubility and solubility in a developing solution.

Particularly —COOH group is useful and preferred especially for an antireflection film in a ArF or KrF photolithography process since it is excellent in water solubility and solubility in a developing solution and has transparency at a wavelength of not less than 193 nm.

A fluorine content of the fluorine-containing polymer (A) used for the antireflection layer (L2) of the present invention is not less than 50% by mass. When the fluorine content is less than 50% by mass, in a photolithography process using light of not more than 200 nm in a vacuum ultraviolet region at exposing, a refractive index measured at such a wavelength becomes too high. As a result, a reflection reducing effect cannot be obtained sufficiently, and an effect of decreasing an adverse influence on a resist pattern due to a standing wave effect and a multiple reflection effect becomes insufficient.

The fluorine content of the fluorine-containing polymer (A) is preferably not less than 55% by mass, more preferably not less than 57.5% by mass, which is preferred since it is possible to obtain a refractive index, for example, at 193 nm of not more than 1.46, particularly not more than 1.44, further not more than 1.42.

An upper limit of the fluorine content is 70% by mass, preferably 65% by mass, more preferably 62.5% by mass, especially 60% by mass. If the fluorine content is too high, water repellency of the formed film becomes too high and there is a case where a dissolution rate in a developing solution is decreased and repeatability of the dissolution rate is lowered.

Further in the present invention, it is important to use, for the antireflection layer (L2), a fluorine-containing polymer having a specific content or more of hydrophilic group Y, namely, a fluorine-containing polymer having a hydrophilic group content higher than that of conventional polymers.

Concretely the number of moles of the hydrophilic group Y in 100 g of the fluorine-containing polymer (A) is not less than 0.14, which gives good water solubility and good solubility in a developing solution (dissolution rate) and enables the polymer to be put into practical use.

If the number of moles of the hydrophilic group Y in 100 g of the fluorine-containing polymer (A) is less than 0.14, the polymer becomes insoluble in water or in a developing solution, or even if the polymer dissolves in a developing solution, a dissolution rate at the developing process is low and practicability of the polymer in a photolithography process becomes insufficient.

The number of moles of the hydrophilic group Y in 100 g of the fluorine-containing polymer (A) is not less than 0.21, more preferably not less than 0.22.

An upper limit of the content (the number of moles) of hydrophilic group Y is 0.5, more preferably 0.45, further preferably 0.4 in 100 g of the fluorine-containing polymer (A). If the content of hydrophilic group Y is too high, there is a case where transparency in a vacuum ultraviolet region is lowered and a refractive index is increased.

Particularly in the case that the hydrophilic group Y is carboxyl group (—COOH), if its content is increased too much, there is a high tendency that at a wavelength of 193 nm, transparency is lowered and a refractive index becomes worse (is increased). The number of moles of —COOH groups in 100 g of the polymer is preferably from 0.14 to 0.40, more preferably from 0.21 to 0.29, particularly preferably from 0.22 to 0.28. When the content of —COOH groups is in the above-mentioned range, it is possible to achieve good water solubility, a low refractive index and good transparency of the fluorine-containing polymer.

Also the present inventors have made studies regarding further enhancement of water solubility of the above-mentioned fluorine-containing polymer having high contents of —COOH group and fluorine, and as a result, have found that the fluorine-containing polymer having a specific number average molecular weight has good water solubility.

As a result, even in the case of dissolving the polymer in a solvent mixture of water and alcohol solvent, a mixing ratio of the alcohol solvent can be reduced, and it is possible to prevent lowering of a reflection reducing effect which arises due to intermixing at an interface when overcoating the coating composition on the resist film.

Further it was found out that when a composition is prepared by using water, water solubility can be maintained stably when storing for a long period of time. Also it was found out that good solubility is exhibited in the case of adding an acidic substance, surfactant, organic solvent and other additives.

Namely, a number average molecular weight of the above-mentioned fluorine-containing polymer having —COOH group is from 10,000 to 750,000, preferably from 20,000 to 500,000, more preferably from 31,000 to 300,000, particularly preferably from 40,000 to 200,000.

If the number average molecular weight is too low, water solubility is lowered. Even if the polymer can be dissolved in water, stability of the aqueous solution becomes insufficient, and also the fluorine-containing polymer is partially subject to sedimentation, precipitation or turbidity in white during storing or by adding additives.

On the other hand, if the number average molecular weight is too high, film forming property of the antireflection film is lowered, which is not preferred.

In the method of forming a laminated photoresist of the present invention, when the fluorine-containing polymer (A) satisfying the above-mentioned requirements with respect to kind (i) and content (iii) of the hydrophilic group Y and fluorine content (ii) is used for the antireflection layer (L2), the laminated photoresist can be practically applicable to conventional photoresist processes and can decrease an adverse effect on a resist pattern due to a standing wave effect and multiple reflection effect.

The first of the preferred examples of the fluorine-containing polymer (A) having hydrophilic group is a fluorine-containing polymer represented by the formula (M-1):
-(M1)-(N1)- (M-1)
wherein the structural unit M1 is a structural unit derived from a fluorine-containing monomer represented by the formula (1): 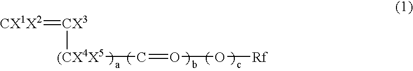
wherein X¹ and X² are the same or different and each is H or F; X³ is H, F, Cl, CH₃ or CF₃; X⁴ and X⁵ are the same or different and each is H or F; Rf is a monovalent organic group in which 1 to 4 hydrophilic groups Y are bonded to a fluorine-containing alkyl group having 1 to 40 carbon atoms or a monovalent organic group in which 1 to 4 hydrophilic groups Y are bonded to a fluorine-containing alkyl group having 2 to 100 carbon atoms and ether bond; a, b and c are the same or different and each is 0 or 1,
the structural unit N1 is a structural unit derived from a monomer copolymerizable with the fluorine-containing monomer of the formula (1), and
the structural units M1 and N1 are contained in amounts of from 30 to 100% by mole and from 0 to 70% by mole, respectively.

The fluorine-containing monomer of the formula (1) is characterized by having a monovalent organic group Rf containing a fluorine-containing alkyl group in its side chain and having 1 to 4 hydrophilic groups Y bonded to the Rf group. Since the monomer itself contains the hydrophilic groups Y and many fluorine atoms, a low refractive index, water solubility and solubility in a developing solution can be given to the polymer obtained from such a monomer.

Rf in the fluorine-containing monomer of the formula (1) is preferably a fluorine-containing alkyl group having 1 to 40 carbon atoms in which 1 to 4 hydrophilic groups Y are bonded or a fluorine-containing alkyl group having 2 to 100 carbon atoms and ether bond in which 1 to 4 hydrophilic groups Y are bonded. Usually Rf having one hydrophilic group Y is preferred.

Also preferred as the Rf is a perfluoro alkyl group having 1 to 40 carbon atoms in which hydrophilic group is bonded or a perfluoro alkyl group having 2 to 100 carbon atoms and ether bond in which hydrophilic group is bonded, from the point that a refractive index of the polymer can be decreased more.

Preferred examples of the hydrophilic group Y are the same as those exemplified above.

The fluorine-containing monomer of the formula (1) is preferred because polymerizability thereof is good and homopolymerization thereof or copolymerization with other fluorine-containing ethylenic monomer is possible.

The first preferred example of the fluorine-containing ethylenic monomer of the formula (1) having the hydrophilic group Y is a monomer represented by the formula (2): 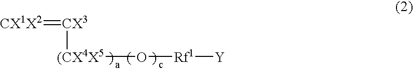
wherein X¹, X², X³, X⁴, X⁵, a, c and Y are as defined in the formula (1); Rf¹ is a divalent fluorine-containing alkylene group having 1 to 40 carbon atoms or a divalent fluorine-containing alkylene group having 2 to 100 carbon atoms and ether bond. The fluorine-containing ethylenic monomer of the formula (2) is preferred because polymerizability thereof is good and homopolymerization or copolymerization with other fluorine-containing ethylenic monomer is possible.

Examples of the fluorine-containing ethylenic monomer (2) having hydrophilic group Y are those represented by the formula (2-1):
CH₂═CFCF₂—O—Rf¹—Y (2-1)
wherein Rf¹ is as defined in the formula (2).

The monomers of the formula (2-1) are concretely fluorine-containing ethylenic monomers represented by: 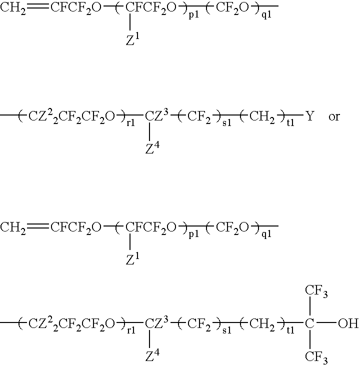
wherein Z¹ is F or CF₃; Z² and Z³ are H or F; Z⁴ is H, F or CF₃; p1+q1+r1 is 0 or an integer of 1 to 10; s1 is 0 or 1; t1 is 0 or an integer of 1 to 5; when both of Z³ and Z⁴ are H, p1+q1+r1+s1 is not 0. Those monomers are preferred because homopolymerizability thereof is excellent and more hydrophilic groups Y can be introduced to the fluorine-containing polymer, thereby enabling a low refractive index and excellent water solubility and solubility in a developing solution to be imparted to the antireflection layer (L2).

Also those monomers have high copolymerizability with fluorine-containing ethylene such as tetrafluoroethylene or vinylidene fluoride and can impart a low refractive index to the antireflection layer (L2).

Further examples thereof are: 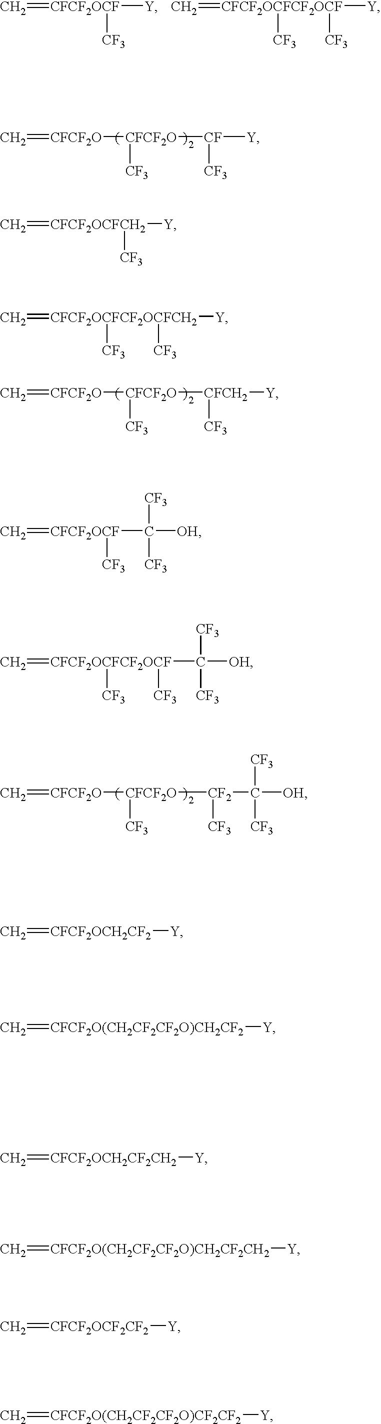 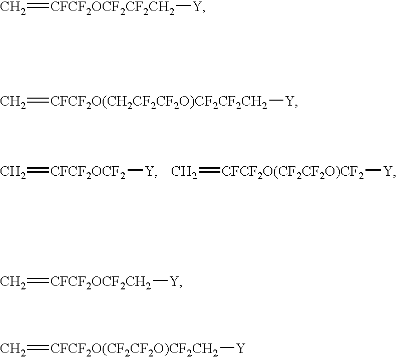
and the like. Among them, preferred are:

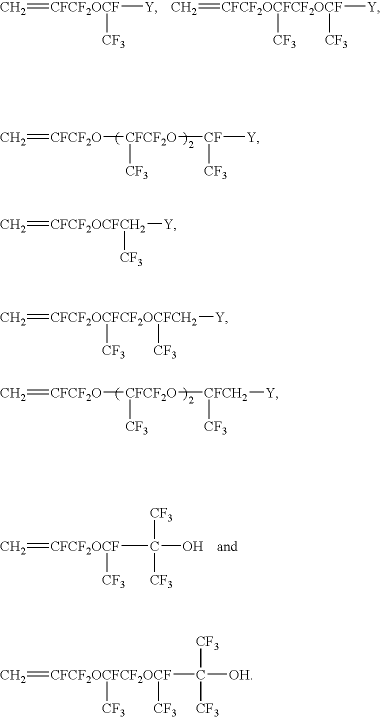

Further examples of the fluorine-containing monomer of the formula (2) having the hydrophilic group Y are fluorine-containing ethylenic monomers represented by the formula (2-2):
CF₂═CF—O—Rf¹—Y (2-2)
wherein Rf¹ is as defined in the formula (2).

The monomers of the formula (2-2) are concretely fluorine-containing ethylenic monomers represented by: 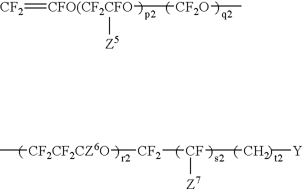
wherein Z⁵ is F or CF₃; Z⁶ is H or F; Z⁷ is H or F; p2+ q2+ r2 is 0 or an integer of 1 to 10; s2 is 0 or 1; t2 is 0 or an integer of 1 to 5. Those monomers are have high copolymerizability with fluorine-containing ethylene such as tetrafluoroethylene or vinylidene fluoride and can impart a low refractive index to the antireflection layer (L2).

Further examples of the monomer of the formula (2-2) are: 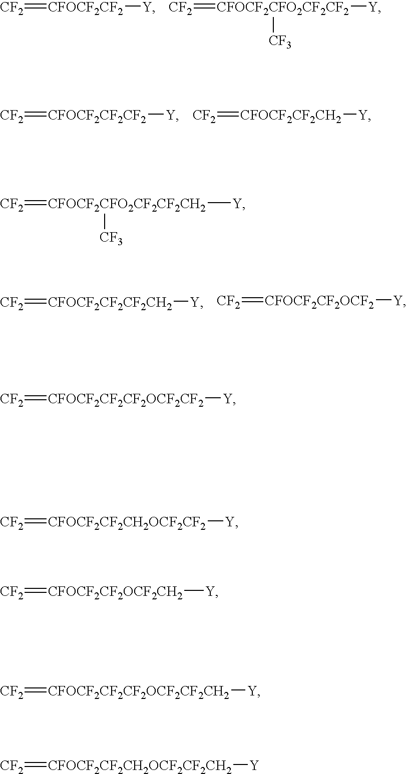
and the like.

Examples of other fluorine-containing ethylenic monomer of the formula (2) having hydrophilic group Y are:
CF₂═CFCF₂—O—Rf¹—Y, CF₂═CF—Rf¹—Y,
CH₂═CF—Rf¹—Y and CH₂═CH—O—Rf¹—Y,
wherein Rf¹ is as defined in the formula (2), and there are concretely: 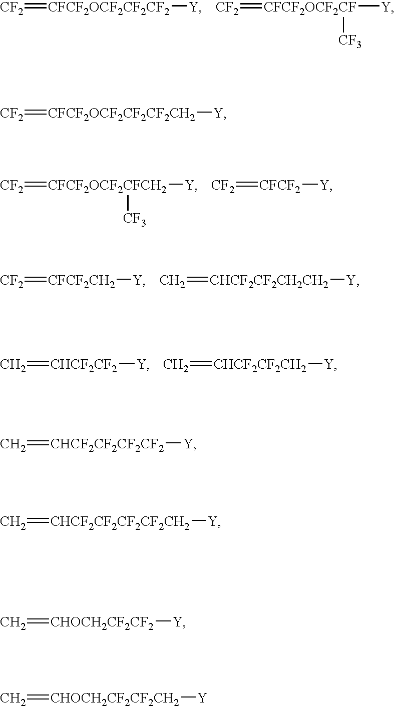
and the like.

Examples of the hydrophilic group Y of those fluorine-containing monomers are preferably those exemplified supra, and particularly preferred are —OH and —COOH, especially —COOH.

The second of preferred fluorine-containing ethylenic monomers of the formula (1) having the hydrophilic group Y are those represented by the formula (3): 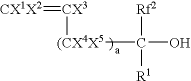
wherein X¹, X², X³, X⁴, X⁵ and a are as defined in the formula (1); Rf² is a fluorine-containing alkyl group which has 1 to 10 carbon atoms and may have ether bond; R¹ is at least one selected from the group consisting of H, a hydrocarbon group having 1 to 10 carbon atoms and a fluorine-containing alkyl group which has 1 to 10 carbon atoms and may have ether bond.

The fluorine-containing polymers obtained therefrom are excellent particularly in transparency and low in a refractive index, and when used for the antireflection layer (L2), are effective particularly in forming an ultrafine pattern.

Preferred examples of the fluorine-containing monomers of the formula (3) are concretely: 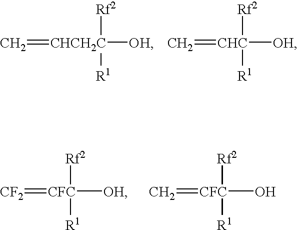
and the like, wherein Rf² and R¹ are as defined in the formula (3) and concretely there are:

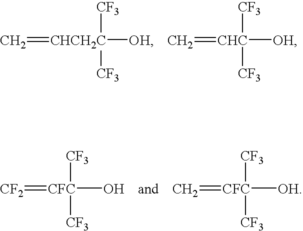

The fluorine-containing polymer of the formula (M-1) to be used for the antireflection layer (L2) of the present invention may be a homopolymer of the fluorine-containing monomer of the formula (1) having the hydrophilic group or a copolymer thereof with other monomer.

In the case of a homopolymerizable monomer among the monomers of the formula (1), the homopolymer is more preferred since a dissolution rate of the antireflection layer (L2) in a developing solution can be increased.

In the case of a copolymer, the structural unit (N1) as a copolymerizable component can be selected optionally, but is preferably so selected as to set a refractive index low within a range of maintaining solubility in a developing solution. Concretely the structural unit (N1) is selected from structural units derived from fluorine-containing ethylenic monomers.

Particularly preferred are those selected from the following structural units (N1-1) and (N1-2).

(N1-1) Structural Unit Derived from a Fluorine-Containing Ethylenic Monomer Having 2 or 3 Carbon Atoms and at Least One Fluorine Atom:

This structural unit N1-1 is preferred because a refractive index can be effectively decreased and transparency can be improved without lowering solubility in a developing solution, and also because a strength of the antireflection layer can be improved.

Concretely there are CF₂═CF₂, CF₂═CFCl, CH₂═CF₂, CFH═CH₂, CFH═CF₂, CF₂═CFCF₃, CH₂═CFCF₃, CH₂═CHCF₃ and the like. Among them, preferred are tetrafluoroethylene (CF₂═CF₂), chlorotrifluoroethylene (CF₂═CFCl) and vinylidene fluoride (CH₂═CF₂) from the viewpoint of good copolymerizability and high effects of imparting transparency and a low refractive index.
(N1-2) Structural Unit Derived from a Monomer Represented by the Formula (n1-2): 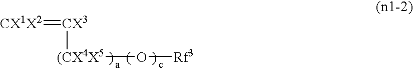
wherein X¹, X², X³, X⁴, X⁵, a and c are as defined in the formula (1); Rf³ is a fluorine-containing alkyl group having 1 to 40 carbon atoms or a fluorine-containing alkyl group having 2 to 100 carbon atoms and ether bond.

This structural unit is preferred since a refractive index can be effectively decreased and transparency can be improved effectively.

Preferred are:
CH₂═CFCF₂—O—Rf³, CF₂═CF—O—Rf³, CF₂═CFCF₂—O—Rf³,
CF₂═CF—Rf³, CH₂═CH—Rf³, CH₂═CH—O—Rf³
and the like, wherein Rf³ is as defined in the formula (n1-2).

The proportion of each structural unit in the fluorine-containing polymer of the formula (M-1) is optionally selected depending on the above-mentioned preferable fluorine content and hydrophilic group content. The structural units M1 and N1 are contained in amounts of preferably from 30 to 100% by mole and from 0 to 70% by mole, further preferably from 40 to 100% by mole and from 0 to 60% by mole, more preferably from 50 to 100% by mole and 0 to 50% by mole, especially preferably from 60 to 100% by mole and from 0 to 40% by mole, respectively.

The number average molecular weight of the fluorine-containing polymer of the formula (M-1) is from 1,000 to 1,000,000, preferably from 2,000 to 200,000, more preferably from 3,000 to 100,000, particularly preferably from 5,000 to 50,000.

If the molecular weight is too low, there is a case where there arise problems that a strength of the antireflection layer (L2) becomes too low and the fluorine-containing polymer itself penetrates into the lower photoresist layer (L1). Also there is a case where film forming property of the antireflection layer is lowered and as a result, formation of a uniform thin film becomes difficult.

The second of the preferred fluorine-containing polymer (A) to be used for the antireflection layer (L2) of the present invention is represented by the formula (M-2):
-(M2)-(N2)- (M-2)
wherein the structural unit M2 is a structural unit derived from a fluorine-containing monomer which has —COOH group as the hydrophilic group Y and is represented by the formula (4): 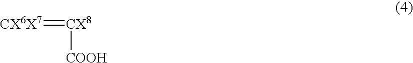
wherein X⁶ and X⁷ are the same or different and each is H or F; X⁸ is H, F, Cl, CH₃ or CF₃; at least one of X⁶, X⁷ and X⁸ contains fluorine atom,
the structural unit N2 is a structural unit derived from a monomer copolymerizable with the fluorine-containing monomer of the formula (4), and
the structural units M2 and N2 are contained in amounts of from 10 to 100% by mole and from 0 to 90% by mole, respectively.

This fluorine-containing polymer contains, as a component for imparting water solubility and solubility in a developing solution, a structural unit derived from a fluorine-containing acrylic acid which is a fluorine-containing monomer having —COOH group as the hydrophilic group Y. This polymer is preferred particularly from the viewpoint of excellent water solubility and solubility in a developing solution.

Examples of the fluorine-containing monomer of the formula (4) are: 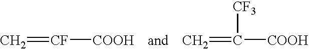
and the like, and particularly preferred are: 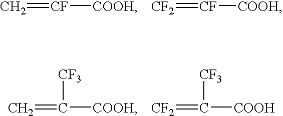
from the viewpoint of goof polymerizability.

The fluorine-containing polymer (M-2) to be used for the antireflection layer (L2) of the present invention may be a homopolymer of the fluorine-containing monomer of the formula (4), but it is usually preferable that the polymer contains the optional structural unit N2 by copolymerization.

The structural unit N2 of copolymerizable component can be selected optionally, but is preferably so selected as to set a refractive index low within a range of maintaining solubility in a developing solution. The structural unit N2 is concretely selected from structural units of the following fluorine-containing ethylenic monomers.

(N2-1) Structural Unit Derived from a Fluorine-Containing Acrylate Monomer:

Concretely preferred are structural units derived from fluorine-containing acrylate monomers represented by the formula (n2-1): 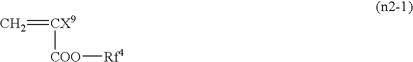
wherein X⁹ is H, F or CH₃; Rf⁴ is a fluorine-containing alkyl group having 1 to 40 carbon atoms or a fluorine-containing alkyl group having 2 to 100 carbon atoms and ether bond. Those monomers are preferred since copolymerizability with the fluorine-containing monomer of the formula (4) is high and a low refractive index can be imparted to the fluorine-containing polymer.

In the fluorine-containing acrylate of the formula (n2-1), examples of Rf⁴ group are: [symbol]
CH₂ [symbol] _{d1} [symbol] CF₂ [symbol] ₑ₁Z⁸
(Z⁸ is H, F or Cl; d1 is an integer of 1 to 4; e1 is an integer of 1 to 10) 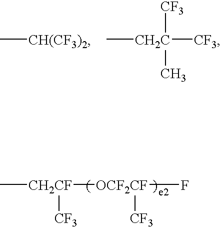
(e2 is an integer of 1 to 5), 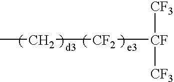
(d3 is an integer of 1 to 4; e3 is an integer of 1 to 10)
and the like.

(N2-2) Structural Unit Derived from a Fluorine-Containing Vinyl Ether Monomer:

Concretely preferred are structural units derived from fluorine-containing vinyl ethers represented by the formula (n2-2):
CH₂═CHO—Rf⁵ (n2-2)
wherein Rf⁵ is a fluorine-containing alkyl group having 1 to 40 carbon atoms or a fluorine-containing alkyl group having 2 to 100 carbon atoms and ether bond. Those monomers are preferred since copolymerizability with the fluorine-containing monomer of the formula (4) is high and a low refractive index can be imparted to the fluorine-containing polymer.

Preferred examples of the monomer of the formula (n2-2) are:
CH₂═CHOCH₂ [symbol] CF₂ [symbol] ₑ₄Z⁹
(Z⁹ is H or F; e4 is an integer of 1 to 10),
CH₂═CHOCH₂CH₂ [symbol] CF₂ [symbol] ₑ₅F
(e5 is an integer of 1 to 10), 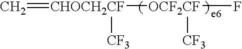
(e6 is an integer of 1 to 10)
and the like.

More concretely there are structural units derived from the following monomers: 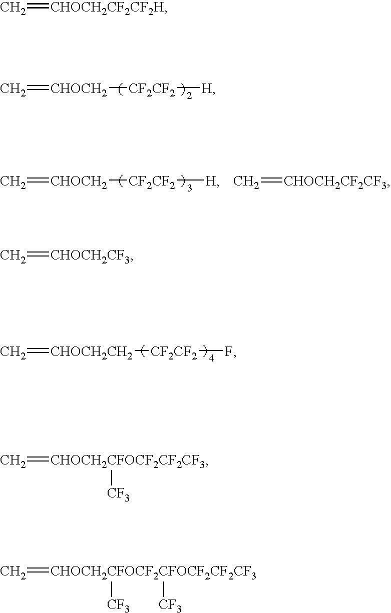
and the like.

Also there are the following structural units (N2-3) and (N2-4).

(N2-3) Structural Unit Derived from a Fluorine-Containing Allyl Ether Represented by the Formula (n2-3):
CH₂═CHCH₂O—Rf⁶ (n2-3)
wherein Rf⁶ is a fluorine-containing alkyl group having 1 to 40 carbon atoms or a fluorine-containing alkyl group having 2 to 100 carbon atoms and ether bond.
(N2-4) Structural Unit Derived from a Fluorine-Containing Vinyl Monomer Represented by the Formula (n2-4):
CH₂═CH—Rf⁷ (n2-4)
wherein Rf⁷ is a fluorine-containing alkyl group having 1 to 40 carbon atoms or a fluorine-containing alkyl group having 2 to 100 carbon atoms and ether bond.

Those structural units are preferred since a low refractive index can be given to the fluorine-containing polymer.

Examples of the monomers (n2-3) and (n2-4) are: 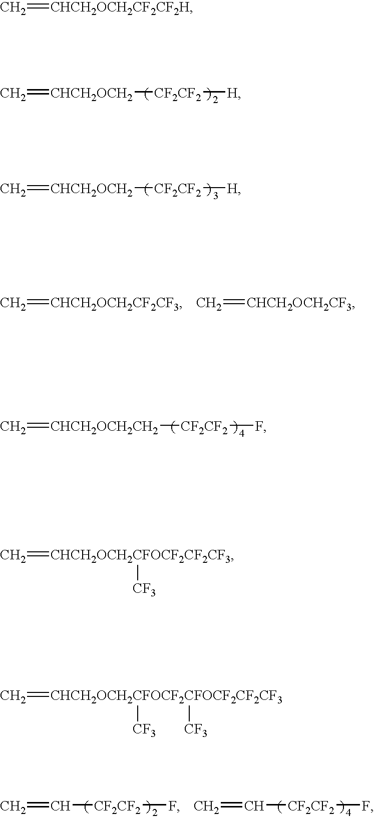
and the like.

The proportion of each structural unit in the fluorine-containing polymer of the formula (M-2) is optionally selected depending on the above-mentioned preferred fluorine content and hydrophilic group content. The structural units M2 and N2 are contained in amounts of preferably from 10 to 100% by mole and from 0 to 90% by mole, further preferably from 20 to 80% by mole and from 20 to 80% by mole, more preferably from 30 to 70% by mole and from 30 to 70% by mole, especially preferably from 40 to 60% by mole and from 40 to 60% by mole, respectively.

If the proportion of the structural unit (M2) is too low, water solubility and solubility in a developing solution become insufficient, and if the proportion of the structural unit (M2) is too high, a refractive index becomes too high. Therefore the both cases are not preferred.

The number average molecular weight of the fluorine-containing polymer of the formula (M-2) is from 1,000 to 1,000,000, preferably from 2,000 to 200,000, more preferably from 3,000 to 100,000, particularly preferably from 5,000 to 50,000.

If the molecular weight is too low, there is a case where there arise problems that a strength of the antireflection layer (L2) becomes too low and the fluorine-containing polymer itself penetrates into the lower photoresist layer (L1). Also there is a case where film forming property of the antireflection layer is lowered and as a result, formation of a uniform thin film becomes difficult.

Preferred examples of the fluorine-containing polymer (A) to be used for the antireflection layer (L2) of the present invention are fluorine-containing polymers represented by the following formulae (M-1-1), (M-1-2) and (M-2-1).

Fluorine-Containing Polymer which has a Number Average Molecular Weight of from 1,000 to 200,000 and is Represented by the Formula (M-1-1):
-(M11-1)- (M-1-1)
wherein the structural unit M1-1 is a structural unit derived from a monomer represented by the formula (2-1):
CH₂═CFCF₂—O—Rf¹—Y (2-1)
in which Rf¹ is as defined in the formula (2). Namely, the fluorine-containing polymer (A) is a fluorine-containing allyl ether homopolymer containing one or more monomers selected from the monomers of the formula (2-1). This polymer is preferred since both of a high fluorine content and a high hydrophilic group content can be obtained, thereby giving a low refractive index and excellent solubility in a developing solution.
Fluorine-Containing Polymer which has a Number Average Molecular Weight of from 1,000 to 200,000 and is Represented by the Formula (M-1-2):
-(M1-2)-(N1-1)- (M-1-2)
wherein the structural unit M1-2 is a structural unit derived from a monomer represented by the formula (3): 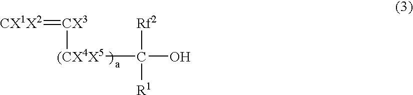
wherein X¹, X², X³, X⁴, X⁵, Rf², R¹ and a are as defined in the formula (3) mentioned supra,
the structural unit N1-1 is a structural unit derived from a fluorine-containing ethylenic monomer having 2 or 3 carbon atoms and at least one fluorine atom, and
the structural units M1-2 and N1-1 are contained in amounts of from 30 to 70% by mole and from 30 to 70% by mole, respectively.

Preferred monomers for the structural unit M1-2 are those exemplified supra in the monomers of the formula (3). Particularly preferred are structural units derived from monomers selected from: 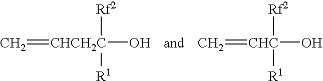
wherein Rf² and R¹ are as defined in the formula (3).

It is preferable that the structural unit N1-1 is a structural unit derived from a monomer selected from tetrafluoroethylene and chlorotrifluoroethylene.

Those monomers are preferred since transparency thereof is high particularly in the case of light in a vacuum ultraviolet region and a refractive index can be set low.

Fluorine-Containing Polymer which has a Number Average Molecular Weight of from 1,000 to 200,000 and is Represented by the Formula (M-2-1):
-(M2)-(N2-2)- (M-2-1)
wherein the structural unit M2 is a structural unit derived from a monomer represented by the formula (4): 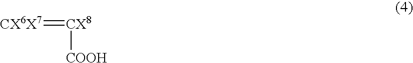
wherein X⁶, X⁷ and X⁸ are as defined in the formula (4) explained supra,
the structural unit N2-2 is a structural unit derived from a monomer represented by the formula (n2-2):
CH₂═CHO—Rf⁵ (n2-2)
in which Rf⁵ is as defined in the formula (n2-2) explained supra, and the structural units M2 and N2-2 are contained in amounts of from 30 to 70% by mole and from 30 to 70% by mole, respectively.

Preferred monomers for the structural unit M2 are those exemplified supra in the monomers of the formula (4). Particularly preferred are structural units derived from monomers selected from:

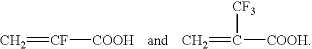

Preferred monomers for the structural unit N2-2 are those exemplified supra in the monomers of the formula (n2-2). Particularly preferred are structural units derived from monomers represented by:
CH₂═CHOCH₂— [symbol] CF₂ [symbol] ₑ₄Z⁹
wherein Z⁹ is H or F; e4 is an integer of 1 to 10.

Those polymers are preferred particularly because of excellent water solubility and solubility in a developing solution.

In the method of forming the laminated photoresist of the present invention, the antireflection layer (L2) is formed on the previously formed photoresist layer (L1) by applying the coating composition containing the above-mentioned fluorine-containing polymer (A).

The coating composition for forming the antireflection layer (L2) contains:

(A) the fluorine-containing polymer having the hydrophilic group Y and

(B) at least one solvent selected from the group consisting of water and alcohols.

It is preferable that the solvent (B) is selected from solvents which do not re-dissolve the previously formed lower photoresist layer (L1) when the coating composition is applied. From this point of view, the solvent (B) is preferably water and/or alcohols.

The fluorine-containing polymer (A) of the present invention has good solubility in those water and alcohols.

Among the solvents (B), water is not limited particularly. Preferred are distilled water, ion exchange water, water subjected to filtration and water subjected to adsorption treatment to remove organic impurities and metal ion.

Alcohols are optionally selected from those which do not re-dissolve the photoresist layer (L1), depending on kind of the photoresist layer (L1). Generally lower alcohols are preferred, and concretely methanol, ethanol, isopropanol, n-propanol and the like are preferred.

In addition to the solvent (B), a water soluble organic solvent may be used together for the purpose of improving coatability, etc. within a range not re-dissolving the photoresist layer (L1).

A water soluble organic solvent is not limited particularly as far as it dissolves in water in an amount of not less than 1% by mass. Preferred examples thereof are, for instance, ketones such as acetone and methyl ethyl ketone; esters of acetic acids such as methyl acetate and ethyl acetate; polar solvents such as dimethylformamide, dimethyl sulfoxide, methyl cellosolve, cellosolve acetate, butyl cellosolve, butyl carbitol and carbitol acetate; and the like.

An adding amount of the water soluble organic solvent to be added in addition to water or alcohol is from 0.1 to 50% by mass, preferably from 0.5 to 30% by mass, more preferably from 1 to 20% by mass, particularly preferably from 1 to 10% by mass based on the total amount of the solvent (B).

To the coating composition forming the antireflection layer (L2) of the present invention may be added, as case demands, at least one selected from basic substances, for example, ammonia and organic amines. In this case, there is a case where an acidic OH group having a pKa value of not more than 11 may be a hydrophilic moiety in the form of derivative, for example, ammonium salt, amine salt or the like in the coating composition.

Especially when the hydrophilic group Y in the fluorine-containing polymer (A) is —COOH or —SO₃H, the addition of the basic substance is effective for enhancing water solubility and solubility in a developing solution and also for maintaining repeatability of a dissolution rate in a developing solution. Also it is effective for adjusting the pH value of the coating composition to be within an optimum range.

With respect to the organic amines, preferred are water soluble organic amine compounds. Preferred examples thereof are, for instance, primary amines such as methylamine, ethylamine, propylamine, butylamine and cyclohexylamine; secondary amines such as dimethylamine, diethylamine, dipropylamine and dibutylamine; tertiary amines such as trimethylamine, triethylamine, tripropylamine, tributylamine, pyridine, pyrrole, piperidine, oxazole and morpholine; hydroxylamines such as monoethanolamine, propanolamine, diethanolamine, triethanolamine and tris(hydroxymethyl)aminomethane; quaternary ammonium compounds such as tetramethylammonium hydroxide, tetraethylammonium hydroxide, tetrapropylammonium hydroxide and tetrabutylammonium hydroxide; primary, secondary and tertiary polyamines such as ethylenediamine, diethylenediamine, tetraethylenediamine, diethylenetriamine, tetraethylenetriamine, imidazole, imidazolidine, pyrazine and s-triazine; and the like.

Among them, from the point of maintaining a low refractive index and increasing a dissolution rate in a developing solution, preferred are hydroxylamines such as monoethanolamine, propanolamine, diethanolamine, triethanolamine and tris(hydroxymethyl)aminomethane, and particularly preferred is monoethanolamine.

In the coating composition, ammonia or organic amine can be added usually in an amount of from 0.01 to 10 mole, preferably from 0.1 to 5 mole, more preferably from 0.5 to 1 mole based on 1 mole of hydrophilic group of the fluorine-containing polymer (A) to be used.

To the coating composition forming the antireflection layer (L2) of the present invention may be added, as case demands, a known surfactant.

The addition of a surfactant is effective for improving wettability of the coating composition to the surface of the lower photoresist layer (L1) and for forming a uniform thin film, and further is preferred for decreasing a surface tension of the obtained antireflection layer (L2) after the coating, thereby resulting in stabilization of solubility in a developing solution. Further the addition of surfactant is preferred for preventing striation.

Examples of the surfactant to be added are nonionic surfactants, anionic surfactants and ampholytic surfactants, and anionic surfactants are used preferably.

Examples of nonionic surfactants are polyoxyethylene alkyl ethers, for instance, polyoxyethylene lauryl ether, polyoxyethylene stearyl ether, polyoxyethylene oleyl ether, polyoxyethylene cetyl ether, polyoxyethylene octyl phenyl ether, polyoxyethylene nonyl phenyl ether, polyethylene glycol dilaurate and polyethylene glycol distearate; polyoxyethylene fatty acid diester, polyoxy fatty acid monoester, polyoxyethylene/polyoxypropylene block polymer, acetylene glycol derivative and the like.

Examples of the anionic surfactants are alkyl diphenylether disulfonic acid and its ammonium salt or organic amine salt; alkyl diphenylether sulfonic acid and its ammonium salt or organic amine salt; alkylbenzene sulfonic acid and its ammonium salt or organic amine salt; polyoxyethylene alkyl ether sulfuric acid and its ammonium salt or organic amine salt; alkyl sulfuric acid and its ammonium salt or organic amine salt; and the like.

Examples of Ampholytic Surfactants are 2-alkyl-N-carboxymethyl-N-hydroxyethyl imidazolinium betaine, lauric acid amidopropylhydroxysulfone betaine and the like.

Also fluorine-containing surfactants are preferred because a low refractive index of the antireflection layer (L2) can be maintained. Examples thereof are: 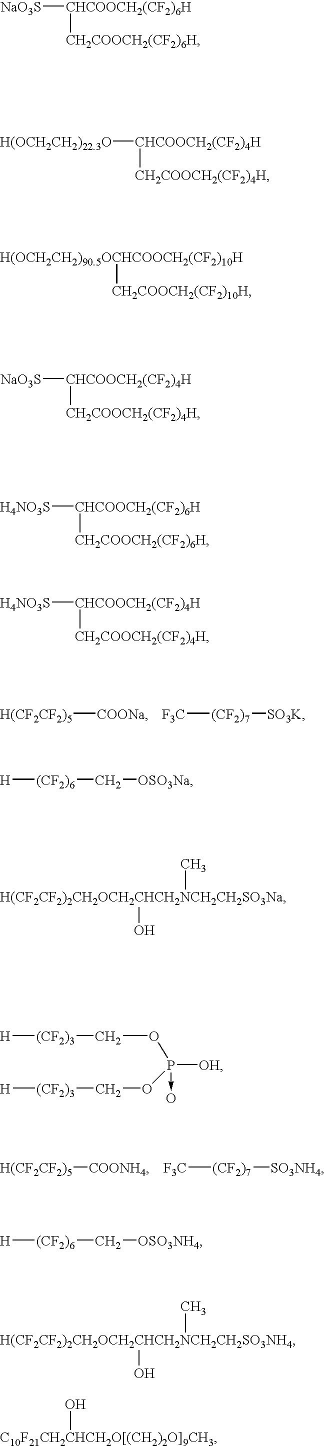 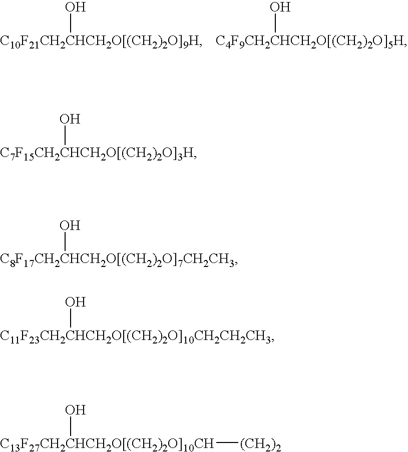
and the like

With respect to the fluorine-containing surfactants, not only the above-mentioned low molecular weight compounds but also the following high molecular weight compounds are preferred because a low refractive index of the antireflection layer (L2) can be maintained.

There are concretely copolymers having a number average molecular weight of 1,000 to 500,000 and containing component units derived from (a) acrylic ester or methacrylic acid ester having fluoroalkyl group (monomer (a)), (b) polyalkylene glycol acrylate or polyalkylene glycol methacrylate (monomer (b)), (c) 3-chloro-2-hydroxypropyl(meth)acrylate (monomer (c)) and (d) glycerol mono(meth)acrylate (monomer (d)), and fluorine-containing polymer surfactants containing such a copolymer.

The monomers providing each component unit are explained below.

Examples of the monomer (a) are, for instance, one or two or more compounds represented by the formula:
Rf²⁰R¹⁰OCOCR¹¹═CH₂
wherein Rf²⁰ is a linear or branched perfluoroalkyl group having 3 to 20 carbon atoms; R¹¹ is hydrogen atom or methyl; R¹⁰ is a linear or branched alkylene group having 1 to 10 carbon atoms, —SO₂N(R¹²)R¹³— group (R¹² is an alkyl group having 1 to 10 carbon atoms; R¹³ is a linear or branched alkylene group having 1 to 10 carbon atoms) or —CH₂CH(OR¹⁴)CH₂— group (R¹⁴ is hydrogen atom or an acyl group having 1 to 10 carbon atoms).

Examples of the monomer (a) are as follows. These monomers may be used alone or in a mixture of two or more thereof.

(a-1) CF₃(CF₂)ₙ(CH₂)ₘOCOCR¹¹═CH₂ (R¹¹ is Hydrogen Atom or Methyl; n is an Integer of 2 to 19, m is an Integer of 1 to 10)

Examples thereof are:
CF₃(CF₂)₇(CH₂)₁₀OCOCH═CH₂,
CF₃(CF₂)₇(CH₂)₂OCOCH═CH₂,
CF₃(CF₂)₆CH₂OCOC(CH₃)═CH₂,
CF₃(CF₂)₇(CH₂)₂OCOC(CH₃)═CH₂,
CF₃(CF₂)₉(CH₂)₂OCOC(CH₃)═CH₂,
CF₃(CF₂)₁₁(CH₂)₂OCOC(CH₃)═CH₂,
and the like.
(a-2) (CF₃)₂CF(CF₂)ₙ(CH₂)ₘOCOCR¹¹═CH₂ (R¹¹ is Hydrogen Atom or Methyl; n is 0 or an Integer of 1 to 17, m is an Integer of 1 to 10)

Examples thereof are:
(CF₃)₂CF(CF₂)₈(CH₂)₂OCOCH═CH₂
and the like.
(a-3) CF₃(CF₂)ₙSO₂N(R¹²)(CH₂)ₘOCOCR¹¹═CH₂ (R¹¹ is Hydrogen Atom or Methyl; R¹² is an Alkyl Group Having 1 to 10 Carbon Atoms; n is an Integer of 2 to 19, m is an Integer of 1 to 10)

Examples thereof are:
CF₃(CF₂)₇SO₂N(CH₃)(CH₂)₂OCOCH═CH₂
CF₃(CF₂)₇SO₂N(C₂H₅)(CH₂)₂OCOC(CH₃)═CH₂
and the like.
(a-4) (CF₃)₂CF(CF₂)ₙCH₂CH(OR¹⁴)(CH₂)ₘOCOCR¹¹═CH₂ (R¹¹ is Hydrogen Atom or Methyl; R¹⁴ is Hydrogen Atom or an Acyl Group Having 1 to 10 Carbon Atoms; n is 0 or an Integer of 1 to 17, m is an Integer of 1 to 10)

Examples thereof are:
(CF₃)₂CF(CF₂)₈CH₂CH(OCOCH₃)CH₂OCOC(CH₃)═CH₂,
(CF₃)₂CF(CF₂)₈CH₂CH(OH)CH₂OCOCH═CH₂
and the like.

Preferred examples of the monomer (b) are, for instance, one or two or more compounds represented by the formula:
CH₂═CR¹⁵COO—(R¹⁶O)ₙ—R¹⁷
wherein R¹⁵ and R¹⁷ are hydrogen atom or methyl; R¹⁶ is an alkylene group having 2 to 6 carbon atoms, n is an integer of 3 to 50.

Usually —CH₂CH₂— is suitable as R¹⁶. R¹⁶ may be —CH(CH₃)CH₂—, —CH(C₂H₅)CH₂— or the like. Namely, in the present invention, polyethylene glycol acrylate or methacrylate in which R¹⁶ is —CH₂CH₂— can be used particularly preferably. Also, n is selected from integers of 3 to 50, and usually when n is selected from integers of 9 to 25, especially good result can be obtained. It is a matter of course that the monomer (b) may be in the form of a mixture of two or more monomers having different kind of R¹⁶ and different number of n.

Examples of the monomer (b) are as follows. These monomers may be used alone or in a mixture of two or more thereof.

(b-1) CH₂═CR¹⁵COO(CH₂CH₂O)ₙR¹⁷ (R¹⁵ and R¹⁷ are Hydrogen Atom or Methyl; n is an Integer of 3 to 50)

Examples thereof are:
CH₂═C(CH₃)COO(CH₂CH₂O)₃H,
CH₂═C(CH₃)COO(CH₂CH₂O)₆H,
CH₂═C(CH₃)COO(CH₂CH₂O)₉H,
CH₂═C(CH₃)COO(CH₂CH₂O)₄₀H,
CH₂═C(CH₃)COO(CH₂CH₂O)₉CH₃,
CH₂═C(CH₃)COO(CH₂CH₂O)₂₃CH₃
and the like.
(b-2) CH₂═CR¹⁵COO(CH₂CH(CH₃)O)ₙR¹⁷ (R¹⁵ and R¹⁷ are Hydrogen Atom or Methyl; n is an Integer of 3 to 50)

Examples thereof are:
CH₂═C(CH₃)COO(CH₂CH(CH₃)O)₁₂H,
CH₂═CHCOO(CH₂CH(CH₃)O)₁₁CH₃
and the like.
(b-3) CH₂═CR¹⁵COO(CH₂CH₂O)ₙ(CH₂CH(CH₃)O)ₘR¹⁷ (R¹⁵ and R¹⁷ are Hydrogen Atom or Methyl; n+m is an Integer of 3 to 50)

Examples thereof are:
CH₂═C(CH₃)COO(CH₂CH₂O)₅(CH₂CH(CH₃)O)₃H
and the like.

3-Chloro-2-hydroxypropyl(meth)acrylate of the monomer (c) is 3-chloro-2-hydroxypropyl acrylate and/or 3-chloro-2-hydroxypropyl methacrylate represented by:
CH₂═CR¹⁸COOCH₂CH(OH)CH₂Cl
wherein R¹⁸ is hydrogen atom or methyl.

Glycerol mono(meth)acrylate of the monomer (d) is glycerol monoacrylate and/or glycerol monomethacrylate represented by:
CH₂═CR¹⁹COOCH₂CH(OH)CH₂OH
wherein R¹⁹ is hydrogen atom or methyl.

In the copolymer to be used in the present invention as a fluorine-containing polymer surfactant, a copolymerization ratio of the (meth)acrylic acid ester (monomer (a)) having fluoroalkyl group is at least 5% by mass, preferably from 6 to 70% by mass.

A copolymerization ratio of the polyalkylene glycol (meth)acrylate (monomer (b)) is at least 10% by mass, preferably from 14 to 60% by mass. If the ratio is less than 10% by mass, dispersibility in water tends to be lowered.

A copolymerization ratio of the 3-chloro-2-hydroxypropyl (meth)acrylate (monomer (c)) is at least 0.5% by mass, preferably from 0.5 to 30% by mass. A copolymerization ratio of the glycerol mono(meth)acrylate (monomer (d)) is at least 0.5% by mass, preferably from 0.5 to 30% by mass.

It is preferable that a total copolymerization ratio of 3-chloro-2-hydroxypropyl(meth)acrylate (monomer (c)) and glycerol mono(meth)acrylate (monomer (d)) is at least 1% by mass, preferably from 1.2 to 30% by mass. Also it is preferable that a ratio of 3-chloro-2-hydroxypropyl(meth)acrylate (monomer (c)) to the sum of monomer (c) and monomer (d) is from 10 to 90% by mass, particularly from 20 to 80% by mass.

A number average molecular weight of the fluorine-containing polymer surfactant is from 1,000 to 500,000, preferably from 5,000 to 200,000. If it is less than 1,000, durability tends to be lowered, and if it exceeds 500,000, a viscosity of the surfactant solution becomes high, and there is a case where workability is lowered. The fluorine-containing polymer surfactant may be a random copolymer or a block copolymer.

With respect to those copolymers to be used as the fluorine-containing polymer surfactant, besides the monomers (a), (b), (c) and (d) can be copolymerized a copolymerizable monomer having no fluoroalkyl group such as ethylene, vinyl chloride, halogenated vinylidene, styrene, (meth)acrylic acid, alkyl ester of (meth)acrylic acid, benzyl methacrylate, vinyl alkyl ketone, vinyl alkyl ether, isoprene, chloroprene, maleic anhydride or butadiene. When those other monomers are copolymerized, dispersibility, uniform coatability, water- and oil-repellency and durability can be enhanced and a low refractive index can be obtained. Also other various properties such as solubility and water resistance can be optionally improved. A copolymerization ratio of the comonomer having no fluoroalkyl group is from 0 to 40% by mass, preferably from 0 to 20% by mass.

The copolymer suitable as the fluorine-containing polymer surfactant of the present invention contains, for example, the following copolymerizable components, but the composition of the copolymer is not limited to them.

(Composition I)

Copolymer Containing:

19 to 22 parts by mass of monomer (a) represented by CF₃CF₂(CF₂CF₂)ₙCH₂CH₂OCOC(CH₃)═CH₂ (a mixture of compounds of n=3, n=4 and n=5 in a weight ratio of 5:3:1),

8 to 13 parts by mass of monomer (b) represented by CH₂═C(CH₃)COO(CH₂CH₂O)₉CH₃,

4 to 7 parts by mass of monomer (b) represented by CH₂═C(CH₃)COO(CH₂CH(CH₃)O)₁₂H,

3 to 5 parts by mass of monomer (c) represented by CH₂═C(CH₃)COOCH₂CH(OH)CH₂Cl and

1 to 2 parts by mass of monomer (d) represented by CH₂═C(CH₃)COOCH₂CH(OH)CH₂OH.

(Composition II)

Copolymer Containing:

8 to 13 parts by mass of monomer (a) represented by CF₃CF₂(CF₂CF₂)ₙCH₂CH₂OCOC(CH₃)═CH₂ (a mixture of compounds of n=3 and n=4 in a weight ratio of 5.4:1),

8 to 12 parts by mass of monomer (b) represented by CH₂═C(CH₃)COO(CH₂CH₂O)_{g}CH₃,

4 to 9 parts by mass of monomer (b) represented by CH₂═C(CH₃)COO(CH₂CH(CH₃)O)₁₂H,

0.5 to 3 parts by mass of monomer (c) represented by CH₂═C(CH₃)COOCH₂CH(OH)CH₂Cl and

0.3 to 2 parts by mass of monomer (d) represented by CH₂═C(CH₃)COOCH₂CH(OH)CH₂OH.

(Composition III)

Copolymer Containing:

5 to 8 parts by mass of monomer (a) represented by CF₃CF₂(CF₂CF₂)ₙCH₂CH₂OCOC(CH₃)═CH₂ (a mixture of compounds of n=3 and n=4 in a weight ratio of 3.9:1),

14 to 17 parts by mass of monomer (b) represented by CH₂═C(CH₃)COO(CH₂CH₂O)_{g}CH₃,

5 to 8 parts by mass of monomer (b) represented by CH₂═C(CH₃)COO(CH₂CH(CH₃)O)₁₂H,

0.5 to 1.5 parts by mass of monomer (c) represented by CH₂═C(CH₃)COOCH₂CH(OH)CH₂Cl and

0.5 to 1.5 parts by mass of monomer (d) represented by CH₂═C(CH₃)COOCH₂CH(OH)CH₂OH.

Examples of commercial products of the copolymer are KP341 (trade name available from Shin-Etsu Chemical Co., Ltd.), POLYFLOW No. 75 and POLYFLOW No. 95 (trade name available from Kyoeisha Chemical Co., Ltd.), F TOP EF301, EF303, EF352 and EF204 (trade name available from Tokem Products Co., Ltd.), MEGAFAC F171 and F173 (trade name available from Dai-Nippon Ink and Chemicals Incorporated), Fluorad FC430 and FC431 (trade name available from Sumitomo Three M), Asahi Guard AG710, Surfron S-382, SC-101, SC-102, SC-103, SC-104, SC-105 and SC-106 (trade name available from Asahi Glass Co., Ltd.) and the like. Those surfactants can be used alone or in a mixture of two or more thereof.

An amount of the surfactant is usually not more than 100 parts by mass, preferably not more than 70 parts by mass, particularly preferably from 0.1 to 50 parts by mass based on 100 parts by mass of the sum of polymer components in the antireflection film material.

To the coating composition forming the antireflection layer (L2) of the present invention may be added, as case demands, a known acid.

The acid is added mainly for the purpose of adjusting a pH value of the coating composition to be not more than 4, preferably not more than 3, more preferably not more than 2.

By forming the antireflection layer (L2) with the acidic coating composition, diffusion and migration of the acid to the antireflection layer (L2) from the photoresist layer (L1) after the exposure can be prevented and the resist pattern profile can be prevented from being in the form of T-top.

With respect to the acid to be used in the present invention, any of an organic acid and inorganic acid may be used. Preferred examples of the organic acid are alkyl sulfonic acid, alkylbenzene sulfonic acid, alkylcarboxylic acid, alkylbebzenecarboxylic acid and partly fluorinated acids thereof. Preferred alkyl groups are those having 1 to 20 carbon atoms. Those organic acids are used in an amount of usually from 0.1 to 2.0% by mass, preferably from 0.5 to 1.0% by mass in the composition.

Fluorine-containing organic acids may be fluoroalkylsulfonic acid and fluoroalkylcarboxylic acid having a fluorine chain of perfluoroalkyl group or hydrofluoroalkyl group, and the fluorine chain may be a linear or branched chain.

Examples of the fluoroalkyl group are not only those having 1 to 4 carbon atoms but also those having 5 to 15 carbon atoms. Other examples thereof are 1,1,2,2,3,3,4,4,5,5-decafluoropentyl group; 1,1,2,2,3,3,4,4,5,5,6,6-decafluorohexyl group; 1,1,2,2,3,3,4,4,5,5,6,6,7,7-tetradecafluoroheptyl group; 1,1,2,2,3,3,4,4,5,5,6,6,7,7,8,8-hexadecafluorooctyl group; 1,1,2,2,3,3,4,4,5,5,6,6,7,7,8,8,9,9-octadecafluorononyl group; 1,1,2,2,3,3,4,4,5,5,6,6,7,7,8,8,9,9,10,10-eicosafluorodecyl group; 2-(perfluorononyl)ethyl group, 2,2,3,3,4,4,5,5,6,6,7,7,8,8,9,9,10,10,11,11-eicosafluoroundecyl group, perfluorodecylmethyl group, 1,1,2,2,3,3,4,4,5,5,6,6,7,78,8,9,9,10,10,11,11-docosafluoroundecyl group, perfluoroundecyl group; 2-(perfluorodecyl)ethyl group, 2,2,3,3,4,4,5,5,6,6,7,7,8,8,9,9,10,10,11,11,12,12-docosafluorododecyl group, perfluoroundecylmethyl group, 1,1,2,2,3,3,4,4,5,5,6,6,7,7,8,8,9,9,10,10,11,11,12,12-tetracosafluorododecyl group, perfluorododecyl group; 2-(perfluoroundecyl)ethyl group, 2,2,3,3,4,4,5,5,6,6,7,7,8,8,9,9,10,10,11,11,12,12,13,13-tetracosafluorotridecyl group, perfluorododecylmethyl group, 1,1,2,2,3,3,4,4,5,5,6,6,7,7,8,8,9,9,10,10,11,11,12,12,13,13-hexacosafluorotridecyl group, perfluorotridecyl group, 2-(perfluorododecyl)ethyl group, 2,2,3,3,4,4,5,5,6,6,7,7,8,8,9,9,10,10,11,11,12,12,13,13,14,14-hexacosafluorotetradecyl group, perfluorotridecylmethyl group, 1,1,2,2,3,3,4,4,5,5,6,6,7,7,8,8,9,9,10,10,11,11,12,12,13,13,14,14-octacosafluorotetradecyl group, perfluorotetradecyl group, 2-(perfluorotridecyl)ethyl group, 2,2,3,3,4,4,5,5,6,6,7,7,8,8,9,9,10,10,11,11,12,12,13,13,14,14,15,15-octacosafluoropentadecyl group, perfluorotetradecylmethyl group, 1,1,2,2,3,3,4,4,5,5,6,6,7,7,8,8,9,9,10,10,11,11,12,12,13,13,14,14,15,15-triacontafluoropentadecyl group, perfluoropentadecyl group and the like.

Examples of such a fluoroalkylsulfonic acid are 2-(perfluoropropyl)ethanesulfonic acid, 1,1,2,2,3,3,4,4,5,5-decafluoropentanesulfonic acid, perfluoropentanesulfonic acid; 2-(perfluorobutyl)ethanesulfonic acid, 1,1,2,2,3,3,4,4,5,5,6,6-dodecafluorohexanesulfonic acid, perfluorohexanesulfonic acid, 2-(perfluoropentyl)ethanesulfonic acid, 1,1,2,2,3,3,4,4,5,5,6,6,7,7-tetradecafluoroheptanesulfonic acid, perfluoroheptanesulfonic acid; 2-(perfluorohexyl)ethanesulfonic acid, 1,1,2,2,3,3,4,4,5,5,6,6,7,7,8,8-hexadecafluorooctanesulfonic acid, perfluorooctanesulfonic acid; 2-(perfluoroheptyl)ethanesulfonic acid, 1,1,2,2,3,3,4,4,5,5,6,6,7,7,8,8,9,9-octadecafluorononanesulfonic acid, perfluorononanesulfonic acid; 2-(perfluorooctyl)ethanesulfonic acid, 1,1,2,2,3,3,4,4,5,5,6,6,7,7,8,8,9,9,10,10-eicosafluorodecanesulfonic acid, perfluorodecanesulfonic acid; 2-(perfluorononyl)ethanesulfonic acid, 1,1,2,2,3,3,4,4,5,5,6,6,7,7,8,8,9,9,10,10,11,11-docosafluoroundecanesulfonic acid, perfluoroundecanesulfonic acid; 2-(perfluorodecyl)ethanesulfonic acid, 1,1,2,2,3,3,4,4,5,5,6,6,7,7,8,8,9,9,10,10,11,11,12,12-tetracosafluorododecanesulfonic acid, perfluorododecanesulfonic acid; 2-(perfluoroundecyl)ethanesulfonic acid, 1,1,2,2,3,3,4,4,5,5,6,6,7,7,8,8,9,9,10,10,11,11,12,12,13,13-hexacosafluorotridecanesulfonic acid, perfluorotridecanesulfonic acid; 2-(perfluorododecyl)ethanesulfonic acid, 1,1,2,2,3,3,4,4,5,5,6,6,7,7,8,8,9,9,10,10,11,11,12,12,13,13,14,14-octacosafluorotetradecanesulfonic acid, perfluorotetradecanesulfonic acid; 2-(perfluorotridecyl)ethane sulfonic acid, 1,1,2,2,3,3,4,4,5,5,6,6,7,7,8,8,9,9,10,10,11,11,12,12,13,13,14,14,15,15-triacontafluoropentadecanesulfonic acid, perfluoropentadecanesulfonic acid and the like.

Examples of Fluoroalkylcarboxylic Acid are 2-(perfluoropropyl)ethanecarboxylic acid, 1,1,2,2,3,3,4,4,5,5-decafluoropentanecarboxylic acid, perfluoropentanecarboxylic acid; 2-(perfluorobutyl)ethanecarboxylic acid, 1,1,2,2,3,3,4,4,5,5,6,6-dodecafluorohexanecarboxylic acid, perfluorohexanecarboxylic acid; 2-(perfluoropentyl)ethanecarboxylic acid, 1,1,2,2,3,3,4,4,5,5,6,6,7,7-tetradecafluoroheptanecarboxylic acid, perfluoroheptanecarboxylic acid; 2-(perfluorohexyl)ethanecarboxylic acid, 1,1,2,2,3,3,4,4,5,5,6,6,7,7,8,8-hexadecafluorooctanecarboxylic acid, perfluorooctanecarboxylic acid; 2-(perfluoroheptyl)ethanecarboxylic acid, 1,1,2,2,3,3,4,4,5,5,6,6,7,7,8,8,9,9-octadecafluorononanecarboxylic acid, perfluorononanecarboxylic acid; 2-(perfluorooctyl)ethanecarboxylic acid, 1,1,2,2,3,3,4,4,5,5,6,6,7,7,8,8,9,9,10,10-eicosafluorodecanecarboxylic acid, perfluorodecanecarboxylic acid; 2-(perfluorononyl)ethanecarboxylic acid, 1,1,2,2,3,3,4,4,5,5,6,6,7,7,8,8,9,9,10,10,11,11-docosafluoroundecanecarboxylic acid, perfluoroundecanecarboxylic acid; 2-(perfluorodecyl)ethanecarboxylic acid, 1,1,2,2,3,3,4,4,5,5,6,6,7,7,8,8,9,9,10,10,11,11,12,12-tetracosafluorododecanecarboxylic acid, perfluorododecanecarboxylic acid; 2-(perfluoroundecyl)ethanecarboxylic acid, 1,1,2,2,3,3,4,4,5,5,6,6,7,7,8,8,9,9,10,10,11,11,12,12,13,13-hexacosafluorotridecanecarboxylic acid, perfluorotridecanecarboxylic acid; 2-(perfluorododecyl)ethanecarboxylic acid, 1,1,2,2,3,3,4,4,5,5,6,6,7,7,8,8,9,9,10,10,11,11,12,12,13,13,14,14-octacosafluorotetradecanecarboxylic acid, perfluorotetradecanecarboxylic acid; 2-(perfluorotridecyl)ethanecarboxylic acid, 1,1,2,2,3,3,4,4,5,5,6,6,7,7,8,8,9,9,10,10,11,11,12,12,13,13,14,14,15,15-triacontafluoropentadecanecarboxylic acid, perfluoropentadecanecarboxylic acid and the like.

Those fluoroalkylsulfonic acids and fluoroalkylcarboxylic acids can be used alone or in a mixture of two or more thereof.

Preferred examples of the inorganic acid are sulfuric acid, hydrochloric acid, nitric acid, phosphoric acid, hydrofluoric acid, hydrobromic acid and the like. Those inorganic acids are preferred for the purpose of adjusting a pH value of the coating composition to not more than 4.0. The inorganic acid is usually used in an amount of from 0.01 to 0.2% by mass based on the coating composition. The above-mentioned organic acids and inorganic acids may be used alone or in a mixture of two or more thereof.

To the coating composition forming the antireflection layer (L2) of the present invention may be added, as case demands, a water soluble polymer other than the fluorine-containing polymer (A). The water soluble polymer can be used for improving film forming property, and may be used within a range (kind and amount of the polymer) neither having an adverse effect on a refractive index of the coating film nor lowering transparency of the coating film.

Examples of the water soluble polymer are, for instance, polyvinyl alcohols, polyalkyl vinyl ethers (polymethyl vinyl ether, polyethyl vinyl ether), polyacrylic acids, acrylate resins having carboxyl group, polymethacrylic acids, polyethylene glycols, celluloses and the like.

An amount of the water soluble polymer is from 0.1 to 100 parts by mass, preferably from 0.5 to 5.0 parts by mass, more preferably from 1 to 30 parts by mass, particularly preferably from 1 to 10 parts by mass based on 100 parts by mass of the fluorine-containing polymer (A) contained in the coating composition.

To the coating composition forming the antireflection layer (L2) of the present invention may be added, as case demands, a known photoacid generator. The addition of the photoacid generator to the coating composition can prevent diffusion and migration of an acid to the antireflection layer (L2) from the photoresist layer (L1) after the exposure and the resist pattern profile can be prevented from being in the form of T-top.

Examples of the acid generator are, for instance, onium salt, haloalkyl group-containing compound, o-quinonediazide compound, nitrobenzyl compound, sulfonic acid ester compound, sulfone compound and the like. Those acid generators can be used alone or in a mixture of two or more thereof. The preferred acid generator is onium salt.

An amount of the acid generator is usually not more than 20 parts by mass, preferably not more than 10 parts by mass, particularly preferably not more than 5 parts by mass based on 100 parts by mass of the fluorine-containing polymer (A) contained in the coating composition. If the amount of the acid generator is too large, there is a tendency that developing property of the laminated resist is lowered and transparency and a refractive index of the antireflection layer (L2) are deteriorated.

Also to the coating composition forming the antireflection layer (L2) of the present invention may be added, as case demands, a defoaming agent, light absorbing agent, storage stabilizer, antiseptic agent, adhesion promoter, photoacid generator, dye and the like.

In the coating composition forming the antireflection layer (L2) of the present invention, the content of the fluorine-containing polymer (A) having hydrophilic group varies depending on kind and molecular weight of the polymer, kind and amount of additives, kind of a solvent and the like, and is optionally selected so that a suitable viscosity being capable of forming a thin coating film is obtained. For example, the content of the polymer is from 0.1 to 50% by mass, preferably from 0.5 to 30% by mass, more preferably from 1 to 20% by mass, particularly preferably from 2 to 10% by mass based on the whole coating composition.

The coating composition is applied on the photoresist layer (L1) to form the antireflection layer (L2). For the application, conventional methods are adopted. Examples of the suitable methods are rotary coating method, cast coating method, roll coating method and the like, and particularly a rotary coating method (spin coating method) is preferred. Other method of forming the antireflection layer (L2) is as mentioned infra.

Next, explained below are the method of forming the antireflection layer (L2) of the present invention on the photoresist layer (L1) to form the laminated photoresist and further one example of the method of forming a fine pattern using the laminated photoresist by means of the drawing.

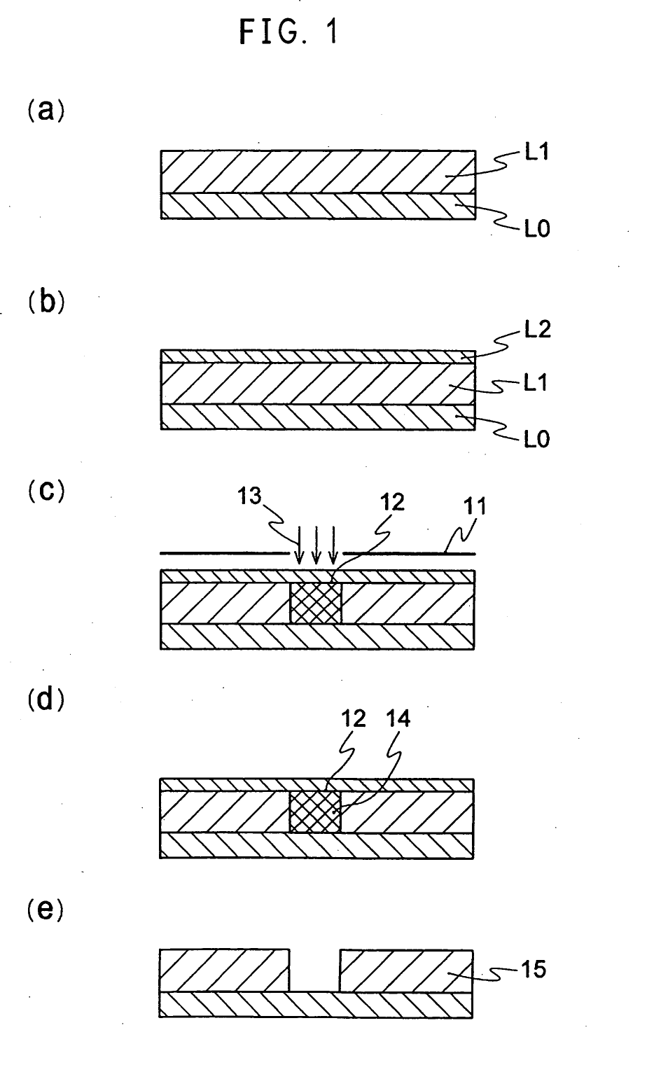

FIG. 1 is a diagrammatic view for explaining each step (a) to (e) of the method of forming a fine pattern via the method of forming the laminated photoresist of the present invention.

(a) A Step for Forming the Photoresist Layer (L1):

First, as shown in FIG. 1(a), the photoresist composition is coated on a substrate L0 by a rotary coating method or the like in a coating thickness of from 0.01 to 5 μm, preferably from 0.05 to 0.5 μm, more preferably from 0.1 to 0.3 μm.

Next, pre-baking treatment is carried out at a pre-determined temperature of not more than 150° C., preferably from 80° to 130° C. to form the photoresist layer (L1).

Examples of the above-mentioned substrate are, for instance, a silicon wafer; a glass substrate; a silicon wafer or glass substrate provided with an organic or inorganic antireflection film; a silicon wafer which has steps and is provided with various insulating films, electrode and wiring on a surface thereof; a mask blank; a semiconductor wafer of III-V group compound such as GaAs or AlGaAs and a semiconductor wafer of II-VI group compound; a piezoelectric wafer of crystal, quartz or lithium tantalate and the like.

In the present invention, conventional photoresist compositions can be used. There can be used, for example, a positive photoresist containing, as main components, novolak resin and diazonaphthoquinone (for g-line or i-line lithography), a chemically amplifying positive or negative resist prepared by using polyhydroxystyrene as a binder resin (for KrF lithography), a chemically amplifying positive photoresist prepared by using an acrylic polymer having an alicyclic structure at its side chain or an alicyclic polymer having a polynorbornene structure (for ArF lithography), a chemically amplifying positive photoresist prepared by using a fluorine-containing polymer (for F₂ lithography) and the like.

Since the antireflection layer (L2) of the present invention can realize a further lower refractive index as compared with conventional ones, it can be preferably applied especially to photography processes of a chemically amplifying positive photoresist using an acrylic polymer having an alicyclic structure at its side chain or an alicyclic polymer having a polynorbornene structure (ArF lithography) and a chemically amplifying positive photoresist prepared by using a fluorine-containing polymer (for F₂ lithography), and purposes such as precise pattern profile, high dimensional accuracy and repeatability thereof are achieved effectively.

(b) A Step for Forming the Antireflection Layer (L2):

As shown in FIG. 1(b), on the dried photoresist layer L1 is applied the coating composition containing the fluorine-containing polymer (A) by a rotary coating method. Then pre-baking is carried out, as case demands, to form the antireflection layer L2.

At that time, it is preferable that the thickness d_{tarc} of the antireflection layer L2 is adjusted to a thickness calculated by an equation:
d_{tarc}=x·λ/4n_{tarc}
wherein d_{tarc} is a thickness (nm) of the antireflection layer; x is an odd number integer; λ is an exposure wavelength (nm); n_{tarc} is a refractive index measured at an exposure wavelength (λ) of the antireflection layer, thereby exhibiting a reflection reducing effect at the upper interface of the resist film, namely lowering a reflectance and decreasing an influence of a standing wave.

The pre-baking conditions are optionally selected for the purpose of evaporating the residual solvent (B) in the antireflection layer L2 and forming a further uniform thin film. For example, the pre-baking temperature is selected within a range of from room temperature to 150° C., preferably from 40° to 120° C., more preferably from 60° to 100° C.

(c) An Exposure Step:

Subsequently as shown in FIG. 1(c), a pattern is drawn on the laminated photoresist (L1+L2) by irradiating the photoresist with energy rays as shown by an arrow 13 through a mask 11 having a desired pattern to selectively exposing a specific area 12.

In this case, examples of the energy rays (or chemical radiation) are, for instance, g-line (436 nm wavelength), i-line (365 nm wavelength), KrF excimer laser beam (248 nm wavelength), ArF excimer laser beam (193 nm wavelength), F₂ laser beam (157 nm wavelength) and the like. The energy ray is optionally selected depending on a photolithography process.

It is also possible to use, as an exposure light, X-ray, high energy electron beam, synchrotron radiation or the like or to scan electron beam, ion beam or the like without using the mask to directly expose the laminated photoresist to the pattern.

The reflection reducing effect of the present invention is exhibited most particularly when ArF excimer laser beam or F₂ laser beam is used as an exposure light.

Subsequently by carrying out post-exposure baking (PEB step) at a temperature of from 70° to 160° C., preferably from 90° to 140° C. for about 30 seconds to about 10 minutes, a latent image 14 is formed on the exposed area 12 of the photoresist layer L1 as shown in FIG. 1(d). At this time, an acid generated by the exposing acts as a catalyst to decompose the dissolution-inhibiting group (protective group) and thereby solubility in a developing solution is increased and the exposed area of the resist film becomes soluble in a developing solution.

Also the antireflection layer L2 may be removed by rinsing with pure water or the like before carrying out the above-mentioned post-exposure baking (PEB step) or may be removed in the developing step after the PEB.

(d) Developing Step:

Then when the photoresist layer L1 after the post-exposure baking is subjected to developing with a developing solution, the un-exposed area of the photoresist layer L1 remains on the substrate because its solubility in the developing solution is low but the exposed area 12 is dissolved in the developing solution as mentioned above.

On the other hand, the upper antireflection layer L2 is excellent in solubility in the developing solution irrespective of the exposed area and un-exposed area, and therefore even if it remains undissolved, it is removed together with the exposed portion in the developing step.

As the developing solution, an aqueous solution of 2.38% by mass of tetramethylammonium hydroxide is preferably used. Also to the aqueous solution of 2.38% by mass of tetramethylammonium hydroxide may be added a surfactant or alcohol such as methanol, ethanol, propanol or butanol in order to adjust wettability to the surfaces of antireflection layer L2 and photoresist layer L1.

Next, after flowing away the developing solution with pure water, lower alcohol or a mixture thereof, the substrate is dried and thus a desired resist pattern 15 can be formed as shown in FIG. 1(e).

Mentioned above is the explanation in the case of forming the laminated photoresist on the substrate L0, but the formation of the laminated photoresist is not limited to the case of forming the resist on a so-called substrate. The laminated photoresist may also be formed on a specific layer such as an electrically conductive film, insulating film or the like which is formed on the substrate. Also it is possible to form an antireflection film (lower antireflection layer), for example, DUV-30, DUV-32, DUV-42 and DUV44 available from Brewer Science Co., Ltd. on the substrate. The laminated photoresist may be formed on a substrate treated with an adhesion improver.

Also when an intended fine pattern of an electrically conductive film or an insulating film is formed by using the so-formed fine resist pattern as a mask and etching a specific layer under the mask and then other steps are carried out, semiconductor devices and electronic devices can be produced. Since those steps are well known, explanation thereof is omitted.

The second of the present invention relates to the coating composition containing the fluorine-containing polymer having —COOH group and the water soluble solvent. This is a particularly preferred coating composition for more effectively and efficiently obtaining the above-mentioned antireflection film to be provided on the resist film.

Namely, the coating composition of the present invention contains:

(A1) a fluorine-containing polymer having carboxyl group and

(B) at least one solvent selected from the group consisting of water and alcohols, and

the fluorine-containing polymer (A1) has a number average molecular weight of from 10,000 to 750,000 and is represented by the formula (M-3):
-(M3)-(N3)- (M-3)
wherein the structural unit M3 is a structural unit derived from a fluorine-containing monomer represented by the formula (5): 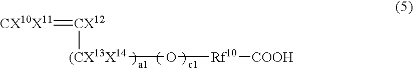
wherein X¹⁰ and X¹¹ are the same or different and each is H or F; X¹² is H, F, Cl, CH₃ or CF₃; X¹³ and X¹⁴ are the same or different and each is H or F; Rf¹⁰ is a divalent fluorine-containing alkylene group having 1 to 40 carbon atoms or a divalent fluorine-containing alkylene group having 2 to 100 carbon atoms and ether bond; a1 and c1 are the same or different and each is 0 or 1,
the structural unit N3 is a structural unit derived from a monomer copolymerizable with the fluorine-containing monomer of the formula (5), and
the structural units M3 and N3 are contained in amounts of from 55 to 100% by mole and from 0 to 45% by mole, respectively.

The coating composition of the present invention is featured especially by the fluorine-containing polymer (A1). Namely, by specifying the above-mentioned conditions with respect to the structure of the monomer (formula (5)) constituting the structural unit M3, the content of the structural unit M3 and the number average molecular weight of the polymer, the polymer stably dissolves in water or a solvent containing water, thin film forming property is good, and a good reflection reducing effect can be given to the resist film.

In the coating composition of the present invention, the fluorine-containing polymer (A1) contains the above-mentioned structural unit M3 as essential component and is a homopolymer of the monomer of the formula (5) or a copolymer of the monomer of the formula (5) with a monomer copolymerizable therewith.

It is important that the structural unit M3 has the fluorine-containing alkylene group Rf¹⁰ and —COOH group in its one side chain at the same time, and as a result, the both of hydrophilic property and a low refractive index can be imparted to the polymer.

In the monomer of the formula (5) constituting the structural unit M3, Rf¹⁰ is a divalent fluorine-containing alkylene group having 1 to 40 carbon atoms or a divalent fluorine-containing alkylene group having 2 to 100 carbon atoms and ether bond. It is particularly preferable that Rf¹⁰ is a perfluoro alkylene group having 1 to 40 carbon atoms or a divalent perfluoro alkylene group having 2 to 100 carbon atoms and ether bond, because a lower refractive index can be given to the polymer.

Examples of the fluorine-containing ethylenic monomer of the formula (5) having COOH group are fluorine-containing ethylenic monomers represented by the formula (5-1):
CH₂═CFCF₂—O—Rf¹⁰—COOH (5-1)
wherein Rf¹⁰ is as defined in the formula (5).

The monomers of the formula (5-1) are concretely fluorine-containing ethylenic monomers represented by: 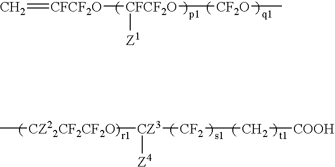
wherein Z¹ is F or CF₃; Z² and Z³ are H or F; Z⁴ is H, F or CF₃; p1+q1+r1 is 0 or an integer of 1 to 10; s1 is 0 or 1; t1 is 0 or an integer of 1 to 5; when both of Z³ and Z⁴ are H, p1+q1+r1+s1 is not 0. Those monomers are preferred since homopolymerizability thereof is excellent and more —COOH groups can be introduced to the fluorine-containing polymer, and as a result, good hydrophilic property can be given to the polymer and a low refractive index and excellent solubility in a developing solution can be imparted to the antireflection layer.

Also copolymerizability thereof with fluorine-containing ethylene such as tetrafluoroethylene or vinylidene fluoride is high and a lower refractive index can be imparted to the antireflection layer.

Preferred examples thereof are: 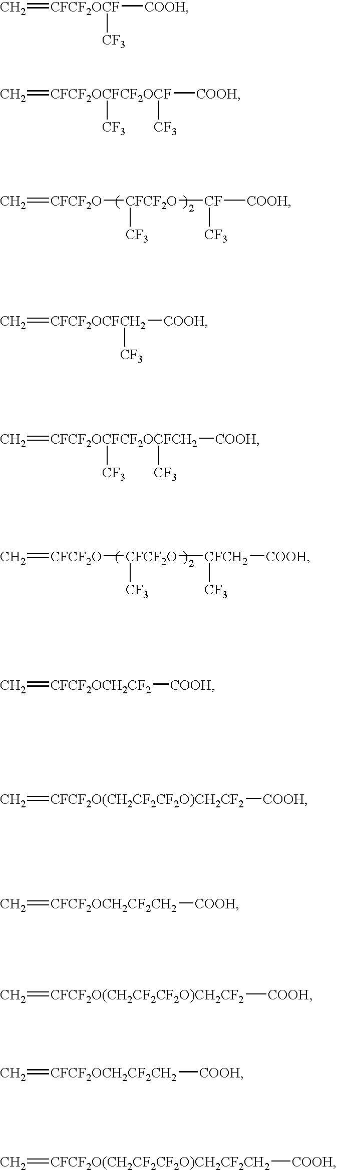 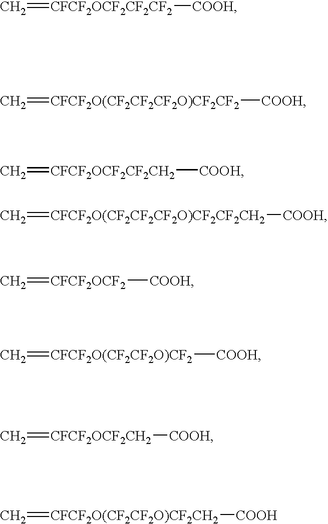
and the like, and particularly preferred are:

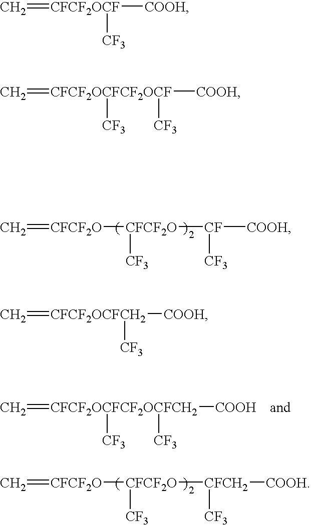

Further examples of the fluorine-containing ethylenic monomer of the formula (5) having —COOH group are fluorine-containing ethylenic monomers represented by the formula (5-2):
CF₂═CF—O—Rf¹¹—COOH (5-2)
wherein Rf¹⁰ is as defined in the formula (5).

The monomers of the formula (5-2) are concretely fluorine-containing ethylenic monomers represented by: 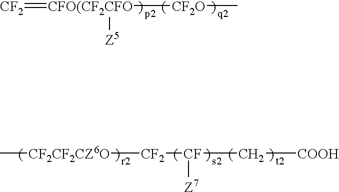
wherein Z⁵ is F or CF₃; Z⁶ is H or F; Z⁷ is H or F; p2+ q2+ r2 is 0 or an integer of 1 to 10; s2 is 0 or 1; t2 is 0 or an integer of 1 to 5. Those monomers have high copolymerizability with fluorine-containing ethylene such as tetrafluoroethylene or vinylidene fluoride and can impart a lower refractive index to the antireflection layer.

Preferred examples of the monomer of the formula (5-2) are: 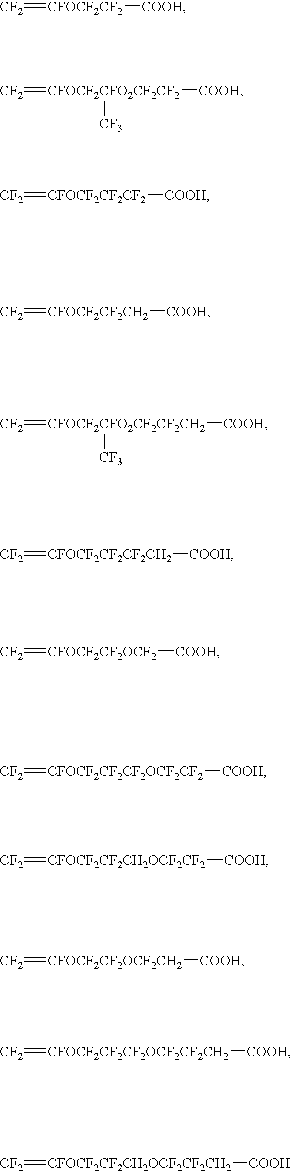
and the like.

Other examples of the fluorine-containing ethylenic monomer of the formula (5) having —COOH group are fluorine-containing ethylenic monomers represented by:
CF₂═CFCF₂—O—Rf¹⁰—COOH,
CF₂═CF—Rf¹⁰—COOH,
CH₂═CH—Rf¹⁰—COOH and
CH₂═CH—O—Rf¹⁰—COOH,
wherein Rf¹⁰ is as defined in the formula (5).

Examples thereof are: 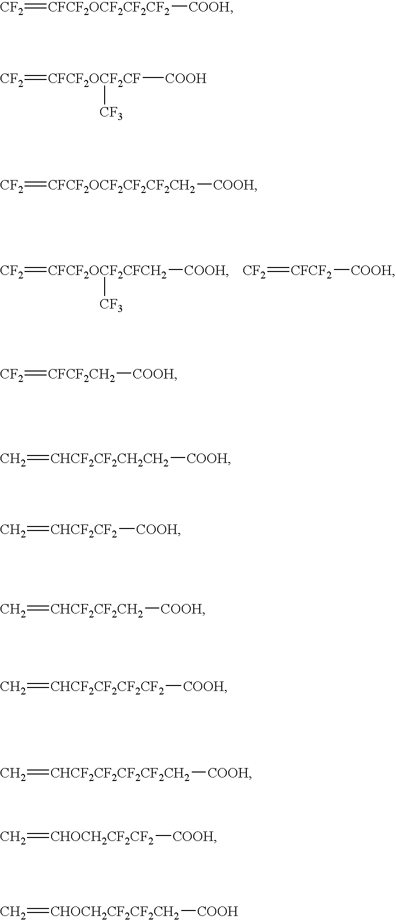
and the like.

In the case of a copolymer, the structural unit (N3) as a copolymerizable component can be optionally selected, but is preferably selected for the purpose of setting a refractive index low within a range of maintaining water solubility and solubility in a developing solution. Concretely the structural unit (N3) is selected from structural units derived from fluorine-containing ethylenic monomers.

Particularly preferred are those selected from structural units of the following (N3-1) and (N3-2).

(N3-1) Structural Units Derived from Fluorine-Containing Ethylenic Monomers Having 2 or 3 Carbon Atoms and at Least One Fluorine Atom:

This structural unit N3-1 is preferred since a refractive index can be effectively set low and transparency can be improved without lowering solubility in a developing solution and also since a strength of the antireflection layer can be increased.

There are concretely exemplified CF₂═CF₂, CF₂═CFCl, CH₂═CF₂, CFH═CH₂, CFH═CF₂, CF₂═CFCF₃, CH₂═CFCF₃, CH₂═CHCF₃ and the like. Among them, from the viewpoint of good copolymerizability and high effects of imparting transparency and a low refractive index, tetrafluoroethylene (CF₂═CF₂), chlorotrifluoroethylene (CF₂═CFCl) and vinylidene fluoride (CH₂═CF₂) are preferred.
(N3-2) Structural Units Derived from Monomers Represented by the Formula (n3-2): 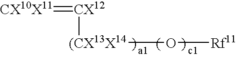
wherein X¹⁰, X¹¹, X¹², X¹³, X¹⁴, a1 and c1 are as defined in the formula (5); Rf¹¹ is a fluorine-containing alkyl group having 1 to 40 carbon atoms or a fluorine-containing alkyl group having 2 to 100 carbon atoms and ether bond.

Those structural units are preferred since a refractive index can be decreased effectively and transparency can be improved.

Preferred examples are:
CH₂═CFCF₂—O—Rf¹¹, CF₂═CF—O—Rf¹¹, CF₂═CFCF₂—O—Rf¹¹,
CF₂═CF—Rf¹, CH₂═CH—Rf¹, CH₂═CH—O—Rf¹¹
and the like, wherein Rf¹¹ is as defined in the formula (n3-2).

The proportions of each structural unit of the fluorine-containing polymer of the formula (M-3) are optionally selected depending on the above-mentioned preferred fluorine content and hydrophilic group content. A higher content of the structural unit M3 is preferred because water solubility is enhanced when a composition contains water, and also because a mixing ratio of alcohol can be decreased when solubility of the polymer (A1) is increased by mixing alcohol.

With respect to the proportions of components of the fluorine-containing polymer (A1) used for the coating composition of the present invention, the structural unit M3 and structural unit N3 are contained in amounts of from 55 to 100% by mole and from 0 to 45% by mole, preferably from 60 to 100% by mole and from 0 to 40% by mole, more preferably from 70 to 100% by mole and from 0 to 30% by mole, particularly preferably from 80 to 100% by mole and from 0 to 20% by mole.

Also among the monomers of the formula (5), in the case of homopolymerizable monomer, the homopolymer obtained therefrom is more preferred since water solubility of the fluorine-containing polymer (A1) and a dissolution rate of the antireflection film in a developing solution can be enhanced. Even in the case of the above-mentioned proportion of the structural unit M3, a low refractive index and transparency can be maintained by using the above-exemplified fluorine-containing monomers.

It is important that the number average molecular weight of the fluorine-containing polymer of the formula (M-3) is from 10,000 to 750,000, which enables the fluorine-containing polymer (A1) to stably maintain its hydrophilic property.

The number average molecular weight is preferably from 20,000 to 500,000, more preferably from 31,000 to 300,000, particularly preferably from 40,000 to 200,000.

If the number average molecular weight is too low, hydrophilic property of the fluorine-containing polymer (A1) is lowered, and in order to make the polymer soluble in a solvent containing water, much amount of alcohol solvent need be mixed. Therefore when forming the antireflection film on the resist film, a reflection reducing effect is lowered due to an intermixing phenomenon at an interface between them. Further the dissolution rate of the coated antireflection film in a developing solution is decreased and resolution of the resist is lowered.

On the contrary, if the molecular weight of the fluorine-containing polymer (A1) is too high, film forming property of the antireflection film is lowered and it becomes difficult to form a uniform thin film.

In the coating composition of the present invention, the solvent (B) is at least one selected from the group consisting of water and alcohols.

It is preferable that the solvent (B) is selected from solvents which do not re-dissolve the previously formed lower photoresist film when the coating composition is applied. From this point of view, the solvent (B) is preferably water and/or alcohols. Further it is preferable that the solvent is water alone or a solvent mixture of water and alcohol. It is particularly preferable that alcohols are not used as far as possible or a solvent mixture containing alcohol at a low ratio is used.

The fluorine-containing polymer (A1) of the present invention has good solubility in those water, alcohols and solvent mixture of water and alcohol.

Among the solvents (B), water is not limited particularly. Preferred are distilled water, ion exchange water, water subjected to filtration and water subjected to adsorption treatment to remove organic impurities and metal ion.

Alcohols are optionally selected from those which do not re-dissolve the lower photoresist layer (L1), depending on kind of the photoresist layer (L1). Generally lower alcohols having 1 to 6 carbon atoms are preferred, and concretely methanol, ethanol, isopropanol, n-propanol, butyl alcohols and the like are preferred.

When using a solvent mixture of water and alcohol, it is preferable that the mixing ratio of water is more than 60% by mass, more preferably more than 65% by mass, particularly preferably more than 70% by mass, further preferably more than 75% by mass based on the total amount of water and alcohol.

In addition to the solvent (B), a water soluble organic solvent may be used together for the purpose of improving coatability, etc. within a range not re-dissolving the photoresist layer (L1).

A water soluble organic solvent is not limited particularly as far as it dissolves in water in an amount of not less than 1% by mass. Examples thereof are, for instance, ketones such as acetone and methyl ethyl ketone; esters of acetic acids such as methyl acetate and ethyl acetate; polar solvents such as dimethylformamide, dimethyl sulfoxide, methyl cellosolve, cellosolve acetate, butyl cellosolve, butyl carbitol and carbitol acetate; and the like.

An adding amount of the water soluble organic solvent to be added in addition to water or alcohol is from 0.1 to 30% by mass, preferably from 0.5 to 20% by mass, more preferably from 1 to 10% by mass, particularly preferably from 1 to 5% by mass based on the total amount of solvents (B).

To the coating composition of the present invention may be added, as case demands, at least one selected from basic substances, for example, ammonia and organic amines. In this case, a part or the whole of —COOH groups in the fluorine-containing polymer (A1) may be, for example, in the form of salt such as ammonium salt or amine salt.

The addition of the basic substance is effective for enhancing water solubility and solubility in a developing solution and also for maintaining repeatability of the dissolution rate in a developing solution. Also it is effective for adjusting the pH value of the coating composition to be within an optimum range.

Further in the present invention, water solubility of the fluorine-containing polymer (A1) can be improved, and for example, even in the case of using a solvent mixture of water and alcohol, a mixing ratio of alcohol can be decreased and the polymer can be dissolved in a solvent containing water at a high mixing ratio or can be dissolved in a solvent of water only not containing alcohols.

With respect to organic amines, preferred are water soluble organic amine compounds. Preferred examples thereof are, for instance, primary amines such as methylamine, ethylamine, propylamine, butylamine and cyclohexylamine; secondary amines such as dimethylamine, diethylamine, dipropylamine and dibutylamine; tertiary amines such as trimethylamine, triethylamine, tripropylamine, tributylamine, pyridine, pyrrole, piperidine, oxazole and morpholine; hydroxylamines such as monoethanolamine, propanolamine, diethanolamine, triethanolamine and tris(hydroxymethyl)aminomethane; quaternary ammonium compounds such as tetramethylammonium hydroxide, tetraethylammonium hydroxide, tetrapropylammonium hydroxide and tetrabutylammonium hydroxide; primary, secondary and tertiary polyamines such as ethylenediamine, diethylenediamine, tetraethylenediamine, diethylenetriamine, tetraethylenetriamine, imidazole, imidazolidine, pyrazine and s-triazine; and the like.

Among them, from the point of maintaining a low refractive index, increasing the dissolution rate in a developing solution and improving water solubility, preferred are hydroxylamines such as monoethanolamine, propanolamine, diethanolamine, triethanolamine and tris(hydroxymethyl)aminomethane, and particularly preferred is monoethanolamine.

In the coating composition of the present invention, ammonia or organic amine can be added usually in an amount of from 0.01 to 10 mole, preferably from 0.1 to 5 mole, more preferably from 0.1 to 2 mole, particularly preferably from 0.4 to 1 mole based on 1 mole of hydrophilic group of the fluorine-containing polymer (A1) to be used.

To the coating composition of the present invention may be added, as case demands, a known surfactant.

The addition of a surfactant is effective for improving wettability of the coating composition to the surface of the lower photoresist layer and for forming a uniform thin film, and further is preferred for decreasing a surface tension of the obtained antireflection layer after the coating, thereby stabilizing solubility in a developing solution. Further the addition of a surfactant is preferred for preventing striation.

Also in the present invention, water solubility of the fluorine-containing polymer (A1) can be improved. For example, even in the case of using a solvent mixture of water and alcohol, a mixing ratio of alcohol can be decreased and the polymer can be dissolved in a solvent containing water at a higher mixing ratio or can be dissolved in a solvent of water only not containing alcohols.

Examples of the surfactant to be added are nonionic surfactants, anionic surfactants and ampholytic surfactants, and anionic surfactants are used preferably.

Examples of nonionic surfactants are polyoxyethylene alkyl ethers, for instance, polyoxyethylene lauryl ether, polyoxyethylene stearyl ether, polyoxyethylene oleyl ether, polyoxyethylene cetyl ether, polyoxyethylene octylphenyl ether, polyoxyethylene nonylphenyl ether, polyethylene glycol dilaurate and polyethylene glycol distearate; polyoxyethylene fatty acid diester, polyoxy fatty acid monoester, polyoxyethylene/polyoxypropylene block polymer, acetylene glycol derivative and the like.

Examples of the anionic surfactants are alkyl diphenylether disulfonic acid and its ammonium salt or organic amine salt; alkyl diphenylether sulfonic acid and its ammonium salt or organic amine salt; alkylbenzene sulfonic acid and its ammonium salt or organic amine salt; polyoxyethylene alkyl ether sulfuric acid and its ammonium salt or organic amine salt; alkyl sulfuric acid and its ammonium salt or organic amine salt; and the like.

Examples of Ampholytic Surfactants are 2-alkyl-N-carboxymethyl-N-hydroxyethyl imidazolinium betaine, lauric acid amidopropylhydroxysulfone betaine and the like.

Also fluorine-containing surfactants are preferred because a low refractive index of the antireflection layer can be maintained. Examples thereof are: 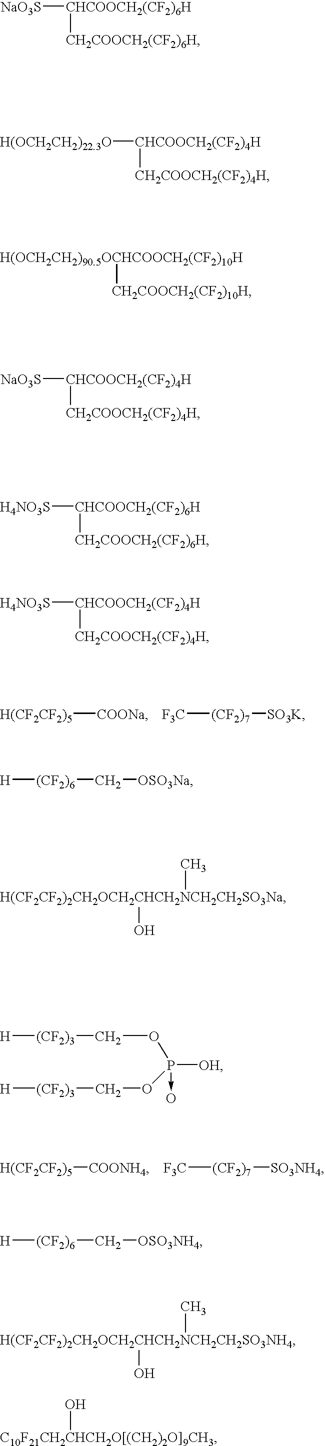 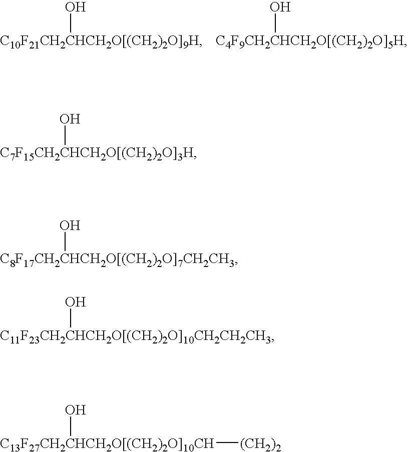
and the like

With respect to the fluorine-containing surfactants, not only the above-mentioned low molecular weight compounds but also the following high molecular weight compounds are preferred because a low refractive index of the antireflection layer (L2) can be maintained.

There are concretely copolymers having a number average molecular weight of 1,000 to 500,000 and containing component units derived from (a) acrylic ester or methacrylic acid ester having fluoroalkyl group (monomer (a)), (b) polyalkylene glycol acrylate or polyalkylene glycol methacrylate (monomer (b)), (c) 3-chloro-2-hydroxypropyl(meth)acrylate (monomer (c)) and (d) glycerol mono(meth)acrylate (monomer (d)) and fluorine-containing polymer surfactants containing such a copolymer.

The monomers providing each component unit are explained below.

Examples of the monomer (a) are, for instance, one or two or more compounds represented by the formula:
Rf²⁰R¹⁰OCOCR¹¹═CH₂
wherein Rf²⁰ is a linear or branched perfluoroalkyl group having 3 to 20 carbon atoms; R¹¹ is hydrogen atom or methyl; R¹⁰ is a linear or branched alkylene group having 1 to 10 carbon atoms, —SO₂N(R¹²)R¹³— group (R¹² is an alkyl group having 1 to 10 carbon atoms; R¹³ is a linear or branched alkylene group having 1 to 10 carbon atoms) or —CH₂CH(OR¹⁴)CH₂— group (R¹⁴ is hydrogen atom or an acyl group having 1 to 10 carbon atoms).

Preferred examples of the monomer (a) are as follows. Those monomers may be used alone or in a mixture of two or more thereof.

(a-1) CF₃(CF₂)ₙ(CH₂)ₘOCOCR¹¹═CH₂ (R¹¹ is Hydrogen Atom or Methyl; n is an Integer of 2 to 19, m is an Integer of 1 to 10)

Examples thereof are:
CF₃(CF₂)₇(CH₂)₁₀OCOCH═CH₂,
CF₃(CF₂)₇(CH₂)₂OCOCH═CH₂,
CF₃(CF₂)₆CH₂OCOC(CH₃)═CH₂,
CF₃(CF₂)₇(CH₂)₂OCOC(CH₃)═CH₂,
CF₃(CF₂)₉(CH₂)₂OCOC(CH₃)═CH₂,
CF₃(CF₂)₁₁(CH₂)₂OCOC(CH₃)═CH₂
and the like.
(a-2) (CF₃)₂CF(CF₂)ₙ(CH₂)ₘOCOCR¹¹═CH₂ (R¹¹ is Hydrogen Atom or Methyl; n is 0 or an Integer of 1 to 17, m is an Integer of 1 to 10)

Examples thereof are:
(CF₃)₂CF(CF₂)₈(CH₂)₂OCOCH═CH₂
and the like.
(a-3) CF₃(CF₂)ₙSO₂N(R¹²)(CH₂)ₘOCOCR¹¹═CH₂ (R¹¹ is Hydrogen Atom or Methyl; R¹² is an Alkyl Group Having 1 to 10 Carbon Atoms; n is an Integer of 2 to 19, m is an Integer of 1 to 10)

Examples thereof are:
CF₃(CF₂)₇SO₂N(CH₃)(CH₂)₂OCOCH═CH₂
CF₃(CF₂)₇SO₂N(C₂H₅)(CH₂)₂OCOC(CH₃)═CH₂
and the like.
(a-4) (CF₃)₂CF(CF₂)ₙCH₂CH(OR¹⁴)(CH₂)ₘOCOCR¹¹═CH₂ (R¹¹ is Hydrogen Atom or Methyl; R¹⁴ is Hydrogen Atom or an Acyl Group Having 1 to 10 Carbon Atoms; n is 0 or an Integer of 1 to 17, m is an Integer of 1 to 10)

Examples thereof are:
(CF₃)₂CF(CF₂)₈CH₂CH(OCOCH₃)CH₂OCOC(CH₃)═CH₂,
(CF₃)₂CF(CF₂)₈CH₂CH(OH)CH₂OCOCH═CH₂
and the like.

It is preferable that the monomer (b) is, for instance, one or two or more compounds represented by the formula:
CH₂═CR¹⁵COO—(R¹⁶O)ₙ—R¹⁷
wherein R¹⁵ and R¹⁷ are hydrogen atom or methyl; R¹⁶ is an alkylene group having 2 to 6 carbon atoms, n is an integer of 3 to 50.

Usually —CH₂CH₂— is suitable as R¹⁶. R¹⁶ may be —CH(CH₃)CH₂—, —CH(C₂H₅)CH₂— or the like. Namely, in the present invention, polyethylene glycol acrylate or methacrylate in which R¹⁶ is —CH₂CH₂— can be used particularly preferably. Also, n is selected from integers of 3 to 50, and usually when n is selected from integers of 9 to 25, especially good result can be obtained. It is a matter of course that the monomer (b) may be in the form of a mixture of two or more monomers having different kind of R¹⁶ and different number of n.

Examples of the monomer (b) are as follows. Those monomers may be used alone or in a mixture of two or more thereof.

(b-1) CH₂═CR¹⁵COO(CH₂CH₂O)ₙR¹⁷ (R¹⁵ and R¹⁷ are Hydrogen Atom or Methyl; n is an Integer of 3 to 50)

Examples thereof are:
CH₂═C(CH₃)COO(CH₂CH₂O)₃H,
CH₂═C(CH₃)COO(CH₂CH₂O)₆H,
CH₂═C(CH₃)COO(CH₂CH₂O)₉H,
CH₂═C(CH₃)COO(CH₂CH₂O)₄₀H,
CH₂═C(CH₃)COO(CH₂CH₂O)₉CH₃,
CH₂═C(CH₃)COO(CH₂CH₂O)₂₃CH₃
and the like.
(b-2) CH₂═CR¹⁵COO(CH₂CH(CH₃)O)ₙR¹⁷ (R¹⁵ and R¹⁷ are Hydrogen Atom or Methyl; n is an Integer of 3 to 50)

Examples thereof are:
CH₂═C(CH₃)COO(CH₂CH(CH₃)O)₁₂H,
CH₂═CHCOO(CH₂CH(CH₃)O)₁₁CH₃
and the like.
(b-3) CH₂═CR¹⁵COO(CH₂CH₂O)ₙ(CH₂CH(CH₃)O)ₘR¹⁷ (R¹⁵ and R¹⁷ are Hydrogen Atom or Methyl; n+m is an Integer of 3 to 50)

Examples thereof are:
CH₂═C(CH₃)COO(CH₂CH₂O)₅(CH₂CH(CH₃)O)₃H
and the like.

3-Chloro-2-hydroxypropyl(meth)acrylate of the monomer (c) is 3-chloro-2-hydroxypropyl acrylate and/or 3-chloro-2-hydroxypropyl methacrylate represented by:
CH₂═CR¹⁸COOCH₂CH(OH)CH₂Cl
wherein R¹⁸ is hydrogen atom or methyl.

Glycerol mono(meth)acrylate of the monomer (d) is glycerol monoacrylate and/or glycerol monomethacrylate represented by:
CH₂═CR¹⁹COOCH₂CH(OH)CH₂OH
wherein R¹⁹ is hydrogen atom or methyl.

In the copolymer to be used in the present invention as a fluorine-containing polymer surfactant, a copolymerization ratio of the (meth)acrylic acid ester (monomer (a)) having fluoroalkyl group is at least 5% by mass, preferably from 6 to 70% by mass.

A copolymerization ratio of the polyalkylene glycol (meth)acrylate (monomer (b)) is at least 10% by mass, preferably from 14 to 60% by mass. If the ratio is less than 10% by mass, dispersibility in water tends to be lowered.

A copolymerization ratio of the 3-chloro-2-hydroxypropyl (meth)acrylate (monomer (c)) is at least 0.5% by mass, preferably from 0.5 to 30% by mass. A copolymerization ratio of the glycerol mono(meth)acrylate (monomer (d)) is at least 0.5% by mass, preferably from 0.5 to 30% by mass.

It is preferable that a total amount of 3-chloro-2-hydroxypropyl(meth)acrylate (monomer (c)) and glycerol mono(meth)acrylate (monomer (d)) is at least 1% by mass, preferably from 1.2 to 30% by mass. Also it is preferable that a ratio of 3-chloro-2-hydroxypropyl(meth)acrylate (monomer (c)) to the sum of monomer (c) and monomer (d) is from 10 to 90% by mass, particularly from 20 to 80% by mass.

A number average molecular weight of the fluorine-containing polymer surfactant is from 1,000 to 500,000, preferably from 5,000 to 200,000. If it is less than 1,000, durability tends to be lowered, and if it exceeds 500,000, there is a case where a viscosity of the surfactant solution becomes high and workability is lowered. The fluorine-containing polymer surfactant may be a random copolymer or a block copolymer.

With respect to those copolymers to be used as the fluorine-containing polymer surfactant, besides the monomers (a), (b), (c) and (d) can be copolymerized a copolymerizable monomer having no fluoroalkyl group such as ethylene, vinyl chloride, halogenated vinylidene, styrene, (meth)acrylic acid, alkyl ester of (meth)acrylic acid, benzyl methacrylate, vinyl alkyl ketone, vinyl alkyl ether, isoprene, chloroprene, maleic anhydride or butadiene. When those other monomers are copolymerized, dispersibility, uniform coatability, water- and oil-repellency and durability can be enhanced and a low refractive index can be obtained. Also other various properties such as solubility and water resistance can be optionally improved. A copolymerization ratio of the comonomer having no fluoroalkyl group is from 0 to 40% by mass, preferably from 0 to 20% by mass.

The copolymer suitable as the fluorine-containing polymer surfactant of the present invention contains, for example, the following copolymerizable components, but the composition of the copolymer is not limited to them.

(Composition I)

Copolymer Containing:

19 to 22 parts by mass of monomer (a) represented by CF₃CF₂(CF₂CF₂)ₙCH₂CH₂OCOC(CH₃)═CH₂ (a mixture of compounds of n=3, n=4 and n=5 in a weight ratio of 5:3:1),

8 to 13 parts by mass of monomer (b) represented by CH₂═C(CH₃)COO(CH₂CH₂O)_{g}CH₃,

4 to 7 parts by mass of monomer (b) represented by CH₂═C(CH₃)COO(CH₂CH(CH₃)O)₁₂H,

3 to 5 parts by mass of monomer (c) represented by CH₂═C(CH₃)COOCH₂CH(OH)CH₂Cl and

1 to 2 parts by mass of monomer (d) represented by CH₂═C(CH₃)COOCH₂CH(OH)CH₂OH.

(Composition II)

Copolymer Containing:

8 to 13 parts by mass of monomer (a) represented by CF₃CF₂(CF₂CF₂)ₙCH₂CH₂OCOC(CH₃)═CH₂ (a mixture of compounds of n=3 and n=4 in a weight ratio of 5.4:1),

8 to 12 parts by mass of monomer (b) represented by CH₂═C(CH₃)COO(CH₂CH₂O)₉CH₃,

4 to 9 parts by mass of monomer (b) represented by CH₂═C(CH₃)COO(CH₂CH(CH₃)O)₁₂H,

0.5 to 3 parts by mass of monomer (c) represented by CH₂═C(CH₃)COOCH₂CH(OH)CH₂Cl and

0.3 to 2 parts by mass of monomer (d) represented by CH₂═C(CH₃)COOCH₂CH(OH)CH₂OH.

(Composition III)

Copolymer Containing:

5 to 8 parts by mass of monomer (a) represented by CF₃CF₂(CF₂CF₂)ₙCH₂CH₂OCOC(CH₃)═CH₂ (a mixture of compounds of n=3 and n=4 in a weight ratio of 3.9:1),

14 to 17 parts by mass of monomer (b) represented by CH₂═C(CH₃)COO(CH₂CH₂O)₉CH₃,

5 to 8 parts by mass of monomer (b) represented by CH₂═C(CH₃)COO(CH₂CH(CH₃)O)₁₂H,

0.5 to 1.5 parts by mass of monomer (c) represented by CH₂═C(CH₃)COOCH₂CH(OH)CH₂Cl and

0.5 to 1.5 parts by mass of monomer (d) represented by CH₂═C(CH₃)COOCH₂CH(OH)CH₂OH.

Examples of commercial products of the copolymer are KP341 (trade name available from Shin-Etsu Chemical Co., Ltd.), POLYFLOW No. 75 and POLYFLOW No. 95 (trade name available from Kyoeisha Chemical Co., Ltd.), F TOP EF301, EF303, EF352 and EF204 (trade name available from Tokem Products Co., Ltd.), MEGAFAC F171 and F173 (trade name available from Dai-Nippon Ink and Chemicals Incorporated), Fluorad FC430 and FC431 (trade name available from Sumitomo Three M), Asahi Guard AG710, Surfron S-382, SC-101, SC-102, SC-103, SC-104, SC-105 and SC-106 (trade name available from Asahi Glass Co., Ltd.) and the like. Those surfactants can be used alone or in a mixture of two or more thereof.

An amount of the surfactant is usually not more than 100 parts by mass, preferably not more than 70 parts by mass, particularly preferably from 0.01 to 50 parts by mass, especially from 0.1 to 30 parts by mass, further from 0.5 to 20 parts by mass based on the total parts by mass of polymer components in the antireflection film material.

To the coating composition of the present invention may be added, as case demands, a known acid.

The acid is added mainly for the purpose of adjusting a pH value of the coating composition to be not more than 4, preferably not more than 3, more preferably not more than 2.

By forming the antireflection layer (L2) with the acidic coating composition, diffusion and migration of an acid to the antireflection layer from the photoresist layer after the exposure can be prevented and the resist pattern profile can be prevented from being in the form of T-top.

With respect to the acid to be used in the present invention, any of an organic acid and inorganic acid may be used. Preferred examples of the organic acid are alkylsulfonic acid, alkylbenzenesulfonic acid, alkylcarboxylic acid, alkylbebzenecarboxylic acid and partly fluorinated acids thereof. Preferred alkyl groups are those having 1 to 20 carbon atoms. Those organic acids are used in an amount of usually from 0.1 to 2.0% by mass, preferably from 0.5 to 1.0% by mass in the composition.

Fluorine-containing organic acids may be fluoroalkylsulfonic acid and fluoroalkylcarboxylic acid having a fluorine chain of perfluoroalkyl group or hydrofluoroalkyl group, and the fluorine chain may be a linear or branched chain.

Examples of the fluoroalkyl group are not only those having 1 to 4 carbon atoms but also those having 5 to 15 carbon atoms. Other examples thereof are 1,1,2,2,3,3,4,4,5,5-decafluoropentyl group; 1,1,2,2,3,3,4,4,5,5,6,6-decafluorohexyl group; 1,1,2,2,3,3,4,4,5,5,6,6,7,7-tetradecafluoroheptyl group; 1,1,2,2,3,3,4,4,5,5,6,6,7,7,8,8-hexadecafluorooctyl group; 1,1,2,2,3,3,4,4,5,5,6,6,7,7,8,8,9,9-octadecafluorononyl group; 1,1,2,2,3,3,4,4,5,5,6,6,7,7,8,8,9,9,10,10-eicosafluorodecyl group; 2-(perfluorononyl)ethyl group, 2,2,3,3,4,4,5,5,6,6,7,7,8,8,9,9,10,10,11,11-eicosafluoroundecyl group, perfluorodecylmethyl group, 1,1,2,2,3,3,4,4,5,5,6,6,7,78,8,9,9,10,10,11,11-docosafluoroundecyl group, perfluoroundecyl group; 2-(perfluorodecyl)ethyl group, 2,2,3,3,4,4,5,5,6,6,7,7,8,8,9,9,10,10,11,11,12,12-docosafluorododecyl group, perfluoroundecylmethyl group, 1,1,2,2,3,3,4,4,5,5,6,6,7,7,8,8,9,9,10,10,11,11,12,12-tetracosafluorododecyl group, perfluorododecyl group; 2-(perfluoroundecyl)ethyl group, 2,2,3,3,4,4,5,5,6,6,7,7,8,8,9,9,10,10,11,11,12,12,13,13-tetracosafluorotridecyl group, perfluorododecylmethyl group, 1,1,2,2,3,3,4,4,5,5,6,6,7,7,8,8,9,9,10,10,11,11,12,12,13,13-hexacosafluorotridecyl group, perfluorotridecyl group, 2-(perfluorododecyl)ethyl group, 2,2,3,3,4,4,5,5,6,6,7,7,8,8,9,9,10,10,11,11,12,12,13,13,14,14-hexacosafluorotetradecyl group, perfluorotridecylmethyl group, 1,1,2,2,3,3,4,4,5,5,6,6,7,7,8,8,9,9,10,10,11,11,12,12,13,13,14,14-octacosafluorotetradecyl group, perfluorotetradecyl group, 2-(perfluorotridecyl)ethyl group, 2,2,3,3,4,4,5,5,6,6,7,7,8,8,9,9,10,10,11,11,12,12,13,13,14,14,15,15-octacosafluoropentadecyl group, perfluorotetradecylmethyl group, 1,1,2,2,3,3,4,4,5,5,6,6,7,7,8,8,9,9,10,10,11,11,12,12,13,13,14,14,15,15-triacontafluoropentadecyl group, perfluoropentadecyl group and the like.

Examples of such a fluoroalkylsulfonic acid are 2-(perfluoropropyl)ethanesulfonic acid, 1,1,2,2,3,3,4,4,5,5-decafluoropentanesulfonic acid, perfluoropentanesulfonic acid; 2-(perfluorobutyl)ethanesulfonic acid, 1,1,2,2,3,3,4,4,5,5,6,6-dodecafluorohexanesulfonic acid, perfluorohexanesulfonic acid, 2-(perfluoropentyl)ethanesulfonic acid, 1,1,2,2,3,3,4,4,5,5,6,6,7,7-tetradecafluoroheptanesulfonic acid, perfluoroheptanesulfonic acid; 2-(perfluorohexyl)ethanesulfonic acid, 1,1,2,2,3,3,4,4,5,5,6,6,7,7,8,8-hexadecafluorooctanesulfonic acid, perfluorooctanesulfonic acid; 2-(perfluoroheptyl)ethanesulfonic acid, 1,1,2,2,3,3,4,4,5,5,6,6,7,7,8,8,9,9-octadecafluorononanesulfonic acid, perfluorononanesulfonic acid; 2-(perfluorooctyl)ethanesulfonic acid, 1,1,2,2,3,3,4,4,5,5,6,6,7,7,8,8,9,9,10,10-eicosafluorodecanesulfonic acid, perfluorodecanesulfonic acid; 2-(perfluorononyl)ethanesulfonic acid, 1,1,2,2,3,3,4,4,5,5,6,6,7,7,8,8,9,9,10,10,11,11-docosafluoroundecanesulfonic acid, perfluoroundecanesulfonic acid; 2-(perfluorodecyl)ethanesulfonic acid, 1,1,2,2,3,3,4,4,5,5,6,6,7,7,8,8,9,9,10,10,11,11,12,12-tetracosafluorododecanesulfonic acid, perfluorododecanesulfonic acid; 2-(perfluoroundecyl)ethanesulfonic acid, 1,1,2,2,3,3,4,4,5,5,6,6,7,7,8,8,9,9,10,10,11,11,12,12,13,13-hexacosafluorotridecanesulfonic acid, perfluorotridecanesulfonic acid; 2-(perfluorododecyl)ethanesulfonic acid, 1,1,2,2,3,3,4,4,5,5,6,6,7,7,8,8,9,9,10,10,11,11,12,12,13,13,14,14-octacosafluorotetradecanesulfonic acid, perfluorotetradecanesulfonic acid; 2-(perfluorotridecyl)ethanesulfonic acid, 1,1,2,2,3,3,4,4,5,5,6,6,7,7,8,8,9,9,10,10,11,11,12,12,13,13,14,14,15,1 5-triacontafluoropentadecanesulfonic acid, perfluoropentadecanesulfonic acid and the like.

Examples of Fluoroalkylcarboxylic Acid are 2-(perfluoropropyl)ethanecarboxylic acid, 1,1,2,2,3,3,4,4,5,5-decafluoropentanecarboxylic acid, perfluoropentanecarboxylic acid; 2-(perfluorobutyl)ethanecarboxylic acid, 1,1,2,2,3,3,4,4,5,5,6,6-dodecafluorohexanecarboxylic acid, perfluorohexanecarboxylic acid; 2-(perfluoropentyl)ethanecarboxylic acid, 1,1,2,2,3,3,4,4,5,5,6,6,7,7-tetradecafluoroheptanecarboxylic acid, perfluoroheptanecarboxylic acid; 2-(perfluorohexyl)ethanecarboxylic acid, 1,1,2,2,3,3,4,4,5,5,6,6,7,7,8,8-hexadecafluorooctanecarboxylic acid, perfluorooctanecarboxylic acid; 2-(perfluoroheptyl)ethanecarboxylic acid, 1,1,2,2,3,3,4,4,5,5,6,6,7,7,8,8,9,9-octadecafluorononanecarboxylic acid, perfluorononanecarboxylic acid; 2-(perfluorooctyl)ethanecarboxylic acid, 1,1,2,2,3,3,4,4,5,5,6,6,7,7,8,8,9,9,10,10-eicosafluorodecanecarboxylic acid, perfluorodecanecarboxylic acid; 2-(perfluorononyl)ethanecarboxylic acid, 1,1,2,2,3,3,4,4,5,5,6,6,7,7,8,8,9,9,10, 10, 11, 11-docosafluoroundecanecarboxylic acid, perfluoroundecanecarboxylic acid; 2-(perfluorodecyl)ethanecarboxylic acid, 1,1,2,2,3,3,4,4,5,5,6,6,7,7,8,8,9,9,10,10,11,11,12,12-tetracosafluorododecanecarboxylic acid, perfluorododecanecarboxylic acid; 2-(perfluoroundecyl)ethanecarboxylic acid, 1,1,2,2,3,3,4,4,5,5,6,6,7,7,8,8,9,9,10,10,11,11,12,12,13,13-hexacosafluorotridecanecarboxylic acid, perfluorotridecanecarboxylic acid; 2-(perfluorododecyl)ethanecarboxylic acid, 1,1,2,2,3,3,4,4,5,5,6,6,7,7,8,8,9,9,10,10,11,11,12,12,13,13,14,14-octacosafluorotetradecanecarboxylic acid, perfluorotetradecanecarboxylic acid; 2-(perfluorotridecyl)ethanecarboxylic acid, 1,1,2,2,3,3,4,4,5,5,6,6,7,7,8,8,9,9,10,10,11,11,12,12,13,13,14,14,15,15-triacontafluoropentadecanecarboxylic acid, perfluoropentadecanecarboxylic acid and the like.

Those fluoroalkylsulfonic acids and fluoroalkylcarboxylic acids can be used alone or in a mixture of two or more thereof.

Preferred examples of the inorganic acid are sulfuric acid, hydrochloric acid, nitric acid, phosphoric acid, hydrofluoric acid, hydrobromic acid and the like. Those inorganic acids are preferred for the purpose of adjusting a pH value of the coating composition to not more than 4.0. The inorganic acid is usually used in an amount of from 0.01 to 0.2% by mass based on the coating composition. The above-mentioned organic acids and inorganic acids may be used alone or in a mixture of two or more thereof.

To the coating composition of the present invention may be added, as case demands, a water soluble polymer other than the fluorine-containing polymer (A1). The water soluble polymer can be used for improving film forming property, and may be used within a range (kind and amount of the polymer) neither having an adverse effect on a refractive index of the coating film nor lowering transparency of the coating film.

Examples of the water soluble polymer are, for instance, polyvinyl alcohols, polyalkyl vinyl ethers (polymethyl vinyl ether, polyethyl vinyl ether), polyacrylic acids, acrylate resins having carboxyl group, polymethacrylates, polyethylene glycols, celluloses and the like.

A composition obtained by blending the water soluble polymer to the coating composition of the present invention is useful as a reflection reducing composition used for KrF resist and the like, and can make it possible to reduce an amount of perfluoroalkyl sulfonic acids (for example, those having 4 to 8 carbon atoms) which have been used for conventional compositions or can make use thereof unnecessary.

An amount of the water soluble polymer is from 0.1 to 100 parts by mass, preferably from 0.5 to 50 parts by mass, more preferably from 1 to 30 parts by mass, particularly preferably from 1 to 10 parts by mass based on 100 parts by mass of the fluorine-containing polymer (A1) contained in the coating composition.

To the coating composition of the present invention may be added, as case demands, a known photoacid generator. The addition of a photoacid generator to the coating composition can prevent diffusion and migration of an acid to the antireflection layer from the photoresist layer after the exposure and the resist pattern profile can be prevented from being in the form of T-top.

Examples of the acid generator are, for instance, onium salt, haloalkyl group-containing compound, o-quinonediazide compound, nitrobenzyl compound, sulfonic acid ester compound, sulfone compound and the like. Those acid generators can be used alone or in a mixture of two or more thereof. The preferred acid generator is onium salt.

An amount of the acid generator is usually not more than 20 parts by mass, preferably not more than 10 parts by mass, particularly preferably not more than 5 parts by mass based on 100 parts by mass of the fluorine-containing polymer (A1) contained in the coating composition. If the amount of the acid generator is too large, there is a tendency that developing property of the laminated resist is lowered and transparency and a refractive index of the antireflection film are deteriorated.

Also to the coating composition forming the antireflection film of the present invention may be added, as case demands, a defoaming agent, light absorbing agent, storage stabilizer, antiseptic agent, adhesion promoter, photoacid generator, dye and the like.

In the coating composition of the present invention, the content of the fluorine-containing polymer (A1) having hydrophilic group varies depending on kind and molecular weight of the polymer, kind and amount of additives, kind of a solvent and the like, and is optionally selected so that a suitable viscosity being capable of forming a thin coating film is obtained. For example, the content is from 0.1 to 50% by mass, preferably from 0.5 to 30% by mass, more preferably from 1 to 20% by mass, particularly preferably from 2 to 10% by mass based on the whole coating composition.

In the claims and specification of the present invention, physical properties are measured by the following methods. Measuring methods of a pKa value, refractive index, dissolution rate in a developing solution and reflectance are explained in examples.

(1) Analysis of Composition: Calculated from Data of ¹H-NMR, ¹⁹F-NMR and IR.

AC-300 available from BRUKER is used for NMR.

Measurement is carried out at room temperature under the following conditions:
Measuring conditions of ¹H-NMR: 300 MHz (Tetramethylsilane=0 ppm)
Measuring conditions of ¹⁹F-NMR: 282 MHz (Trichlorofluoromethane=0 ppm)

IR analysis: Measurement is carried out at room temperature with a Fourier-transform infrared spectrophotometer 1760× available from Perkin Elmer Co., Ltd.

(2) Fluorine Content (% by Mass):

The fluorine content is obtained by burning 10 mg of a sample by an oxygen flask combustion method, absorbing cracked gas in 20 ml of de-ionized water and then measuring a fluorine ion concentration in the solution by a fluoride-ion selective electrode method (using a fluorine ion meter model 901 available from Orion).

(3) Number Average Molecular Weight:

A number average molecular weight is calculated based on monodisperse polystyrene from the data measured with gel permeation chromatography (GPC) by using GPC HLC-8020 available from Toso Kabushiki Kaisha and columns available from Shodex (one GPC KF-801, one GPC KF-802 and two GPC KF-806M were connected in series) and flowing tetrahydrofuran (THF) as a solvent at a flowing rate of 1 ml/min.

(4) Content of Hydrophilic Groups Y (Number of Moles/100 g of Polymer):

Calculated from data of ¹H-NMR, ¹⁹F-NMR and IR. AC-300 available from BRUKER is used for NMR.

Measurement is carried out at room temperature under the following conditions:
Measuring conditions of ¹H-NMR: 300 MHz (Tetramethylsilane=00 ppm)
Measuring conditions of ¹⁹F-NMR: 282 MHz (Trichlorofluoromethane=00 ppm)
and the number of moles of hydrophilic groups contained in 100 g of polymer is calculated from the proportions of each structural unit in the polymer.
(5) Measurement of pH Value of Coating Composition

Measurement of a pH value is carried out at 25° C. with a pH METER F-22 available from HORIBA.

The present invention is then explained by means of examples but is not limited to them.

### PREPARATION EXAMPLE 1

(Synthesis of Fluorine-Containing Polymer Having —COOH as the Hydrophilic Group Y)

Into a 100 ml four-necked glass flask equipped with a stirrer and thermometer were poured 21.1 g of perfluoro-(9,9-dihydro-2,5-bistrifluoromethyl-3,6-dioxa-8-nonenoic acid): 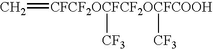
and 21.6 g of perfluorohexane solution of 8.0% by mass of:
[H—(CF₂CF₂)₃COO [symbol] ₂
and after sufficiently replacing the inside of the flask with nitrogen gas, polymerization reaction was continued at 20° C. for 24 hours in nitrogen gas atmosphere and a solid having a high viscosity was obtained.

The obtained solid dissolved in acetone was poured into n-hexane and was subjected to separation and vacuum drying to obtain 17.6 g of a colorless transparent polymer.

According to ¹H-NMR, ¹⁹F-NMR and IR analyses, the obtained polymer was found to be a fluorine-containing polymer containing only a structural unit of the above-mentioned fluorine-containing allyl ether having COOH group.

With respect to the molecular weight of the polymer, the above-mentioned GPC measurement was carried out after methyl-esterification of the carboxyl group in the polymer by the following method.

(Reaction of Methyl-Esterification)

In 5 ml of tetrahydrofuran (THF) was dissolved 1 g of the obtained polymer, and titration of 2-N hexane solution of trimethylsilyldiazomethane was carried out with stirring until the reaction solution turned to light yellow. After the reaction, the solvent was distilled off under reduced pressure and according to ¹H-NMR analysis of the obtained reaction product, it was confirmed that all COOH groups of the sample was converted to methyl ester.

After the conversion to methyl ester, the number average molecular weight of the fluorine-containing polymer measured by GPC was 13,000.

### PREPARATION EXAMPLE 2

(Synthesis of Fluorine-Containing Polymer Having COOH Group as the Hydrophilic Group Y)

Polymerization reaction and separation of a polymer were carried out in the same manner as in Preparation Example 1 except that 23.5 g of perfluoro-(12,12-dihydro-2,5,8-tristrifluoromethyl-3,6,9-trioxa-11-dodecenic acid): 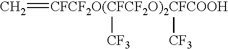
was used instead of perfluoro-(9,9-dihydro-2,5-bistrifluoromethyl-3,6-dioxa-8-nonenoic acid) and 17.3 g of perfluorohexane solution of 8.0% by mass of:
[H—(CF₂CF₂)₃COO [symbol] ₂
was used, and 20.6 g of a colorless transparent polymer was obtained.

According to ¹H-NMR, ¹⁹F-NMR and IR analyses, the obtained polymer was found to be a fluorine-containing polymer containing only a structural unit of the above-mentioned fluorine-containing allyl ether having COOH group.

### PREPARATION EXAMPLE 3

(Synthesis of Fluorine-Containing Polymer Having COOH Group as the Hydrophilic Group Y)

Polymerization reaction and separation of a polymer were carried out in the same manner as in Preparation Example 1 except that 22.6 g of perfluoro-(15,15-dihydro-2,5,8,11-tetrakistrifluoromethyl-3,6,9,12-tetraoxa-14-pentadecenic acid): 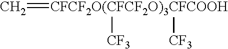
was used instead of perfluoro-(9,9-dihydro-2,5-bistrifluoromethyl-3,6-dioxa-8-nonenoic acid) and 12.9 g of perfluorohexane solution of 8.0% by mass of:
[H—(CF₂CF₂)₃COO [symbol] ₂
was used, and 18.6 g of a colorless transparent polymer was obtained.

According to ¹H-NMR, ¹⁹F-NMR and IR analyses, the obtained polymer was found to be a fluorine-containing polymer containing only a structural unit of the above-mentioned fluorine-containing allyl ether having COOH group.

### PREPARATION EXAMPLE 4

(Synthesis of Fluorine-Containing Polymer Having COOH Group as the Hydrophilic Group Y)

Into a 100 ml four-necked glass flask equipped with a stirrer and thermometer were poured 5.0 g of 1,1,2,4,4,8-hexahydro-3-oxa-1-octene: CH₂═CHOCH₂(CF₂CF₂)₂—H, 50 g of ethyl acetate and 0.03 g of azobisisobutyronitrile (AIBN), and after replacing the inside of the system with nitrogen gas, 5 g of 2-(trifluoromethyl)acrylic acid: 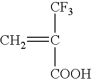
was added and a reaction was continued at 60° C. in a stream of nitrogen gas with stirring.

The obtained reaction solution was taken out and was subjected to re-precipitation with a hexane solvent to separate a solid. This solid was subjected to vacuum drying until a constant weight was reached, and 9.1 g of a copolymer in the form of white powder was obtained.

According to ¹H-NMR and ¹⁹F-NMR analyses, the copolymer was one containing perfluoro(1,1,2,4,4,8-hexahydro-3-oxa-1-octene) and 2-(trifluoromethyl)acrylic acid in a percent by mole ratio of 50/50. The number average molecular weight thereof was 87,000.

### PREPARATION EXAMPLE 5

(Synthesis of Fluorine-Containing Polymer Having COOH Group as the Hydrophilic Group Y)

Polymerization reaction and separation of a polymer were carried out in the same manner as in Preparation Example 4 except that 4.0 g of maleic anhydride was used instead of 2-(trifluoromethyl)acrylic acid, and 8.2 g of a polymer in the form of white powder was obtained.

According to ¹H-NMR and ¹⁹F-NMR analyses, the copolymer was one containing perfluoro(1,1,2,4,4,8-hexahydro-3-oxa-1-octene) and maleic anhydride in a percent by mole ratio of 50/50.

The obtained polymer was poured into 100 ml of aqueous solution of 1N—NaOH and was dissolved homogeneously by stirring. To this solution was added 35% concentrated hydrochloric acid to adjust its pH value to 2 or less. The acidic solution was extracted with dichloromethane to take out an organic substance. After drying of the organic layer, dichloromethane was concentrated and distilled off. As a result, 7.0 g of a copolymer in the form of white solid was obtained.

According to ¹H-NMR and ¹⁹F-NMR analyses, the copolymer was one containing perfluoro(1,1,2,4,4,8-hexahydro-3-oxa-1-octene) and maleic acid in a percent by mole ratio of 50/50.

### PREPARATION EXAMPLE 6

(Synthesis of Fluorine-Containing Polymer Having OH Group as the Hydrophilic Group Y)

Polymerization reaction and separation of a polymer were carried out in the same manner as in Preparation Example 1 except that 20.4 g of (1,1,9,9-tetrahydro-2,5-bistrifluoromethyl-3,6-dioxa-8-nonenol): 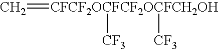
was used instead of perfluoro-(9,9-dihydro-2,5-bistrifluoromethyl-3,6-dioxa-8-nonenoic acid) and 17.1 g of a colorless transparent polymer was obtained.

According to ¹H-NMR, ¹⁹F-NMR and IR analyses, the obtained polymer was found to be a fluorine-containing polymer containing only a structural unit of the above-mentioned fluorine-containing allyl ether having OH group.

### PREPARATION EXAMPLE 7

(Synthesis of Fluorine-Containing Polymer Having OH Group as the Hydrophilic Group Y)

Into a 100 ml stainless steel autoclave equipped with a valve, pressure gauge and thermometer were poured 5.2 g of 1,1-bistrifluoromethyl-3-buten-1-ol: 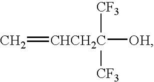
30 ml of CH₃CCl₂F (HCFC-141b) and 10 g of perfluorohexane solution of 10% by mole of n-heptafluorobutyryl peroxide (HBP), and the inside of the system was sufficiently replaced with nitrogen gas while cooling with dry ice/methanol solution. Then 10 g of tetrafluoroethylene (TFE) was introduced through the valve and a reaction was carried out at 30° C. with shaking. During the reaction, there was no change in a gauge pressure in the system (9.0 MPaG before starting of the reaction), and also 20 hours after, the gauge pressure was 9.0 MPaG.

Twenty hours after starting of the reaction, the unreacted monomer was released. The precipitated solid was taken out and dissolved in acetone and was subjected to re-precipitation with a hexane solvent to separate and refine a solid. The solid was vacuum-dried until a constant weight was reached, and 3.0 g of a copolymer was obtained.

According to ¹H-NMR and ¹⁹F-NMR analyses, the copolymer was one containing 1,1-bistrifluoromethyl-3-buten-1-ol and tetrafluoroethylene in a percent by mole ratio of 50/50. The number average molecular weight thereof was 4,900.

### PREPARATION EXAMPLE 8

(Synthesis of Fluorine-Containing Polymer Having —COOH Group as the Hydrophilic Group Y)

Polymerization reaction and post-treatment were carried out in the same manner as in Preparation Example 1 except that 40.0 g of perfluoro-(9,9-dihydro-2,5-bistrifluoromethyl-3,6-dioxa-8-nonenoic acid): 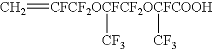
and 59.2 g of perfluorohexane solution of 8.0% by mass of:
[H—(CF₂CF₂)₃COO [symbol] ₂
were used, and 38.2 g of a colorless transparent polymer was obtained.

According to ¹H-NMR, ¹⁹F-NMR and IR analyses, the obtained polymer was found to be a fluorine-containing polymer containing only a structural unit of the above-mentioned fluorine-containing allyl ether having COOH group.

Also GPC measurement was carried out after methyl-esterification of carboxyl group in the same manner as in Preparation Example 1. The number average molecular weight thereof was 7,800.

### PREPARATION EXAMPLE 9

(Synthesis of Fluorine-Containing Polymer Having —COOH Group as the Hydrophilic Group Y)

Polymerization reaction and post-treatment were carried out in the same manner as in Preparation Example 1 except that 40.0 g of perfluoro-(9,9-dihydro-2,5-bistrifluoromethyl-3,6-dioxa-8-nonenoic acid): 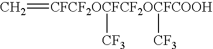
and 8.46 g of perfluorohexane solution of 8.0% by mass of:
[H—(CF₂CF₂)₃COO [symbol] ₂
were used, and 32.6 g of a colorless transparent polymer was obtained.

According to ¹H-NMR, ¹⁹F-NMR and IR analyses, the obtained polymer was found to be a fluorine-containing polymer containing only a structural unit of the above-mentioned fluorine-containing allyl ether having COOH group.

Also GPC measurement was carried out after methyl-esterification of carboxyl group in the same manner as in Preparation Example 1. The number average molecular weight thereof was 29,000.

### PREPARATION EXAMPLE 10

(Synthesis of Fluorine-Containing Polymer Having —COOH Group as the Hydrophilic Group Y)

Into a 100 ml four-necked glass flask equipped with a stirrer and thermometer were poured 30.0 g of perfluoro-(6,6-dihydro-2-trifluoromethyl-3-oxa-5-hexenoic acid): 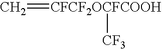
and 31.4 g of perfluorohexane solution of 8.0% by mass of.
[H—(CF₂CF₂)₃COO [symbol] ₂
and after sufficiently replacing the inside of the flask with nitrogen gas, polymerization reaction was continued at 20° C. for 24 hours in nitrogen gas atmosphere and a solid having a high viscosity was obtained.

The obtained solid dissolved in acetone was poured into n-hexane and then subjected to separation and vacuum drying to obtain 27.9 g of a colorless transparent polymer.

According to ¹H-NMR, ¹⁹F-NMR and IR analyses, the obtained polymer was found to be a fluorine-containing polymer containing only a structural unit of the above-mentioned fluorine-containing allyl ether having COOH group.

Also GPC measurement was carried out after methyl-esterification of carboxyl group in the same manner as in Preparation Example 1. The number average molecular weight thereof was 11,000.

### PREPARATION EXAMPLE 11

(Synthesis of Fluorine-Containing Polymer Having —COOH Group as the Hydrophilic Group Y)

Polymerization reaction and post-treatment were carried out in the same manner as in Preparation Example 10 except that 50.0 g of perfluoro-(6,6-dihydro-2-trifluoromethyl-3-oxa-5-hexenoic acid): 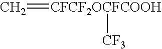
and 13.9 g of perfluorohexane solution of 8.0% by mass of:
[H—(CF₂CF₂)₃COO [symbol] ₂
were used, and 43.2 g of a colorless transparent polymer was obtained.

According to ¹H-NMR, ¹⁹F-NMR and IR analyses, the obtained polymer was found to be a fluorine-containing polymer containing only a structural unit of the above-mentioned fluorine-containing allyl ether having COOH group.

Also GPC measurement was carried out after methyl-esterification of carboxyl group in the same manner as in Preparation Example 1. The number average molecular weight thereof was 34,000.

### PREPARATION EXAMPLE 12

(Synthesis of Fluorine-Containing Polymer Having —COOH Group as the Hydrophilic Group Y)

Polymerization reaction and post-treatment were carried out in the same manner as in Preparation Example 10 except that 5.0 g of perfluoro-(6,6-dihydro-2-trifluoromethyl-3-oxa-5-hexenoic acid): 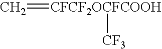
and 1.39 g of perfluorohexane solution of 8.0% by mass of:
[H—(CF₂CF₂)₃COO [symbol] ₂
were used, and 4.1 g of a colorless transparent polymer was obtained.

According to ¹H-NMR, ¹⁹F-NMR and IR analyses, the obtained polymer was found to be a fluorine-containing polymer containing only a structural unit of the above-mentioned fluorine-containing allyl ether having COOH group.

Also GPC measurement was carried out after methyl-esterification of carboxyl group in the same manner as in Preparation Example 1. The number average molecular weight thereof was 55,000.

### PREPARATION EXAMPLE 13

(Synthesis of Fluorine-Containing Polymer Having —COOH Group as the Hydrophilic Group Y)

Polymerization reaction and post-treatment were carried out in the same manner as in Preparation Example 10 except that 50.0 g of perfluoro-(9,9-dihydro-2,5-bistrifluoromethyl-3,6-dioxa-8-nonenoic acid): 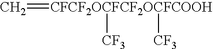
and 5.3 g of perfluorohexane solution of 8.0% by mass of:
[H—(CF₂CF₂)₃COO [symbol] ₂
were used, and 39.5 g of a colorless transparent polymer was obtained.

According to ¹H-NMR, ¹⁹F-NMR and IR analyses, the obtained polymer was found to be a fluorine-containing polymer containing only a structural unit of the above-mentioned fluorine-containing allyl ether having COOH group.

Also GPC measurement was carried out after methyl-esterification of carboxyl group in the same manner as in Preparation Example 1. The number average molecular weight thereof was 50,000.

### PREPARATION EXAMPLE 14

(Synthesis of Fluorine-Containing Polymer Having —COOH Group as the Hydrophilic Group Y)

Into a 100 ml four-necked glass flask equipped with a stirrer and thermometer were poured 10.0 g of perfluoro-(6,6-dihydro-2-trifluoromethyl-3-oxa-5-hexenoic acid): 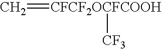
and a solution prepared by dissolving 89 mg of ammonium persulfate in 20 g of water and after sufficiently replacing the inside of the flask with nitrogen gas, polymerization reaction was continued at 80° C. for six hours in nitrogen gas atmosphere. After completion of the polymerization, to the obtained solution was added 10 g of 10% hydrochloric acid to precipitate the polymer. The precipitated polymer dissolved in acetone was poured into n-hexane and then subjected to separation and vacuum drying to obtain 8.3 g of a colorless transparent polymer.

According to ¹H-NMR, ¹⁹F-NMR and IR analyses, the obtained polymer was found to be a fluorine-containing polymer containing only a structural unit of the above-mentioned fluorine-containing allyl ether having COOH group.

Also GPC measurement was carried out after methyl-esterification of carboxyl group in the same manner as in Preparation Example 1. The number average molecular weight thereof was 54,000.

### PREPARATION EXAMPLE 15

(Synthesis of Fluorine-Containing Polymer Having —COOH Group as the Hydrophilic Group Y)

Into a 100 ml four-necked glass flask equipped with a stirrer and thermometer were poured 25.0 g of perfluoro-(9,9-dihydro-2,5-bistrifluoromethyl-3,6-dioxa-8-nonenoic acid): 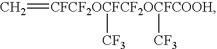
25.0 g of perfluoro-(6,6-dihydro-2-trifluoromethyl-3-oxa-5-hexenoic acid): 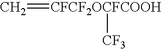
and a solution prepared by dissolving 180 mg of ammonium persulfate in 100 g of water and after sufficiently replacing the inside of the flask with nitrogen gas, polymerization reaction was continued at 80° C. for six hours in nitrogen gas atmosphere. After completion of the polymerization, to the obtained solution was added 50 g of 10% hydrochloric acid to precipitate the polymer. The precipitated polymer dissolved in acetone was poured into n-hexane and then subjected to separation and vacuum drying to obtain 38 g of a colorless transparent polymer.

According to ¹H-NMR, ¹⁹F-NMR and IR analyses, the obtained polymer was found to be a fluorine-containing polymer containing perfluoro-(9,9-dihydro-2,5-bistrifluoromethyl-3,6-dioxa-8-nonenoic acid) and perfluoro-(6,6-dihydro-2-trifluoromethyl-3-oxa-5-hexenoic acid) in a percent by mole ratio of 38/62.

Also GPC measurement was carried out after methyl-esterification of carboxyl group in the same manner as in Preparation Example 1. The number average molecular weight thereof was 39,000.

### PREPARATION EXAMPLE 16

(Synthesis of Fluorine-Containing Polymer Having —COOH Group as the Hydrophilic Group Y)

Into a 100 ml four-necked glass flask equipped with a stirrer and thermometer were poured 15.0 g of perfluoro-(9,9-dihydro-2,5-bistrifluoromethyl-3,6-dioxa-8-nonenoic acid): 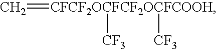
35.0 g of perfluoro-(6,6-dihydro-2-trifluoromethyl-3-oxa-5-hexenoic acid): 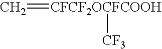
and a solution prepared by dissolving 200 mg of ammonium persulfate in 100 g of water and after sufficiently replacing the inside of the flask with nitrogen gas, polymerization reaction was continued at 80° C. for six hours in nitrogen gas atmosphere. After completion of the polymerization, to the obtained solution was added 50 g of 10% hydrochloric acid to precipitate the polymer. The precipitated polymer dissolved in acetone was poured into n-hexane and then subjected to separation and vacuum drying to obtain 8.3 g of a colorless transparent polymer.

The obtained solid was dissolved in acetone, poured into n-hexane and then subjected to separation and vacuum drying to obtain 39 g of a colorless transparent polymer.

According to ¹H-NMR, ¹⁹F-NMR and IR analyses, the obtained polymer was found to be a fluorine-containing polymer containing perfluoro-(9,9-dihydro-2,5-bistrifluoromethyl-3,6-dioxa-8-nonenoic acid) and perfluoro-(6,6-dihydro-2-trifluoromethyl-3-oxa-5-hexenoic acid) in a percent by mole ratio of 17/83.

Also GPC measurement was carried out after methyl-esterification of carboxyl group in the same manner as in Preparation Example 1. The number average molecular weight thereof was 37,000.

### EXPERIMENTAL EXAMPLE 1

(To Confirm Solubility of Fluorine-Containing Polymer in a Solvent)

Solubility in water and alcohols was confirmed using the fluorine-containing polymers having hydrophilic group which were obtained in Preparation Examples 1 to 7 and 10 to 18.

The polymers were blended in each solvent shown in Table 1 so that concentrations thereof became 5% by mass, and were allowed to stand at room temperature for 24 hours with stirring. Then appearance of the solutions was evaluated. The evaluation was made by the following criteria. The results are shown in Table 1.

TABLE 1

| | Water | Methanol | Ethanol | Isopropanol |
|---|---|---|---|---|
| Preparation Example 1 | ◯ | ◯ | ◯ | ◯ |
| Preparation Example 2 | ◯ | ◯ | ◯ | ◯ |
| Preparation Example 3 | X | X | X | X |
| Preparation Example 4 | ◯ | ◯ | ◯ | ◯ |
| Preparation Example 5 | ◯ | ◯ | ◯ | ◯ |
| Preparation Example 6 | X | ◯ | ◯ | ◯ |
| Preparation Example 7 | X | ◯ | ◯ | ◯ |
| Preparation Example 10 | ◯ | ◯ | ◯ | ◯ |
| Preparation Example 11 | ◯ | ◯ | ◯ | ◯ |
| Preparation Example 12 | ◯ | ◯ | ◯ | ◯ |
| Preparation Example 13 | ◯ | ◯ | ◯ | ◯ |
| Preparation Example 14 | ◯ | ◯ | ◯ | ◯ |
| Preparation Example 15 | ◯ | ◯ | ◯ | ◯ |
| Preparation Example 16 | ◯ | ◯ | ◯ | ◯ |
| Preparation Example 17 | ◯ | ◯ | ◯ | ◯ |
| Preparation Example 18 | ◯ | ◯ | ◯ | ◯ |

◯: A polymer is completely soluble, and a solution becomes transparent and homogeneous.
X: A polymer is partly insoluble or completely insoluble, and a solution is not transparent.

### EXPERIMENTAL EXAMPLE 2

(Measurement of a pKa Value of a Monomer Having Hydrophilic Group)

With respect to the monomers having hydrophilic group used in Preparation Examples 1 to 7 and 10, a pKa value of hydrophilic group thereof was calculated by the following method (in Preparation Example 5, measurement was made with respect to maleic acid instead of maleic anhydride).

(Method of Determining a pKa Value)

The method of determining a pKa value is mentioned below using 1,1-bistrifluoromethyl-3-buten-1-ol: 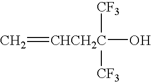
(used in Preparation Example 7) as an example of a monomer.

In a water/acetone mixture (10/15 ml) solution was poured 0.7865 g of CH₂═CHCH₂C(CF₃)₂OH, followed by stirring at room temperature. After it was confirmed that the solution was homogeneous, titration was carried out with about 0.2 mol/L NaOH solution. A titration curve was obtained by adding the NaOH solution dropwise in increments of 0.15 ml and recording a pH value at every addition. An equivalence point was determined by an inflection point (maximum differential value of titration curve=dpH/dml) of the titration curve. In this case, the equivalence point was 14.5 ml. A pH value at 7.25 ml which was a half of the equivalence point was read from the titration curve and was found to be 10.58. From a titration curve of water/acetone solution and aqueous solution which had been measured previously as a blank solution, a difference in a pH value derived from an electric potential difference between the solutions at titration of 7.25 ml was 1.29. Therefore from 10.98-1.29=9.69, it was decided that a pKa value of this CH₂═CHCH₂C(CF₃)₂OH was 9.69.

In the case of titration of 1.0865 g of CH₂═CHCH₂C(CF₃)₂OH by the same procedures as above, an equivalence point was 20.15 ml and a half of equivalence point was 10.08 ml. A pH value at a half of the equivalence point was 10.78. A difference in a pH value between the both solutions at 10.08 ml was 1.14, and from 10.78-1.14=9.64, it was decided that a pKa value of CH₂═CHCH₂C(CF₃)₂OH was 9.64.

When the same procedures as above were carried out by changing the titration solution to about 0.05 mol/L NaOH, an equivalence point of 0.115 g of CH₂═CHCH₂C(CF₃)₂OH was 8.00 ml and a half of the equivalence point was 4.00 ml. A pH value at this time was 10.92. A difference in a pH value between the both solutions at 4.00 ml was 1.38, and from 10.92-1.38=9.54, it was decided that a pKa value of CH₂═CHCH₂C(CF₃)₂OH was 9.54.

From those experiments carried out three times, it was decided that a pKa value of CH₂═CHCH₂C(CF₃)₂OH was 9.6.

With respect to the various fluorine-containing ethylenic monomers having OH group shown in Table 2, a pKa value was measured by the same procedures as above. The results are shown in Table 2.

TABLE 2

| | Monomer having hydrophilic group | pKa |
|---|---|---|
| Prep. Ex. 1 | 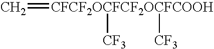 | 3.6 |
| Prep. Ex. 2 | 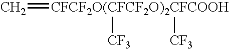 | 3.8 |
| Prep. Ex. 3 | 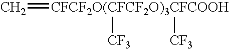 | 4.0 |
| Prep. Ex. 4 | 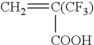 | 3.9 |
| Prep. | Maleic acid | 1.4 |
| Ex. 5 | | |
| Prep. Ex. 6 | 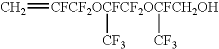 | 12.6 |
| Prep. Ex. 7 | 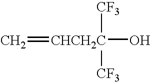 | 9.6 |
| Prep. Ex. 10 | 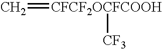 | 3.4 |

### EXPERIMENTAL EXAMPLE 3

(Measurement of Fluorine Content and Hydrophilic Group Content)

With respect to the fluorine-containing polymers having hydrophilic group obtained in Preparation Examples 1 to 7, 10 and 15 to 18, a fluorine content (% by mass) and a hydrophilic group content (number of moles/100 g of polymer) thereof were measured. The results are shown in Table 3.

TABLE 3

| | Fluorine content | Hydrophilic group content |
|---|---|---|
| | (% by mass) | (number of moles/100 g of polymer) |
| Prep. Ex. 1 | 58.5 | 0.237 |
| Prep. Ex. 2 | 61.4 | 0.170 |
| Prep. Ex. 3 | 64.2 | 0.135 |
| Prep. Ex. 4 | 52.5 | 0.251 |
| Prep. Ex. 5 | 42.4 | 0.532 |
| Prep. Ex. 6 | 60.5 | 0.245 |
| Prep. Ex. 7 | 61.6 | 0.324 |
| Prep. Ex. 10 | 52.0 | 0.39 |
| Prep. Ex. 15 | 54.9 | 0.323 |
| Prep. Ex. 16 | 53.6 | 0.352 |
| Prep. Ex. 17 | 55.8 | 0.33 |
| Prep. Ex. 18 | 54.0 | 0.36 |

### EXPERIMENTAL EXAMPLE 4

(Preparation of Coating Composition)

The fluorine-containing polymers obtained in Preparation Examples 1, 2, 4 and 5 respectively were dissolved in an amount of 10 g in 10 ml of methanol. The obtained total amount of methanol solution of fluorine-containing polymer was added dropwise in 150 ml of pure water over about ten minutes at room temperature with stirring. Further pure water was added thereto to adjust the total amount of composition to 200 ml, followed by filtrating with a filter having an opening size of 0.2 μm to obtain a homogeneous coating composition.

### EXPERIMENTAL EXAMPLE 5

(Preparation of Coating Composition)

The fluorine-containing polymers obtained in Preparation Examples 6 and 7 respectively were dissolved in an amount of 10 g in 200 ml of methanol, and then subjected to filtration with a filter having an opening size of 0.2 μm to obtain a homogeneous coating composition.

### EXPERIMENTAL EXAMPLE 6

(Preparation of Coating Composition)

The fluorine-containing polymer obtained in Preparation Example 3 was dissolved in an amount of 10 g in 200 ml of acetone, and then subjected to filtration with a filter having an opening size of 0.2 μm to obtain a homogeneous coating composition.

### EXPERIMENTAL EXAMPLE 7

(Preparation of Coating Composition)

The fluorine-containing polymer obtained in Preparation Example 1 was dissolved in an amount of 21.1 g in 20 ml of methanol, and further 0.6 g of ethanolamine was blended thereto. The obtained total amount of methanol solution of fluorine-containing polymer was added dropwise in 350 ml of pure water over about ten minutes at room temperature with stirring, and further pure water was added thereto to adjust the total amount of composition to 420 ml, followed by filtrating with a filter having an opening size of 0.2 μm to obtain a homogeneous coating composition.

### EXPERIMENTAL EXAMPLE 8

(Preparation of Coating Composition)

A coating composition of fluorine-containing polymer was obtained in the same manner as in Experimental Example 7 except that ethanolamine was added in an amount of 1.5 g.

### EXPERIMENTAL EXAMPLE 9

(Preparation of Coating Composition)

A coating composition of fluorine-containing polymer was obtained in the same manner as in Experimental Example 7 except that ethanolamine was added in an amount of 3.0 g.

### EXPERIMENTAL EXAMPLE 10

(Measurement of Refractive Index of Coating Film)

The respective coating compositions prepared in Experimental Examples 4 to 9 were coated on a 8-inch silicon wafer substrate with a spin coater at 300 rpm for three seconds and then at 4,000 rpm for twenty seconds while rotating the wafer to form a coating film so that a thickness of the dried coating film became about 100 nm.

With respect to the respective coating films formed on the silicon wafer substrate by the above-mentioned method, refractive indices thereof were measured. The results are shown in Table 4.

(Measurement of Refractive Index)

A refractive index at 193 nm wavelength and a coating thickness are measured with a spectroscopic ellipsometer (VASE ellipsometer available from J.A. Woollam).

### EXPERIMENTAL EXAMPLE 11

(Measurement of a Dissolution Rate of a Coating Film in a Developing Solution)

A dissolution rate (nm/sec) in a developing solution was measured in the manner mentioned below by the quartz crystal oscillation method (QCM method). The results are shown in Table 4.

Production of Sample:

The respective coating compositions prepared in Experimental Examples 4 to 9 were applied on a 24 mm diameter quartz oscillation panel coated with gold and was dried to make an about 100 nm coating film.

Measurement of Dissolution Rate in a Developing Solution:

A coating film thickness is calculated by converting the number of oscillations of the quartz crystal oscillation panel.

The quartz oscillation panel produced above by coating the fluorine-containing polymer was dipped in an aqueous solution of 2.38% by mass of tetramethylammonium hydroxide (TMAH) as a standard developing solution. After the dipping of the panel, a change in a coating thickness was obtained from a change in the number of oscillations with the progress of time, and a dissolution rate per unit time (nm/sec) was calculated (Reference bulletin: Advances in Resist Technology and Proceedings of SPIE Vol. 4690, 904(2002)).

### EXAMPLE 1

(Formation of Laminated Resist)

Formation of Photoresist Layer (L1):

A photoresist TArF-P6071 for ArF lithography (Tokyo Ohka Kogyo Kabushiki Kaisha) was coated on a 8-inch silicon substrate with a spin coater while changing the number of revolutions to adjust the coating thickness to be 200 to 300 nm, followed by pre-baking at 130° C. for 60 seconds to form the photoresist layer (L1).

Formation of Antireflection Layer (L2):

On the photoresist layer (L1) formed above were coated the respective coating compositions containing the fluorine-containing polymer having hydrophilic group which were prepared in Experimental Examples 4, 5 and 7 to 9 with a spin coater at 300 rpm for three seconds and then at 4,000 rpm for twenty seconds while rotating the wafer to form the antireflection layer (L2) so that the coating thickness became about 100 nm. Thus the laminated photoresist was formed.

The reflectance at 193 nm of the obtained laminated photoresist was measured. The results are shown in Table 4.

(Measurement of Reflectance)

A reflectance at 193 nm wavelength is measured with a spectroscopic ellipsometer (VASE ellipsometer available from J.A. Woollam).

Also with respect to the laminated photoresist produced by forming the antireflection layer (L2) in the same manner as above by using the fluorine-containing polymer which was confirmed to have solubility in a developing solution in Experimental Example 11, stationary puddle-developing was carried out at 23° C. for 60 seconds by using a developing solution of 2.38% by mass of tetramethylammonium hydroxide and then rinsing with pure water was carried out. It was confirmed that in any of coating compositions, the antireflection layer (L2) had been selectively removed.

TABLE 4

| | | | | | Experimental | |
|---|---|---|---|---|---|---|
| Coating composition | Experimental Example 4 | | | | Example 5 | |
| (A) Fluorine-containing polymer | Prep. | Prep. | Prep. | Prep. | Prep. | Prep. |
| | Ex. 1 | Ex. 2 | Ex. 4 | Ex. 5 | Ex. 6 | Ex. 7 |
| Fluorine content (% by mass) | 58.5 | 61.4 | 52.5 | 42.4 | 60.5 | 61.6 |
| Kind of hydrophilic group | COOH | COOH | COOH | COOH | OH | OH |
| pKa value of hydrophilic group | 3.6 | 3.8 | 3.9 | 1.4 | 12.6 | 9.6 |
| Hydrophilic group content | 0.237 | 0.170 | 0.251 | 0.279 | 0.245 | 0.324 |
| (mole/100 g of polymer) | | | | | | |
| Concentration of polymer (g/100 ml) | 5.0 | 5.0 | 5.0 | 5.0 | 5.0 | 5.0 |
| (B) Solvent (% by volume) | | | | | | |
| Water | 95 | 95 | 95 | 95 | | |
| Methanol | 5 | 5 | 5 | 5 | 100 | 100 |
| Acetone | | | | | | |

| | Experimental | Experimental | Experimental | Experimental |
|---|---|---|---|---|
| Coating composition | Example 6 | Example 7 | Example 8 | Example 9 |
| (A) Fluorine-containing polymer | Prep. | | Prep. | |
| | Ex. 3 | | Ex. 1 | |
| Fluorine content (% by mass) | 64.2 | | 58.5 | |
| Kind of hydrophilic group | COOH | | COOH | |
| pKa value of hydrophilic group | 4.0 | | 3.6 | |
| Hydrophilic group content | 0.135 | | 0.237 | |
| (mole/100 g of polymer) | | | | |
| Concentration of polymer (g/100 ml) | 5.0 | | 5.0 | |
| (B) Solvent (% by volume) | | | | |
| Water | | | 95 | |
| Methanol | | | 5 | |
| Acetone | 100 | | | |

| | | | | | Experimental | |
|---|---|---|---|---|---|---|
| Coating composition | Experimental Example 4 | | | | Example 5 | |
| (C) Organic amine | | | | | | |
| (equivalent/hydrophilic group) | | | | | | |
| Ethanolamine | | | | | | |
| Characteristics of coating film | | | | | | |
| Refractive index (λ = 193 nm) | 1.41 | 1.39 | 1.45 | 1.51 | 1.40 | 1.43 |
| Dissolution rate in a developing | 150 | 100 | 1000 | 1000 | insoluble | 300 |
| solution (nm/sec) | | | | | | |
| Characteristics of laminated resist | | | | | | |
| Reflectance (%) | 1.17 | 0.9 | 1.84 | 3.07 | 1.02 | 1.49 |

| | Experimental | Experimental | Experimental | Experimental |
|---|---|---|---|---|
| Coating composition | Example 6 | Example 7 | Example 8 | Example 9 |
| (C) Organic amine | | | | |
| (equivalent/hydrophilic group) | | | | |
| Ethanolamine | | 0.2 | 0.5 | 1.0 |
| Characteristics of coating film | | | | |
| Refractive index (λ = 193 nm) | 1.38 | 1.41 | 1.42 | 1.43 |
| Dissolution rate in a developing | Insoluble | 200 | 300 | 500 |
| solution (nm/sec) | | | | |
| Characteristics of laminated resist | | | | |
| Reflectance (%) | — | 1.17 | 1.33 | 1.49 |

### EXPERIMENTAL EXAMPLE 12

(Solubility of Fluorine-Containing Polymer (A1) in a Solvent Mixture of Water/Isopropanol)

To 1 g each of the respective fluorine-containing polymers obtained in Preparation Examples 1 and 8 to 18 was added 9 g of a solvent mixture of water/isopropanol (IPA) having the composition shown in Table 5, followed by allowing to stand at room temperature for 24 hours with stirring and then further allowing to stand at room temperature for 24 hours. Then appearance of the solution was observed.

Evaluation was carried out by the following criteria. The results are shown in Table 5.

◯: A polymer is completely soluble, and a solution becomes transparent and homogeneous and has a low viscosity.

Δ: A solution becomes transparent and homogeneous, but is in the form of gel having a high viscosity.

X: The polymer is partly insoluble or completely insoluble, and a solution is opaque.

The results are shown in Table 5.

TABLE 5

| | Polymer (A1) | | | | | |
|---|---|---|---|---|---|---|
| | Prep. Ex. | Prep. Ex. | Prep. Ex. | Prep. Ex. | Prep. Ex. | Prep. Ex. |
| | 8 | 1 | 9 | 10 | 11 | 12 |
| Number average | 7800 | 13000 | 29000 | 11000 | 34000 | 55000 |
| molecular weight | | | | | | |
| Solubility | | | | | | |
| Water/IPA ratio | | | | | | |
| (% by mass) | | | | | | |
| 0/100 | ◯ | ◯ | ◯ | ◯ | ◯ | ◯ |
| 60/40 | ◯ | ◯ | ◯ | ◯ | ◯ | ◯ |
| 65/35 | X | ◯ | ◯ | ◯ | ◯ | ◯ |
| 70/30 | X | X | ◯ | ◯ | ◯ | ◯ |
| 75/25 | X | X | X | X | ◯ | ◯ |
| 80/20 | X | X | X | X | X | ◯ |
| 85/15 | X | X | X | X | X | X |
| 100/0 | Δ | Δ | Δ | ◯ | ◯ | ◯ |
| | Polymer (A1) | | | | | |
| | Prep. Ex. | Prep. Ex. | Prep. Ex. | Prep. Ex. | Prep. Ex. | Prep. Ex. |
| | 13 | 14 | 15 | 16 | 17 | 18 |
| Number average | 50000 | 54000 | 39000 | 37000 | 61000 | 46000 |
| molecular weight | | | | | | |
| Solubility | | | | | | |
| Water/IPA ratio | | | | | | |
| (% by mass) | | | | | | |
| 0/100 | ◯ | ◯ | ◯ | ◯ | ◯ | ◯ |
| 60/40 | ◯ | ◯ | ◯ | ◯ | ◯ | ◯ |
| 65/35 | ◯ | ◯ | ◯ | ◯ | ◯ | ◯ |
| 70/30 | ◯ | ◯ | ◯ | ◯ | ◯ | ◯ |
| 75/25 | ◯ | ◯ | ◯ | ◯ | ◯ | ◯ |
| 80/20 | ◯ | ◯ | X | X | ◯ | ◯ |
| 85/15 | X | X | X | X | ◯ | ◯ |
| 100/0 | Δ | ◯ | ◯ | ◯ | ◯ | ◯ |

### EXAMPLE 2

(Preparation of Coating Composition)

The fluorine-containing polymer obtained in Preparation Example 1 was dissolved in an amount of 10 g in 35 g of isopropanol. The total amount of the obtained isopropanol solution of fluorine-containing polymer was added dropwise to 65 g of pure water at room temperature over about 10 minutes with stirring. Further a solution mixture of water/isopropanol of 65/35% by mass was added thereto to adjust the total amount of the composition to 200 g, and then filtration was carried out with a filter having an opening size of 0.2 μm to obtain a homogeneous coating composition.

### EXAMPLE 3

(Preparation of Coating Composition)

The fluorine-containing polymer obtained in Preparation Example 9 was dissolved in an amount of 10 g in 30 g of isopropanol. The total amount of the obtained isopropanol solution of fluorine-containing polymer was added dropwise to 70 g of pure water at room temperature over about 10 minutes with stirring. Further a solution mixture of water/isopropanol of 70/30% by mass was added thereto to adjust the total amount of the composition to 200 g, and then filtration was carried out with a filter having an opening size of 0.2 μm to obtain a homogeneous coating composition.

### EXPERIMENTAL EXAMPLE 13

The fluorine-containing polymer obtained in Preparation Example 8 was dissolved in an amount of 10 g in 40 g of isopropanol. The total amount of the obtained isopropanol solution of fluorine-containing polymer was added dropwise to 60 g of pure water at room temperature over about 10 minutes with stirring. Further a solution mixture of water/isopropanol of 60/40% by mass was added thereto to adjust the total amount of the composition to 200 g, and then filtration was carried out with a filter having an opening size of 0.2 μm to obtain a homogeneous coating composition.

### EXAMPLE 4

(Preparation of Coating Composition)

The fluorine-containing polymer obtained in Preparation Example 10 was mixed in an amount of 10 g to 190 g of pure water, and was completely dissolved by stirring at room temperature for 24 hours. The obtained aqueous solution was filtrated with a filter having an opening size of 0.2 μm to obtain a homogeneous coating composition.

### EXAMPLE 5

(Preparation of Coating Composition)

A coating composition was obtained in the same manner as in Example 4 except that the fluorine-containing polymer obtained in Preparation Example 11 was used instead of the fluorine-containing polymer obtained in Preparation Example 10.

### EXAMPLE 6

(Preparation of Coating Composition)

A coating composition was obtained in the same manner as in Example 4 except that the fluorine-containing polymer obtained in Preparation Example 12 was used instead of the fluorine-containing polymer obtained in Preparation Example 10.

### EXPERIMENTAL EXAMPLE 14

(Measurement of Refractive Index of Coating Film)

A refractive index was measured using light of 193 nm wavelength in the same manner as in Experimental Example 10 after forming a coating film on a silicon wafer by using the coating compositions obtained in Examples 2, 3 and 4 to 6 and Experimental Example 13.

The results are shown in Table 6.

### EXPERIMENTAL EXAMPLE 15

(Measurement of a Dissolution Rate of a Coating Film in a Developing Solution)

Production of a sample and measurement of a dissolution rate (nm/sec) in a developing solution by the quartz crystal oscillation method (QCM method) were carried out in the same manner as in Experimental Example 11 by using the respective coating compositions obtained in Examples 2, 3 and 4 to 6 and Experimental Example 13.

The results are shown in Table 6.

### EXPERIMENTAL EXAMPLE 16

(Formation of Laminated Resist and Measurement of Reflectance)

Formation of Photoresist Layer:

A photoresist layer was formed by using a resist for ArF lithography in the same manner as in Example 1.

Formation of Antireflection Layer:

A laminated photoresist was obtained by forming an antireflection layer on the photoresist layer formed above in the same manner as in Example 1 by using the respective coating compositions obtained in Examples 2, 3 and 4 to 6 and Experimental Example 13.

The reflectance of the obtained laminated photoresists was measured with light of 193 nm wavelength in the same manner as in Example 1.

The results are shown in Table 6.

TABLE 6

| Coating composition | Ex. 2 | Ex. 3 | Exp. Ex. 13 | Ex. 4 | Ex. 5 | Ex. 6 |
|---|---|---|---|---|---|---|
| (A1) Fluorine-containing | Prep. Ex. | Prep. Ex. | Prep. Ex. | Prep. Ex. | Prep. Ex. | Prep. Ex. |
| polymer | 1 | 9 | 8 | 10 | 11 | 12 |
| Number average molecular | 13000 | 29000 | 7800 | 11000 | 34000 | 55000 |
| weight: Mn | | | | | | |
| Concentration of polymer | 5.0 | 5.0 | 5.0 | 5.0 | 5.0 | 5.0 |
| (% by mass) | | | | | | |
| (B) Solvent (% by mass) | | | | | | |
| Water | 65 | 70 | 60 | 100 | 100 | 100 |
| Isopropanol | 35 | 30 | 40 | 0 | 0 | 0 |
| Characteristics of coating film | | | | | | |
| Refractive index (193 nm) | 1.41 | 1.41 | 1.41 | 1.44 | 1.44 | 1.44 |
| Dissolution rate in a | 150 | 500 | 50 | 500 | 1000 or | 1000 or |
| developing solution (nm/sec) | | | | | more | more |
| Characteristics of laminated resist | | | | | | |
| Reflectance (%) | 1.17 | 1.17 | 1.17 | 1.65 | 1.65 | 1.65 |

### EXAMPLE 7

(Preparation of Coating Composition)

(Addition of Amine (C))

To 10 g of the fluorine-containing polymer obtained in Preparation Example 1 was mixed diethanolamine (1.5 g) in an amount of 0.6 equivalent based on the carboxyl group contained in the fluorine-containing polymer. Further pure water was added thereto to adjust the total amount of the composition to be 200 g, followed by stirring at room temperature for six hours. Then after allowing the solution to stand at room temperature for 24 hours, appearance of the solution was observed.

The evaluation was carried out by the following criteria.

◯: A polymer is completely soluble, and a solution becomes transparent and homogeneous and has a low viscosity.

Δ: A solution becomes transparent and homogeneous, but is in the form of gel having a high viscosity.

X: A polymer is partly insoluble or is completely insoluble, and a solution is opaque.

(Addition 1 of Acid (D))

To 50 g of the above-mentioned coating composition containing amine was mixed para-toluenesulfonic acid in an amount of 0.2 equivalent based on the carboxyl group contained in the fluorine-containing polymer. After stirring at room temperature for six hours and then allowing to stand at room temperature for 24 hours, appearance of the solution was observed in the same manner as above.

(Addition 2 of Acid (D))

To 50 g of the above-mentioned coating composition containing amine was mixed perfluoro butanoic acid in an amount of 0.2 equivalent based on the carboxyl group contained in the fluorine-containing polymer. After stirring at room temperature for six hours and then allowing to stand at room temperature for 24 hours, appearance of the solution was observed in the same manner as above.

(Measurement of a pH Value of a Coating Composition)

A pH value of the above coating composition was measured with the above-mentioned pH meter. Also a pH value of the coating composition obtained in Example 5 was measured.

The results are shown in Table 7.

TABLE 7

| | Example 7 | | | Example 5 |
|---|---|---|---|---|
| | Prep. | Prep. | Prep. | Prep. |
| Coating composition | Ex. 1 | Ex. 1 | Ex. 1 | Ex. 11 |
| (A1) Fluorine-containing | | | | |
| polymer | | | | |
| Concentration of polymer | 5.0 | 5.0 | 5.0 | 5.0 |
| (% by mass) | | | | |
| (B) Water (content (%) in | 100 | 100 | 100 | 100 |
| a solvent) | | | | |
| (C) Diethanolamine (equivalent) | 0.6 | 0.6 | 0.6 | — |
| (D) Para-toluenesulfonic acid | — | 0.2 | — | — |
| (equivalent) | | | | |
| Perfluoro butanoic acid | — | — | 0.2 | — |
| (equivalent) | | | | |
| Evaluation of solubility | ◯ | ◯ | ◯ | ◯ |
| pH | 2.37 | 1.75 | 1.86 | 1.70 |

### EXAMPLE 8

(Preparation of Coating Composition)

(Addition of Surfactant (E))

The fluorine-containing polymer obtained in Preparation Example 1 was dissolved in an amount of 10 g in 25 g of isopropanol. The total amount of the obtained isopropanol solution of fluorine-containing polymer was added dropwise to 75 g of pure water at room temperature over about 10 minutes with stirring. Further a solution mixture of water/isopropanol of 75/25% by mass was added thereto to adjust the total amount of the composition to 200 g, and stirring was continued at room temperature for six hours. Then after allowing to stand at room temperature for 24 hours, appearance of the solution was observed. An undissolved substance remains partly in the solution and the solution was opaque.

The above composition was separated to four compositions of 50 g each, and to the respective compositions was added 0.05 g (2.0% by mass based on the polymer in the composition) of a surfactant of the following formulae (E-1), (E-2), (E-3) and (E-4): 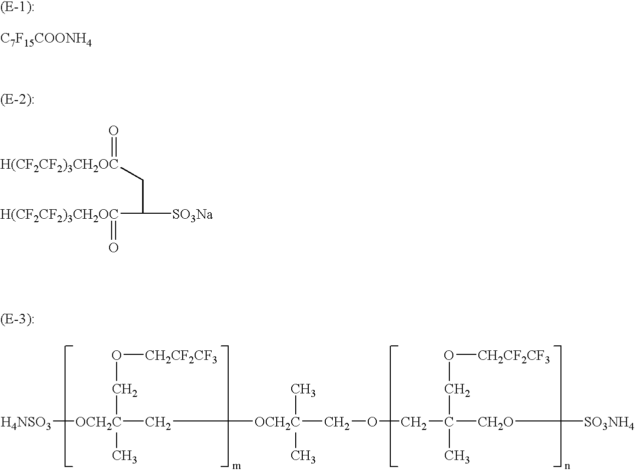
(1≦m+n≦50, an average of m+n is 7)
(E-4): A Copolymer which has a Number Average Molecular Weight of 12,000 (Based on Styrene) and is Prepared by Copolymerizing:
20 g of a compound represented by CF₃CF₂(CF₂CF₂)ₙCH₂CH₂OCOC(CH₃)═CH₂ (a mixture of compounds of n=3, n=4 and n=5 in a weight ratio of 5:3:1),
10 g of CH₂═C(CH₃)COO(CH₂CH₂O)₉CH₃,
5 g of CH₂═C(CH₃)COO(CH₂CH(CH₃)O)₁₂H,
4 g of CH₂═C(CH₃)COOCH₂CH(OH)CH₂Cl and
1 g of CH₂═C(CH₃)COOCH₂CH(OH)CH₂OH,
and then stirring was continued at room temperature for six hours. Then after allowing to stand at room temperature for 24 hours, appearance of the solution was observed.

The evaluation was carried out by the following criteria.

◯: A polymer is completely soluble, and a solution becomes transparent and homogeneous and has a low viscosity.

Δ: A solution becomes transparent and homogeneous, but is in the form of gel having a high viscosity.

X: A polymer is partly insoluble or is completely insoluble, and a solution is opaque.

The results are shown in Table 8.

TABLE 8
Coating composition

| | Prep. | Prep. | Prep. | Prep. | Prep. |
|---|---|---|---|---|---|
| (A) Fluorine-containing polymer | Ex. 1 | Ex. 1 | Ex. 1 | Ex. 1 | Ex. 1 |
| (B) Solvent (% by mass in a solvent) | | | | | |
| Water/isopropanol | 75/25 | 75/25 | 75/25 | 75/25 | 75/25 |
| (E) Surfactant | | | | | |
| (% by mass based on polymer) | | | | | |
| (E-1) | — | 2.0 | — | — | — |
| (E-2) | — | — | 2.0 | — | — |
| (E-3) | — | — | — | 2.0 | — |
| (E-4) | — | — | — | — | 2.0 |
| Evaluation of solubility | X | ◯ | ◯ | ◯ | ◯ |

### EXAMPLE 9

(Preparation of Coating Composition)

The fluorine-containing polymer obtained in Preparation Example 13 was dissolved in an amount of 10 g in 20 g of isopropanol. The total amount of the obtained isopropanol solution of fluorine-containing polymer was added dropwise to 80 g of pure water at room temperature over about 10 minutes with stirring. Further a solution mixture of water/isopropanol of 80/20% by mass was added thereto to adjust the total amount of composition to 200 g, and then filtration was carried out with a filter having an opening size of 0.2 μm to obtain a homogeneous coating composition.

### EXAMPLE 10

(Preparation of Coating Composition)

A coating composition was obtained in the same manner as in Example 9 except that the fluorine-containing polymer obtained in Preparation Example 14 was used instead of the fluorine-containing polymer obtained in Preparation Example 13.

### EXAMPLE 11

(Preparation of Coating Composition)

A coating composition was obtained in the same manner as in Example 9 except that the fluorine-containing polymer obtained in Preparation Example 15 was used instead of the fluorine-containing polymer obtained in Preparation Example 13.

### EXAMPLE 12

(Preparation of Coating Composition)

A coating composition was obtained in the same manner as in Example 9 except that the fluorine-containing polymer obtained in Preparation Example 16 was used instead of the fluorine-containing polymer obtained in Preparation Example 13.

### EXPERIMENTAL EXAMPLE 17

(Measurement of a Refractive Index of a Coating Film)

A refractive index was measured using light of 193 nm wavelength in the same manner as in Experimental Example 10 after forming a coating film on a silicon wafer by using the coating compositions obtained in Examples 9 to 12.

The results are shown in Table 9.

### EXPERIMENTAL EXAMPLE 18

(Measurement of a Dissolution Rate of a Coating Film in a Developing Solution)

Production of a sample and measurement of a dissolution rate (nm/sec) in a developing solution by the quartz crystal oscillation method (QCM method) were carried out in the same manner as in Experimental Example 11 by using the respective coating compositions obtained in Examples 9 to 12.

The results are shown in Table 9.

### EXPERIMENTAL EXAMPLE 19

(Formation of Laminated Resist and Measurement of Reflectance)

Formation of Photoresist Layer:

A photoresist layer was formed by using a resist for ArF lithography in the same manner as in Example 1.

Formation of Antireflection Layer:

A laminated photoresist was obtained by forming, on the photoresist layer formed above, an antireflection layer in the same manner as in Example 1 by using the respective coating compositions obtained in Examples 9 to 12.

The reflectance of the obtained laminated photoresists was measured with light of 193 nm wavelength in the same manner as in Example 1.

The results are shown in Table 9.

TABLE 9

| Coating composition | Ex. 9 | Ex. 10 | Ex. 11 | Ex. 12 |
|---|---|---|---|---|
| (A1) Fluorine-containing polymer | Prep. Ex. 13 | Prep. Ex. 14 | Prep. Ex. 15 | Prep. Ex. 16 |
| Number average molecular weight: Mn | 50000 | 54000 | 39000 | 37000 |
| Concentration of polymer (% by mass) | 5.0 | 5.0 | 5.0 | 5.0 |
| (B) Solvent | | | | |
| Water | 80 | 100 | 100 | 100 |
| Isopropanol | 20 | 0 | 0 | 0 |
| Characteristics of coating film | | | | |
| Refractive index (193 nm) | 1.41 | 1.44 | 1.42 | 1.43 |
| Dissolution rate in a developing solution | 1000 | 1000 | 1000 | 1000 |
| (nm/sec) | or more | or more | or more | or more |
| Characteristics of laminated resist | | | | |
| Reflectance (%) | 1.17 | 1.65 | 1.33 | 1.50 |

### EXPERIMENTAL EXAMPLE 20

(Measurement of a Dissolution Rate of a Coating Film in Water)

A dissolution rate (nm/sec) in water was measured in the manner mentioned below by the quartz crystal oscillation method (QCM method). The results are shown in Table 10.

Production of Sample:

Compositions prepared in Examples 6 and 9 to 12 were applied on a 24 mm diameter quartz crystal oscillation panel coated with gold to make about 100 nm thick coating films.

Measurement of Dissolution Rate in Water:

A coating film thickness is calculated by converting the number of oscillations of the quartz crystal oscillation panel.

The quartz oscillation panel produced above by coating the fluorine-containing polymer was dipped in pure water. After dipping of the panel, a change in a coating thickness was obtained from a change in the number of oscillations with the progress of time, and a dissolution rate per unit time (nm/sec) was calculated (Reference bulletin: Advances in Resist Technology and Proceedings of SPIE Vol. 4690, 904(2002)). The results are shown in Table 10.

TABLE 10

| Coating composition | Ex. 6 | Ex. 9 | Ex. 10 | Ex. 11 | Ex. 12 |
|---|---|---|---|---|---|
| (A1) Fluorine-containing | Prep. | Prep. | Prep. | Prep. | Prep. |
| polymer | Ex. 12 | Ex. 13 | Ex. 14 | Ex. 15 | Ex. 16 |
| Dissolution rate in water | 1000 | 1000 | 1000 | 1000 | 1000 |
| (nm/sec) | or more | or more | or more | or more | or more |

### PREPARATION EXAMPLE 17

(Synthesis of Fluorine-Containing Polymer Having —COOH Group as the Hydrophilic Group Y)

Into a 300 ml autoclave were poured 20.0 g of perfluoro-(6,6-dihydro-2-trifluoromethyl-3-oxa-5-hexenoic acid): 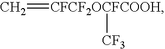
80 g of CH₃CCl₂F and 0.2 g of dinormalpropylperoxy dicarbonate. After sufficiently replacing the inside of the autoclave with nitrogen, 20 g of tetrafluoroethylene was introduced. This autoclave was subjected to shaking on a 40° C. hot water bath for 15 hours, and a colorless transparent solid was produced.

This solid dissolved in acetone was poured into n-hexane, followed by separation and vacuum drying, and 17.3 g of a colorless transparent polymer was obtained.

According to ¹⁹F-NMR analysis, ¹H-NMR analysis and IR analysis, the polymer was a copolymer containing: 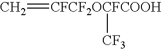
and tetrafluoroethylene in a percent by mole ratio of 67:33.

Also after methyl-esterification of the carboxyl group in the same manner as in Preparation Example 1, measurement by GPC was carried out. The number average molecular weight thereof was 61,000.

### PREPARATION EXAMPLE 18

(Synthesis of Fluorine-Containing Polymer Having —COOH Group as the Hydrophilic Group Y)

Into a 100 ml autoclave were poured 10.0 g of perfluoro-(6,6-dihydro-2-trifluoromethyl-3-oxa-5-hexenoic acid): 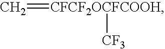
40 g of CH₃CCl₂F and 0.1 g of dinormalpropylperoxy dicarbonate. After sufficiently replacing the inside of the autoclave with nitrogen, 5 g of tetrafluoroethylene was introduced. This autoclave was subjected to shaking on a 40° C. hot water bath for 15 hours, and a colorless transparent solid was produced.

This solid dissolved in acetone was poured into n-hexane, followed by separation and vacuum drying, and 7.5 g of a colorless transparent polymer was obtained.

According to ¹⁹F-NMR analysis, ¹H-NMR analysis and IR analysis, the polymer was a copolymer containing: 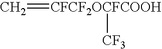
and tetrafluoroethylene in a percent by mole ratio of 82:18.

Also after methyl-esterification of the carboxyl group in the same manner as in Preparation Example 1, measurement by GPC was carried out. The number average molecular weight thereof was 46,000.

### EXAMPLE 13

(Preparation of Coating Composition)

The fluorine-containing polymer obtained in Preparation Example 17 was dissolved in an amount of 5 g in 24 g of isopropanol. The total amount of the obtained isopropanol solution of fluorine-containing polymer was added dropwise to 96 g of pure water at room temperature over about 10 minutes with stirring, followed by filtrating with a filter having an opening size of 0.2 μm to obtain a homogeneous coating composition.

### EXAMPLE 14

(Preparation of Coating Composition)

A coating composition was obtained in the same manner as in Example 13 except that the fluorine-containing polymer obtained in Preparation Example 18 was used.

### EXPERIMENTAL EXAMPLE 21

(Measurement of a Refractive Index of a Coating Film)

A refractive index was measured using light of 193 nm wavelength in the same manner as in Experimental Example 10 after forming a coating film on a silicon wafer by using the coating compositions obtained in Examples 13 and 14.

The results are shown in Table 11.

### EXPERIMENTAL EXAMPLE 22

(Measurement of a Dissolution Rate of a Coating Film in a Developing Solution)

Production of a sample and measurement of a dissolution rate (nm/sec) in a developing solution by the quartz crystal oscillation method (QCM method) were carried out in the same manner as in Experimental Example 11 by using the respective coating compositions obtained in Examples 13 and 14.

The results are shown in Table 11.

### EXPERIMENTAL EXAMPLE 23

(Formation of Laminated Resist and Measurement of Reflectance)

Formation of Photoresist Layer:

A photoresist layer was formed by using a resist for ArF lithography in the same manner as in Example 1.

Formation of Antireflection Layer:

A laminated photoresist was obtained by forming, on the photoresist layer formed above, an antireflection layer in the same manner as in Example 1 by using the respective coating compositions obtained in Examples 13 and 14.

The reflectance of the obtained laminated photoresists was measured with light of 193 nm wavelength in the same manner as in Example 1.

The results are shown in Table 11.

TABLE 11

| Coating composition | Ex. 13 | Ex. 14 |
|---|---|---|
| (A) Fluorine-containing polymer | Prep. Ex. 17 | Prep. Ex. 18 |
| Fluorine content | 55.8 | 54.0 |
| Number average molecular weight: Mn | 61000 | 46000 |
| Concentration of polymer (g/100 ml) | 5.0 | 5.0 |
| (B) Solvent | | |
| Water | 20 | 20 |
| Isopropanol | 80 | 80 |
| Characteristics of coating film | | |
| Refractive index | 1.43 | 1.44 |
| Dissolution rate in a developing | 1000 or | 1000 or |
| solution | more | more |
| Characteristics of laminated resist | | |
| Reflectance (%) | 1.50 | 1.65 |

### INDUSTRIAL APPLICABILITY

The present invention is featured especially by the fluorine-containing polymer (A) used for the antireflection layer (L2). When this fluorine-containing polymer (A) is present in the antireflection layer (L2) as main component, it is possible to reduce adverse effects on a resist pattern attributable to a standing wave effect arising in the case of using the photoresist layer (L1) alone and to a multiple reflection effect in patterning on a substrate having a step, and also it is possible to reduce a change of a pattern form attributable to an influence of outside atmosphere (an acidic or basic substance, water and the like in the air). As a result, the pattern form and dimensional accuracy are enhanced, and an ultrafine resist pattern being excellent in repeatability thereof can be formed.

The fluorine-containing polymer (A) used for the antireflection layer (L2) of the present invention can satisfy requirements for both of a low refractive index and water solubility or solubility in a developing solution (dissolution rate) though it has been difficult to satisfy the requirements. As a result, the polymer has performance adaptable to a conventional photolithography process, especially a developing process as before in addition to the above-mentioned effects in the pattern formation.

According to the present invention, since the antireflection layer of the laminated resist contains the fluorine-containing polymer containing hydrophilic group and having a high fluorine content, in a step for forming a laminated photoresist for lithography, particularly in lithography using ArF (193 nm) laser or F₂ laser as exposure light, it is possible to prevent lowering of dimensional accuracy of a pattern and decreasing of a dissolution rate in the developing step, which arise due to interference between the exposure light and the reflection light in the photoresist layer, and processability in micro fabrication can be improved.

1. A method of forming a laminated photoresist which comprises:
(I) a step for forming a photoresist layer (L1) on a substrate and
(II) a step for forming an antireflection layer (L2) on the photoresist layer (L1) by applying a coating composition comprising a fluorine-containing polymer (A) having hydrophilic group Y; said fluorine-containing polymer (A) has a structural unit derived from a fluorine-containing ethylenic monomer having the hydrophilic group Y and is characterized in that:
(i) the hydrophilic group Y contains an acidic OH group having a pKa value of not more than 11,
(ii) a fluorine content is not less than 50% by mass, and
(iii) the number of moles of the hydrophilic group Y in 100 g of the fluorine-containing polymer (A) is not less than 0.14.

2. The method of forming a laminated photoresist of claim 1, wherein in the fluorine-containing polymer (A), the hydrophilic group Y containing an acidic OH group is —OH having a pKa value of not more than 11 and/or —COOH having a pKa value of not more than 11.

3. The method of forming a laminated photoresist of claim 1, wherein the number of moles of the hydrophilic group Y in 100 g of the fluorine-containing polymer (A) is not less than 0.21.

4. The method of forming a laminated photoresist of claim 1, wherein the hydrophilic group Y in the fluorine-containing polymer (A) is —COOH and the number of moles of —COOH in 100 g of the polymer is not less than 0.21 and not more than 0.290.

5. The method of forming a laminated photoresist of claim 1, wherein the hydrophilic group Y in the fluorine-containing polymer (A) is —COOH and a number average molecular weight of the polymer is from 10,000 to 750,000.

6. The method of forming a laminated photoresist of claim 1, wherein the hydrophilic group Y in the fluorine-containing polymer (A) is —COOH and a number average molecular weight of the polymer is from 31,000 to 750,000.

7. The method of forming a laminated photoresist of claim 1, wherein the fluorine-containing polymer (A) is represented by the formula (M-1):
-(M1)-(N1)- (M-1)
wherein the structural unit M1 is a structural unit derived from a fluorine-containing monomer represented by the formula (1): 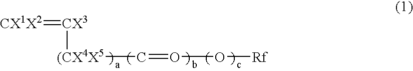
wherein X¹ and X² are the same or different and each is H or F; X³ is H, F, Cl, CH₃ or CF₃; X⁴ and X⁵ are the same or different and each is H or F; Rf is a monovalent organic group in which 1 to 4 hydrophilic groups Y are bonded to a fluorine-containing alkyl group having 1 to 40 carbon atoms or a monovalent organic group in which 1 to 4 hydrophilic groups Y are bonded to a fluorine-containing alkyl group having 2 to 100 carbon atoms and ether bond; a, b and c are the same or different and each is 0 or 1,
the structural unit N1 is a structural unit derived from a monomer copolymerizable with the fluorine-containing monomer of the formula (1), and
the structural units M1 and N1 are contained in amounts of from 30 to 100% by mole and from 0 to 70% by mole, respectively.

8. The method of forming a laminated photoresist of claim 7, wherein the structural unit M1 is a structural unit derived from a fluorine-containing monomer represented by the formula (2): 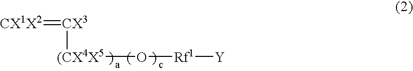
wherein X¹, X², X³, X⁴, X⁵, a, c and Y are as defined in said formula (1); Rf is a divalent fluorine-containing alkylene group having 1 to 40 carbon atoms or a divalent fluorine-containing alkylene group having 2 to 100 carbon atoms and ether bond.

9. The method of forming a laminated photoresist of claim 7, wherein the structural unit M1 is a structural unit derived from a fluorine-containing monomer represented by the formula (3): 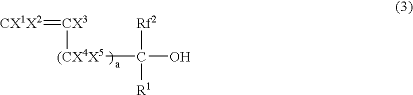
wherein X¹, X², X³, X⁴, X⁵ and a are as defined in said formula (1); Rf² is a fluorine-containing alkyl group which has 1 to 10 carbon atoms and may have ether bond; R¹ is at least one selected from the group consisting of H, a hydrocarbon group having 1 to 10 carbon atoms and a fluorine-containing alkyl group which has 1 to 10 carbon atoms and may have ether bond.

10. The method of forming a laminated photoresist of claim 1, wherein the fluorine-containing polymer (A) is represented by the formula (M-2):
-(M2)-(N2)- (M-2)
wherein the structural unit M2 is a structural unit derived from a fluorine-containing monomer which has —COOH group as the hydrophilic group Y and is represented by the formula (4): 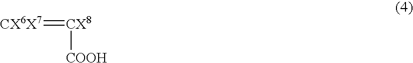
wherein X⁶ and X⁷ are the same or different and each is H or F; X⁸ is H, F, Cl, CH₃ or CF₃; at least one of X⁶, X⁷ and X⁸ contains fluorine atom,
the structural unit N2 is a structural unit derived from a monomer copolymerizable with the fluorine-containing monomer of the formula (4), and
the structural units M2 and N2 are contained in amounts of from 10 to 100% by mole and from 0 to 90% by mole, respectively.

11. The method of forming a laminated photoresist of claim 1, wherein the coating composition further contains (B) at least one solvent selected from the group consisting of water and alcohols.

12. The method of forming a laminated photoresist of claim 11, wherein the coating composition further contains (C) at least one selected from the group consisting of ammonia and organic amines.

13. A coating composition comprising:
(A1) a fluorine-containing polymer having carboxyl group and
(B) at least one solvent selected from the group consisting of water and alcohols;
said fluorine-containing polymer (A1) has a number average molecular weight of from 10,000 to 750,000 and is represented by the formula (M-3):
-(M3)-(N3)- (M-3)
wherein the structural unit M3 is a structural unit derived from a fluorine-containing monomer represented by the formula (5): 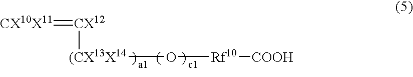
wherein X¹⁰ and X¹¹ are the same or different and each is H or F; X¹² is H, F, Cl, CH₃ or CF₃; X¹³ and X¹⁴ are the same or different and each is H or F; Rf¹⁰ is a divalent fluorine-containing alkylene group having 1 to 40 carbon atoms or a divalent fluorine-containing alkylene group having 2 to 100 carbon atoms and ether bond; a1 and c1 are the same or different and each is 0 or 1,
the structural unit N3 is a structural unit derived from a monomer copolymerizable with the fluorine-containing monomer of the formula (5), and
the structural units M3 and N3 are contained in amounts of from 55 to 100% by mole and from 0 to 45% by mole, respectively.

14. The coating composition of claim 13, wherein the fluorine-containing polymer (A1) has a number average molecular weight of from 31,000 to 750,000.

15. The coating composition of claim 13, wherein in the fluorine-containing polymer (A1), the structural units M3 and N3 are contained in amounts of from 70 to 100% by mole and from 0 to 30% by mole, respectively.

16. The coating composition of claim 13, wherein the solvent (B) is selected from water and solvent mixtures of water and alcohol, and a content of water in the solvent (B) exceeds 65% by mass based on the total weight of water and alcohol.

17. The coating composition of claim 13, wherein the coating composition further contains (C) at least one selected from the group consisting of ammonia and organic amines.

18. The coating composition of claim 17, wherein (C) at least one selected from the group consisting of ammonia and organic amines is at least one selected from the group consisting of ammonia and hydroxyalkyl amines.

19. The method of forming a laminated photoresist of claim 7, wherein the hydrophilic group Y in the fluorine-containing polymer (A) is —COOH and a number average molecular weight of the fluorine-containing polymer (A) is from 10,000 to 750,000.

20. The method of forming a laminated photoresist of claim 7, wherein the hydrophilic group Y in the fluorine-containing polymer (A) is —COOH and a number average molecular weight of the fluorine-containing polymer (A) is from 31,000 to 750,000.
